(19) United States
(12) Patent Application Publication
(10) Pub. No.: US 2005/0198140 A1
(43) Pub. Date: Sep. 8, 2005

(54) Member management system and member management method

(76) Inventors: Yayoi Itoh, Yokohama (JP); Takahiro Kikuchi, Yokohama (JP)

Correspondence Address: KATTEN MUCHIN ROSENMAN LLP, 575 MADISON AVENUE, NEW YORK, NY, 10022-2585, US

(21) Appl. No.: 10/875,927

(22) Filed: Jun. 24, 2004

(30) Foreign Application Priority Data
Jan. 13, 2004 (JP) 2004-006151

(51) Int. Cl. G06F 15/16

(52) U.S. Cl. 709/205; 709/230

(57) ABSTRACT

To provide a technique for managing members easily and flexibly as circumstances demand. Request information for a service is received from a key person terminal. A service list for the requested service is created based on the request information, and member information is created based on the request information, which are then registered. The member information is transmitted to the key person terminal, and the member application information created based on the member information is received from the group member terminal, which is verified against the member information. In the case where the member application information is judged as being authorized, member information on the group member terminal is created and transmitted to the group member terminal. Upon receiving a request for the service and member information from the key person terminal or the group member terminal, the received member information is subjected to verification. In the case where the member information is judged as being authorized as a result of the verification, information on the requested service is distributed to a terminal that has transmitted the member information.

### BACKGROUND OF THE INVENTION

The present invention relates to a technique for managing members who participate in a service such as a television (TV) conference system.

For example, the present invention can be applied to a mobile communication network adopting a CDMA system and a mobile terminal (of a type equipped with a TV telephone function and a type equipped with an application program), and is preferable for a service used by organizing a plurality of group members such as a TV conference system utilizing the TV telephone function of a mobile telephone.

Up to now, in the case of utilizing a system using a mobile terminal such as a TV conference, it is generally necessary that a user make an application in writing or through the Web in advance, and that the administrator of the system register the user and then notify the user in writing or by email of information for access to the system including a user ID, a password, and a TV conference ID and other such information. For changing group members for the conference, it is also necessary to make registrations in writing or through the Web in advance in a similar manner.

It is also necessary that a member keep the information including a user ID and a password sent in writing or by email, and that the member perform input of the information including a user ID and a password while looking at the information kept or relying on your memory thereof each time the member registers/updates scheduling data, selects group members, participates in a TV conference, or the like.

In general, for each conference, it is necessary that the host of the conference notify his/her group members of information including a key code required for participation in the conference.

Further, only a group member structure consisting of a relatively small number of members is taken into consideration, so that it is impossible to perform complicated member management such as organizing a group member structure considered in a hierarchical manner or restructuring the already-structured group members into subgroups.

Examples of the prior art relating to the present invention include the following techniques disclosed in Patent documents 1 to 4.
[Patent document 1]
JP 2000-353138 A
[Patent document 2]
JP 2002-111902 A
[Non-Patent document 1]

Copyright 2002 CNET Networks, Inc. [Retrieved on Nov. 28, 2003] Internet <http://www.zdnet.co.jp/news/0205/24/njbt_{—}05.html>
[Non-Patent document 2]

Copyright 1997-2003 ASCII Corporation. [Retrieved on Nov. 28, 2003] Internet<http://ascii24.com/news/i/net/article/2002/0 3/13/634353-000.html>
[Non-Patent document 3]

Copyright 2003 NTT DoCoMo, ink. [Retrieved on Nov. 28, 2003] Internet<http://www.nttdocomo.co.jp/new/contents/02/w hatnew0313.html>
[Non-Patent document 4]
   Copyright 2002-03-13 Shota Angu, NTT PC COMMUNICATIONS, Inc. [Retrieved on Nov. 28, 2003] Internet<http://www.pc-view.net/News/Old/0203/1303.html>
[Non-Patent document 5]

Copyright 1997-2003 ASCII Corporation. [Retrieved on Nov. 28, 2003] Internet<http://ascii24.com/news/i/net/article/2002/0 5/24/636001-000.html>
[Non-Patent document 6]

Copyright 2003 NTT DoCoMo, ink. [Retrieved on Nov. 28, 2003] Internet<http://www.nttdocomo.co.jp/new/contents/02/w hatnew0524a.html>
[Non-Patent document 7]
   Copyright 2003 NTT DoCoMo, ink. [Retrieved on Dec. 18, 2003] Internet<http://www.nttdocomo.co.jp/p_s/mstage/infoga te_top.html>
[Non-Patent document 8]
   Copyright 2003 NTT DoCoMo, ink. [Retrieved on Dec. 18, 2003] Internet<http://www.nttdocomo.co.jp/p_s/mstage/visual net/index.html>
[Non-Patent document 9]

Copyright 2001-2003 NTT BizLink, Inc. [Retrieved on Nov. 28, 2003] Internet<http://www.vcd.nttbiz.com/tatiten/outline/us e.htm>

### SUMMARY OF THE INVENTION

The conventional techniques have the following problems.

1. If there is a change in group members, it is necessary to make another application in writing or through the Web. In that case, information including a new user ID and a new password cannot be obtained on a timely basis, making it impossible to structure group members flexibly as circumstances demand.

2. Information including a user ID, a password, and a conference ID is described in writing (on paper) or by email (in the body), which may lead to a situation where a user cannot use the system owing to the loss of the information or the information becomes vulnerable to fraudulent use.

3. As authentication with information including a user ID, a password, and a conference ID becomes stricter, the information becomes harder to remember by a human being (has the code increased in number of digits, becomes meaningless set of alphanumeric characters, or the like).

4. Each time a user registers/updates scheduling data, selects group members, participates in a TV conference, or the like, it is necessary that the user perform manual input of the information including a user ID, a password, and a conference ID, thereby making the work complicated.

5. For each conference, it is necessary that the host of the conference notify his/her group members of information including a key code required for participation in the conference. This makes the work complicated on the conference host side as well.

6. Management of various information performed by the administrator of a system is complicated.

7. It is impossible to organize a complicated group member structure such as organizing a group member structure considered in a hierarchical manner or restructuring the already-structured group members into subgroups.

In addition, as the security of a system becomes stricter, the amount of the information for access to the system including a conference ID, a user ID, and a user password becomes larger. This makes the work of opening a conference, participating in the conference, and registering/modifying a schedule likely to be more complicated.

In view of the above problems, the present invention therefore has an object to provide a technique capable of managing members easily and flexibly as circumstances demand.

In order to solve the above-mentioned problems, a member management system, a server, a key person terminal, a group member terminal, and a member management method according to the present invention adopts the following measures. That is, a member management system according to the present invention includes: a server that provides a service through a network; a key person terminal that requests the server to provide the service; and a group member terminal that receives the service requested by the key person terminal from the server,
the server including:
a request receiving unit that receives request information for the service from the key person terminal;
a list creating unit that creates a service list for the requested service based on the request information, and registers the service list in a list storing unit;
a member information creating unit that creates member information based on the request information, and registers the member information in a member information storing unit in association with the service of the service list;
a member information transmitting unit that transmits the member information to the key person terminal;
an application receiving unit that receives member application information created based on the member information from the group member terminal;
an application information verifying unit that verifies whether or not the member application information is authorized member application information based on the member information registered in the member information storing unit;
a group member information creating unit that creates member information on the group member terminal in the case where the member application information is judged as being authorized as a result of verification thereof, and registers the member information in the member information storing unit;
a group member information transmitting unit that transmits the member information created by the group member information creating unit to the group member terminal;
a member information verifying unit that, upon receiving a request for the service and member information from the key person terminal or the group member terminal, verifies the received member information against the member information registered in the member information storing unit in association with the requested service; and
a service providing unit that, in the case where the member information is judged as being authorized as a result of verification thereof, distributes information on the requested service to a terminal that has transmitted the member information,
the key person terminal including:
a request transmitting unit that transmits the request information for the service to the server;
a member information receiving unit that receives the member information created based on the request information from the server;
an application information creating unit that creates the member application information based on the member information;
an application information transmitting unit that transmits the member application information to the group member terminal;
a service requesting unit that transmits the request for the service and the member information to the server; and
a service receiving unit that receives the information on the requested service,
the group member terminal including:
an application information receiving unit that receives the member application information;
an application information transmitting unit that transmits the member application information to the server;
a member information receiving unit that receives the member information created based on the member application information from the server;
a service requesting unit that transmits the request for the service and the member information to the server; and
a service receiving unit that receives the information on the requested service.

According to the above configuration, the member management system according to the present invention is capable of managing members easily and flexibly as circumstances demand when plural terminals receive a service.

Note that the service is provided by distributing information (service information) through a network in the form of TV conferences, distribution of a moving images, database searches, or the like.

Further, a member management system according to the present invention includes:
a server that provides a service through a network; a key person terminal that requests the server to provide the service; and a group member terminal that receives the service requested by the key person terminal from the server,
the server including:
a request receiving unit that receives request information including information on a service to be requested and the number of members to receive the service from the key person terminal;
a list creating unit that creates a service list for the requested service based on the request information, and registers the service list in a list storing unit;
a member information creating unit that creates member information based on the request information and member IDs for the number of the members, and registers the member information and the member IDs in a member information storing unit in association with the service of the service list;
a member information transmitting unit that transmits the member information and the member IDs to the key person terminal;
an application receiving unit that receives member application information created based on the member information and the member IDs from the group member terminal;
an application information verifying unit that verifies whether or not the member application information is authorized member application information based on the member information and the member IDs registered in the member information storing unit;
a group member information creating unit that creates member information on the group member terminal in the case where the member application information is judged as being authorized as a result of verification thereof, and registers the member information in the member information storing unit;
a group member information transmitting unit that transmits the member information created by the group member information creating unit to the group member terminal;
a member information verifying unit that, upon receiving a request for the service and member information from the key person terminal or the group member terminal, verifies the received member information against the member information registered in the member information storing unit in association with the requested service; and
a service providing unit that, in the case where the member information is judged as being authorized as a result of verification thereof, distributes information on the requested service to a terminal that has transmitted the member information,
the key person terminal including:
a request transmitting unit that transmits the request information including the information on the service to be requested and the number of the members to receive the service to the server;
a member information receiving unit that receives member information for the key person terminal created based on the request information and the member IDs from the server;
a member information creating unit that creates member information for the group member terminal based on the member information for the key person terminal and the member IDs;
a member information transmitting unit that transmits the member information for the group member terminal to the group member terminal;
a service requesting unit that that transmits the request for the service and the member information for the key person terminal to the server; and
a service receiving unit that receives the information on the requested service,
the group member terminal including:
a member information receiving unit that receives the member information;
a service requesting unit that transmits the request for the service and the member information to the server; and
a service receiving unit that receives the information on the requested service.

As described above, in the member management system according to the present invention, only the key person terminal has to perform the registration process with respect to the server. Thus, it is unnecessary to perform the registration of the member information for each group member terminal, thereby realizing the member management with a simple configuration.

In the above-mentioned member management system,
the member application information may be communicated between the application information transmitting unit of the key person terminal and the application information receiving unit of the group member terminal by infrared communication, wireless communication, or email.

According the present invention adopting the above configuration, the member information needs not to be printed out on paper or the like for notifying another member of the member information, thereby reducing the fear of the leak of the member information.

In the above-mentioned member management system,
the member information may include a service ID for identifying a service, a member ID for identifying a terminal, and a password.

The member information including a service ID, a member ID, and a password is thus created in the member information creating unit. Accordingly, even if the security is enhanced, time and trouble such as those in inputting operations are not increased.

In the above-mentioned member management system,
the group member terminal may include:
the application information creating unit that creates the member application information based on the member information; and
the application information transmitting unit that transmits the member application information to the group member terminal.

According the present invention adopting the above configuration, the group member terminal that has received the member information can further expand members by transmitting the member application information to another group member terminal.

In the above-mentioned member management system,
the key person terminal may transmit the member application information including a permitted number of levels to the group member terminal,
the group member terminal may transmit the member application information to the server,
the server may judge whether or not the permitted number of levels in the member application information is equal to or more than a predetermined value, and if the permitted number of levels is equal to or more than the predetermined value, may create the member information, and transmit the member information to the group member terminal, and
the group member terminal that has received the member information may create the member application information by performing subtraction on the permitted number of levels in the member information, and transmit the member application information to another group member terminal.

The present invention adopting the above configuration allows expansion of members to be made within the permitted number of levels.

In the above-mentioned member management system,
the key person terminal may further includes a grouping unit that, if the group member terminal receives the member information from the server and the key person terminal is notified of the permitted number of levels in the member information and a member ID, sets a group for each permitted number of levels, and registers each group and the member ID in association with each other in a group information storing unit, and
if the key person terminal receives input of a group to receive the service, the application information transmitting unit may transmit the member application information to the group member terminal identified by the member ID registered in association with the group in the group information storing unit.

According to the present invention adopting the above configuration, the service can be received by each of groups that have been formed based on the permitted number of levels and include: a group (for convenience, referred to also as main group) consisting of terminals that are directly selected by the key person, that is, that receive the member application information from the key person terminal; and a group consisting of terminals that receive the member application information from the terminal of the main group.

In the above-mentioned member management system,
the group member terminal may further include a grouping unit that, upon receiving input of a member ID for grouping, registers each group and the member ID in association with each other in a group information storing unit,
if the key person terminal receives input of a group to receive the service, the application information transmitting unit may transmit the member application information to the group member terminal identified by the member ID registered in association with the group in the group information storing unit.

According to the present invention adopting the above configuration, the service can be received by each of groups that have been formed of arbitrarily designated terminals.

Further, a member management method according to the present invention is executed by a member management system including: a server that provides a service through a network; a key person terminal that requests the server to provide the service; and a group member terminal that receives the service requested by the key person terminal from the server,
the server executing:
receiving request information for the service from the key person terminal;
creating a service list for the requested service based on the request information, and registering the service list in a list storing unit;
creating member information based on the request information, and registering the member information in a member information storing unit in association with the service of the service list;
transmitting the member information to the key person terminal;
receiving member application information created based on the member information from the group member terminal;
verifying whether or not the member application information is authorized member application information based on the member information registered in the member information storing unit;
creating member information on the group member terminal in the case where the member application information is judged as being authorized as a result of verification thereof, and registering the member information in the member information storing unit;
transmitting the member information created in the preceding step to the group member terminal;
upon receiving a request for the service and member information from the key person terminal or the group member terminal, verifying the received member information against the member information registered in the member information storing unit in association with the requested service; and
in the case where the member information is judged as being authorized as a result of the verification thereof, distributing information on the requested service to a terminal that has transmitted the member information,
the key person terminal executing:
transmitting the request information for the service to the server;
receiving the member information created based on the request information from the server;
creating the member application information based on the member information;
transmitting the member application information to the group member terminal;
transmitting the request for the service and the member information to the server; and
receiving the information on the requested service,
the group member terminal executing:
receiving the member application information;
transmitting the member application information to the server;
receiving the member information created based on the member application information from the server;
creating the member application information based on the member information;
transmitting the member application information to the group member terminal;
transmitting the request for the service and the member information to the server; and
receiving the information on the requested service.

Further, the present invention may be a program which is executed by each of the server, the key person terminal, and the group member terminal.

The present invention may be a recording medium which is recorded so as to be readable by devices (server, key person terminal, and group member terminal) that execute the above-mentioned program. In addition, by causing each of the devices to read the program out of the recording medium to execute the program, its functions can be provided.

The recording medium readable by the devices represents a recording medium that accumulates information including data and a program electrically, magnetically, optically, mechanically, or chemically, and out of which the information can be read by a device such as a computer. Of such recording media, examples of removable recording medium include, for example, a flexible disk, a magneto-optical disk, a CD-ROM, a CD-R/W, a DVD, a DAT, an 8-mm tape, and a memory card.

In addition, examples of the recording medium fixed to a computer include a hard disk and a ROM (read-only memory).

### DESCRIPTION OF THE DRAWINGS

FIG. 1 is a functional block diagram of a system according to the present invention.

FIG. 2 is an outline flow of a process for the system according to Embodiment 1.

FIG. 3 is an outline flow of a process for the system according to Embodiment 2.

FIG. 4 is a diagram for explaining how the group members are organized.

FIG. 5 is a diagram for explaining how the group members are organized.

FIG. 6 is a schematic structural diagram of a server according to the present invention.

FIG. 7 is a schematic structural diagram of a key person terminal according to the present invention.

FIG. 8 is a schematic structural diagram of a group member terminal according to the present invention.

FIG. 9 is an explanatory diagram of a key person registration process.

FIG. 10 is a flow chart of a group member registration process (in a face-to-face manner by infrared communication).

FIG. 11 is a flow chart of the group member registration process (in a face-to-face manner by infrared communication).

FIG. 12 is an explanatory diagram of a vTrigger format.

FIG. 13 is a flow chart of the group member registration process (in a face-to-face manner by infrared communication).

FIG. 14 is a flow chart of a group member registration process (in a non-face-to-face manner by email communication).

FIG. 15 is a flow chart of the group member registration process (in a non-face-to-face manner by email communication).

FIG. 16 is an explanatory diagram of an email format for activation of an application program.

FIG. 17 is a flow chart of the group member registration process (in a non-face-to-face manner by email communication).

FIG. 18 is a flow chart of a subconference member registration process.

FIG. 19 is a flow chart of a subconference member registration process.

FIG. 20 is a flow chart of a conference participation process (opening with designated date/cycle).

FIG. 21 is an explanatory diagram of an email as a conference participation notification.

FIG. 22 is a flow chart of a conference participation process.

FIG. 23 is a flow chart of the conference participation process.

FIG. 24 is an explanatory diagram of an email as a conference participation notification.

FIGS. 25A-C are explanatory diagrams of a database structure.

FIGS. 26A-C are explanatory diagrams of the database structure.

FIG. 27 is a flow chart of a user registration process according to Embodiment 2.

FIG. 28 is a flow chart of a conference registration process according to Embodiment 2.

FIG. 29 is a flow chart of a group member registration process according to Embodiment 2.

FIG. 30 is a flow chart of the group member registration process according to Embodiment 2.

FIG. 31 is an explanatory diagram of member application information in the vTrigger format.

FIG. 32 is a flow chart of a group member registration process according to Embodiment 2.

FIG. 33 is a flow chart of the group member registration process according to Embodiment 2.

FIG. 34 is a flow chart of the group member registration process according to Embodiment 2.

FIG. 35 is an explanatory diagram of an email for activation of an application program.

FIGS. 36A-C are an explanatory diagrams of a database structure.

FIGS. 37A-D are explanatory diagrams of the database structure.

FIG. 38 is a flow chart of a user registration process according to Embodiment 3.

FIG. 39 is a flow chart of a conference registration process according to Embodiment 3.

FIG. 40 is a flow chart of an instant conference notification process according to Embodiment 3.

FIG. 41 is a flow chart of the instant conference notification process according to Embodiment 3.

FIG. 42 is an explanatory diagram of an email for activation of an application program.

FIGS. 43A-C are explanatory diagrams of a database structure.

FIG. 44 is a flow chart of an instant conference registration process and an instant conference notification process according to Modified Embodiment.

FIG. 45 is a flow chart of the instant conference registration process and the instant conference notification process according to Modified Embodiment.

FIG. 46 is a flow chart of the instant conference registration process and the instant conference notification process according to Modified Embodiment.

### DETAILED DESCRIPTION OF THE INVENTION

Hereinafter, description will be made of best modes for carrying out the present invention with reference to the drawings. Note that structures of the following embodiments are provided as examples, and the present invention is not limited to those structures of the embodiments.

### Embodiment 1

§1. Outline of System

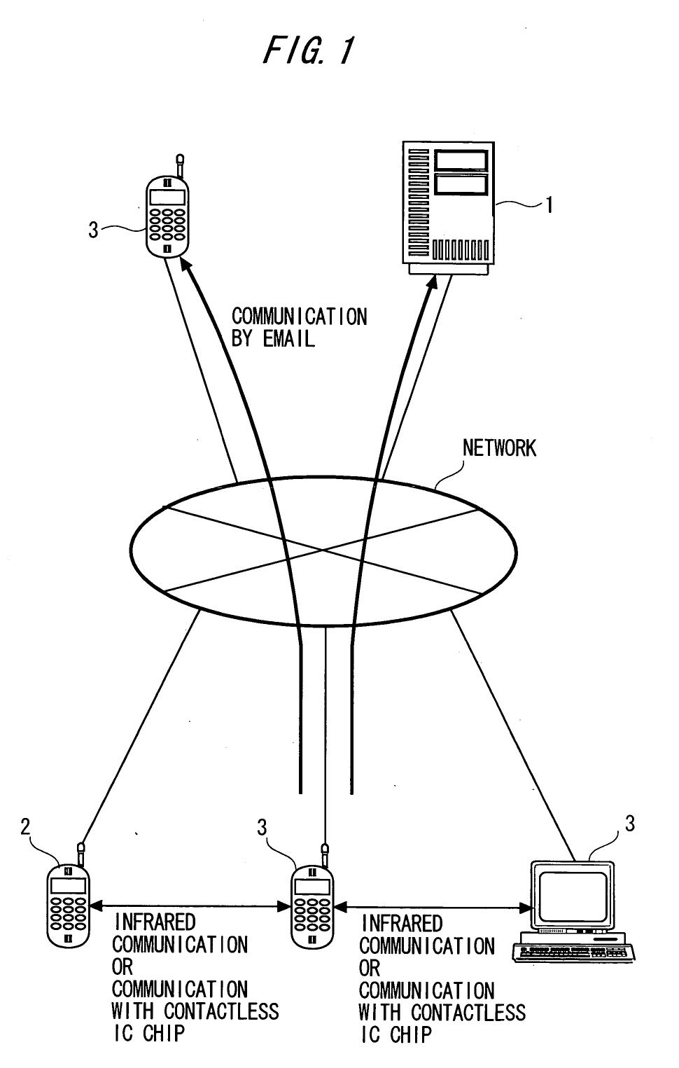

FIG. 1 is a functional block diagram of a system according to the present invention. This system includes a structure (member management system) for managing members who participate in a TV conference by use of terminals 2 and 3 that are connected to a server 1 for providing a TV (television) conference service through a network.

Each member (user) downloads an application program to the terminal 2 or 3 from the server 1, and executes the application program to perform a procedure for participation in the TV conference. Of the members, a member who plans to hold a conference is referred to herein as a “key person”, and a terminal used by the key person is referred to herein as a “key person terminal”. Also, a member who is designated as a member by the key person or the like so as to participate in the conference is referred to herein as a “group member”, and a terminal of the group member, that is, a terminal that receives member application information is referred to herein as a “group member terminal”.

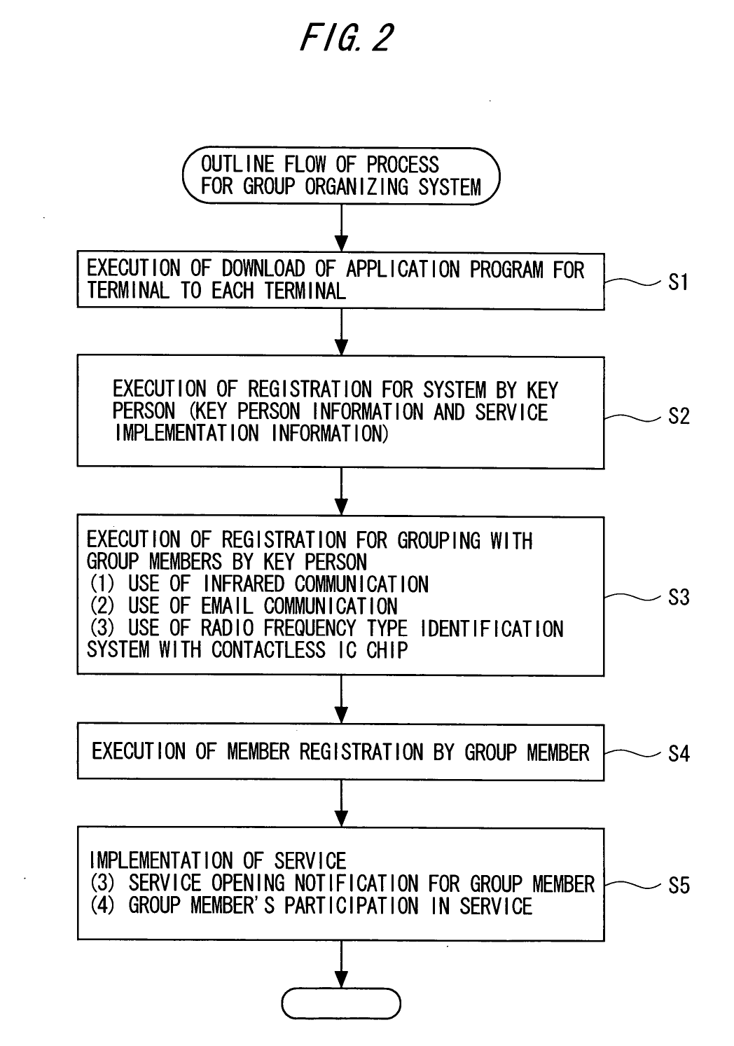

FIG. 2 shows an outline flow (part 1) of a process for the system according to this embodiment. Note that for convenience in describing each step, description is made by using the same symbols as shown in the figure.

S1 (abbreviated as “S1” in the figure): An application program for a terminal is downloaded to each of the terminals 2 and 3.

S2: A key person terminal 2 executes the downloaded application program and makes a request for a service such as a TV conference to the server 1. Personal information of a corresponding key person and service implementation information for a conference or the like are inputted as registration information when the request is made.

S3: The key person terminal 2 transmits the member application information to a group member terminal to designate a group member by using an infrared communication function, a wireless communication system (for example, a specific low-power wireless communication system, specifically, through the Bluetooth (registered trademark) or a wireless LAN), a radio frequency type identification system (RFID=Radio Frequency Identification) with a contactless IC chip, or an email communication function.

S4: Each group member terminal 3 that has received the member application information executes the application program to register for the conference.

S5: Upon receiving a service opening notification (conference starting notification), the group members including the key person each transmit member information from the terminal 2 or 3 and participate in the service such as a TV conference.

Upon execution of the downloaded application program, the terminal 2 performs communication with the server 1 and stores, in a memory area of the terminal, information (member information) on the service such as a TV conference including a personal ID, a personal authentication code, a service ID, and a service key code.

At this time, the server 1 interacts with the application program on the terminal 2 to register the personal information, execute personal authentication, register the service, implement the service, and the like.

That is, in this system, transmission/reception of the personal ID, the service ID, and other information is performed by the application program on the terminal 2, and there is no operation such as input of the information to be performed by the user. Accordingly, there is no need to provide the system with a function of allowing the user to check the information by, for example, displaying the information stored within the memory area, so that the information can be prevented from leaking.

In this embodiment, preferably used as the terminals 2 and 3 are application program-compatible mobile terminals (mobile telephones) manufactured by NTT DoCoMo, Inc. and the like. In the application program-compatible mobile terminals, a memory area (Scratchpad) can be accessed by only an application program related to the memory area. Thus, as long as the application program has no function of displaying information, reference cannot be made to the contents of information.

Alternatively, in the case of using personal computers (PCs) as the terminals 2 and 3 or applying the present invention to terminals such as PCs, the data of the information (member information) including a personal ID, a personal authentication code, a service ID, and a service key code is converted into a format that can be decoded by only the related application program for the conference.

By thus performing authentication of the members using the member information stored in the terminals 2 and 3, an access right to the TV conference service is fixed to each terminal, so that the access can be made only from the terminals 2 and 3. Also, the member information is not outputted from the terminals 2 and 3 except when processed by the application program for the conference. As a result, robust security that reduces the fear of the leak of the member information can be realized.

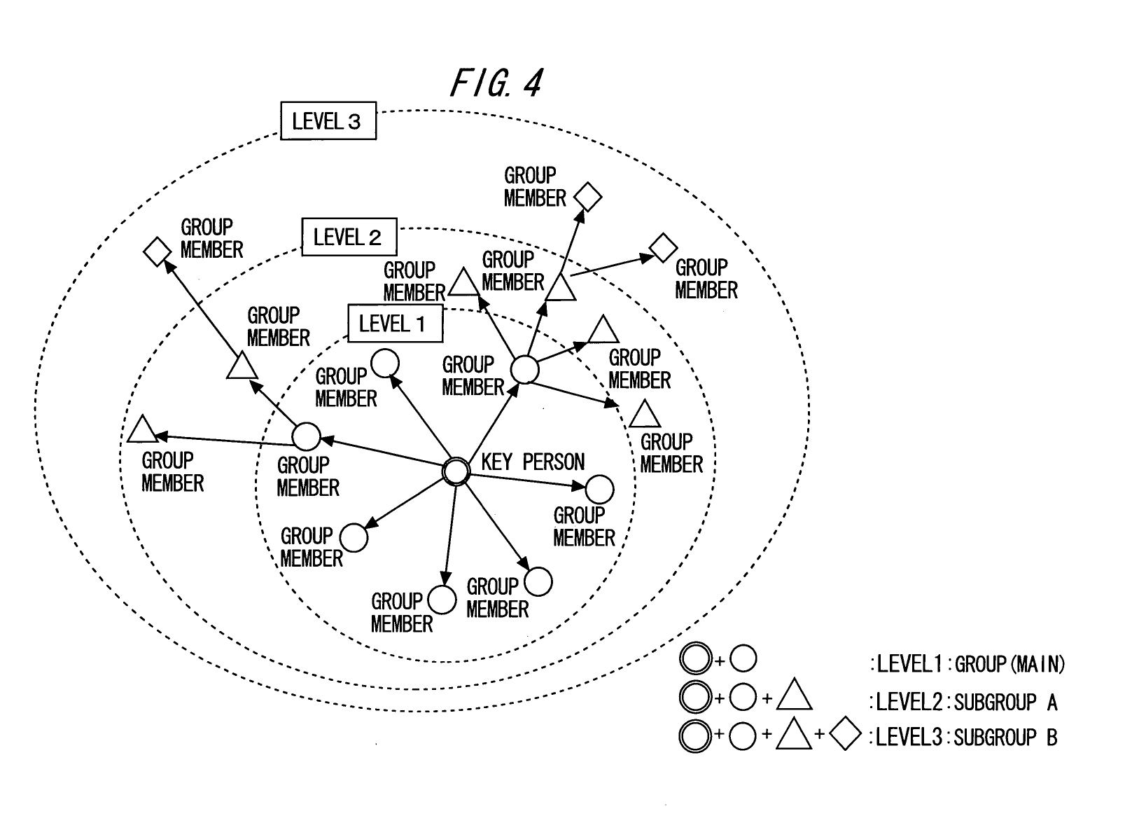

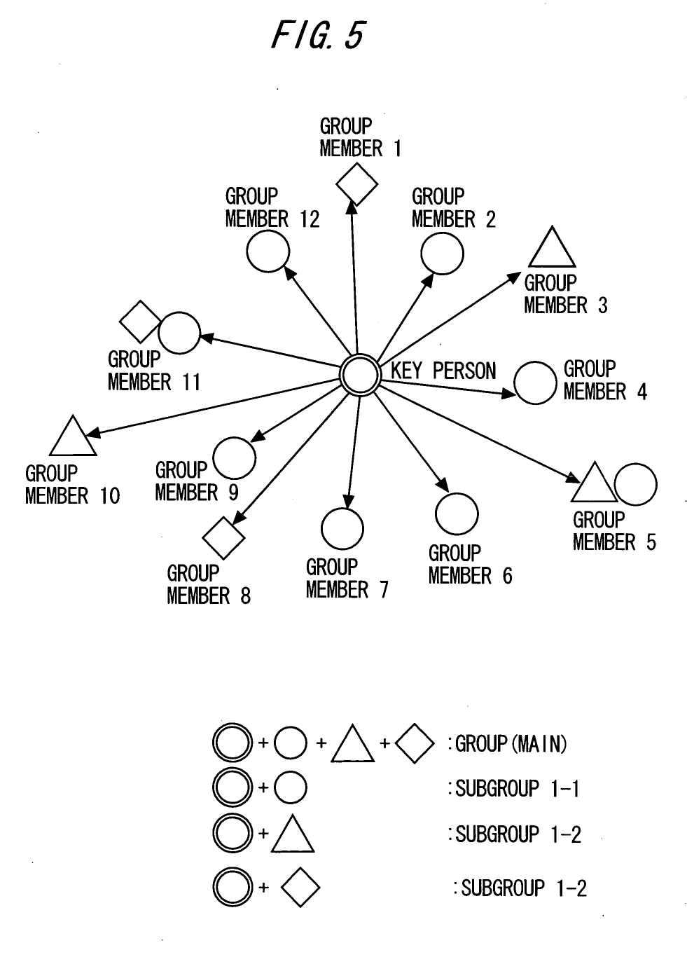

FIGS. 4 and 5 each show an image of how group members are organized.

FIG. 4 shows an image where members who have received a notification of designation as a group member from a key person further expand a group member organization with members at the next level. Upon registering for a system such as a TV conference, the key person can designate the permitted number of grouping levels. The group members can expand the group member organization within the range of the permitted number of grouping levels.

In terms of a group, subgroups can be organized at each level as described below. Instead of classification into the subgroups on a level basis, it is also possible to set a single group so as to include group members at all levels.

Level 1: A main group consisting of group members who directly receive a notification from the key person.

Level 2: A subgroup A obtained by adding, to the main group, group members who secondarily receive a notification from a member of the main group that has directly received a notification from the key person.

Level 3: A subgroup B obtained by further adding, to the subgroup A, group members who tertiarily receive a notification from a member.

FIG. 5 shows an image where members who have received a notification of designation as a group member from a key person are grouped into subgroups.

The key person notifies the group members of their designation, and after all the group members have completed their registration with the server 1, the key person can register the group members into subgroups. The group members who have directly received a notification from the key person belong to a main group, and as shown in FIG. 5, the group members are further classified into three subgroups 1-1, 1-2, and 1-3. Each group member can belong to plural subgroups (group member 5: subgroups 1-1 and 1-2, group member 11: subgroups 1-1 and 1-3).

In addition, the combination of the method of subgrouping on a level basis shown in FIG. 4 and the subgrouping method shown in FIG. 5 can be used.

§2. Structural Components of this System

2-1. Server 1

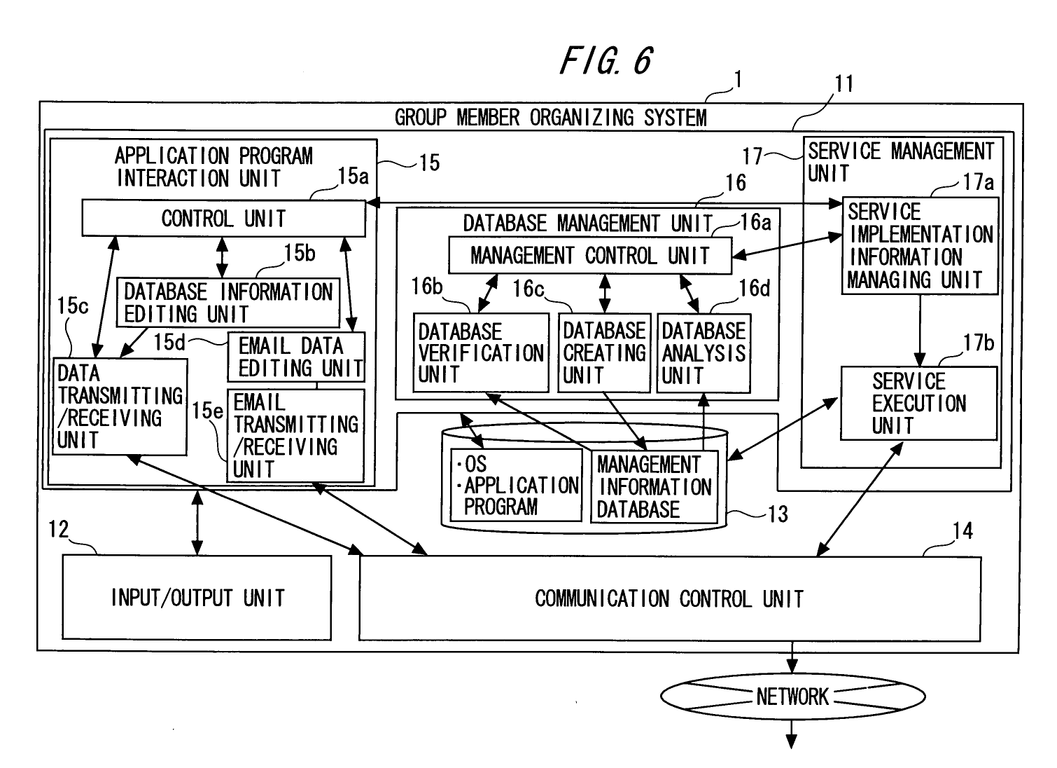

As shown in FIG. 6, the server 1 is a general computer including a processing unit 11 composed of a CPU and a main memory, an input/output unit 12, a storage device (hard disk drive) 13, and a communication control unit 14.

The storage device 13 stores a program for implementing a service (TV conference), an application program such as a member management program, and an operating system. The storage device 13 further stores management information including member information and a service list in a management information database built therein.

The processing unit 11 reads out to execute the program stored in the storage device 13 when necessary, thereby implementing a TV conference or performing a process for member management.

Particularly in this embodiment, based on the member management program, the processing unit 11 realizes functions of an application program interaction unit 15, a database management unit 16, and a service management unit 17.

The application program interaction unit 15 transmits/receives information for implementing a service to/from each of the terminals 2 and 3 through the communication control unit 14. The application program interaction unit 15 also functions as an application program control unit 15a, a database information editing unit 15b, a data transmitting/receiving unit 15c, an email data editing unit 15d, and an email transmitting/receiving unit 15e.

The application program control unit 15a performs control of an interaction process with respect to a terminal application program.

The database information editing unit 15b performs editing of information received from a management control unit 16a.

The email data editing unit 15d edits data for each member in an email format in order to transmit the data to the terminal of the corresponding member.

The email transmitting/receiving unit 15e performs transmission of the email format data edited by the email data editing unit 15d.

The data transmitting/receiving unit 15c performs transmission/reception of data based on HTTP or the like in response to a request from an application program.

The email transmitting/receiving unit 15e and the data transmitting/receiving unit 15c performs transmission/reception of email and transmission/reception of data, respectively, and therefore each function as: a request receiving unit that receives request information for a service from a key person terminal; a member information transmitting unit that transmits member information to the key person terminal; an application receiving unit that receives member application information created based on the member information from a group member terminal; and a group member information transmitting unit that transmits the member information created by a group member information creating unit to the group member terminal.

Further, the database management unit 16 manages data for the group member organization. The database management unit 16 includes the management control unit 16a, a database verification unit 16b, a database creating unit 16c, and a database analysis unit 16d.

The management control unit 16a performs control of the data management for the group member organization.

The database verification unit 16b performs verification and authentication of the provided information. The database verification unit 16b functions as: an application information verifying unit that verifies whether or not the member application information is authorized member application information based on the member information registered in a member information storing unit; and a member information verifying unit that, in the case of receiving member information along with a request for a service from the key person terminal or the group member terminal, verifies the received member information against member information registered in the member information storing unit in association with the requested service.

The database creating unit 16c creates a database from the provided information. The database creating unit 16c functions as: a list creating unit that creates a service list for the requested service based on the request information, and registers the service list in a list storing unit; a member information creating unit that creates member information based on the request information, and registers the member information in the member information storing unit in association with the service of the service list; and the group member information creating unit that creates member information on the group member terminal in the case where the member application information is judged as being authorized as a result of the verification thereof, and registers the member information in the member information storing unit.

The database analysis unit 16d analyzes data for the purpose of implementing a service.

The service management unit 17 performs management relating to the implementation of a service such as a TV conference. The service management unit 17 (corresponding to a service providing unit) includes a service implementation information managing unit 17a and a service execution unit 17b.

The service implementation information managing unit 17a manages information required when a service is implemented.

The service execution unit 17b executes the implementation of the service in accordance with an instruction from the service implementation information managing unit 17a.

For example, in the case where the service implementation information managing unit 17a receives from the database management unit 16 a notification that the member information is judged as being authorized as a result of the verification thereof, the service implementation information managing unit 17a notifies the service execution unit 17b of the start of the service, and the service execution unit 17b transmits information on the requested service back to the terminal that has transmitted the member information.

2-2. Key Person Terminal 2

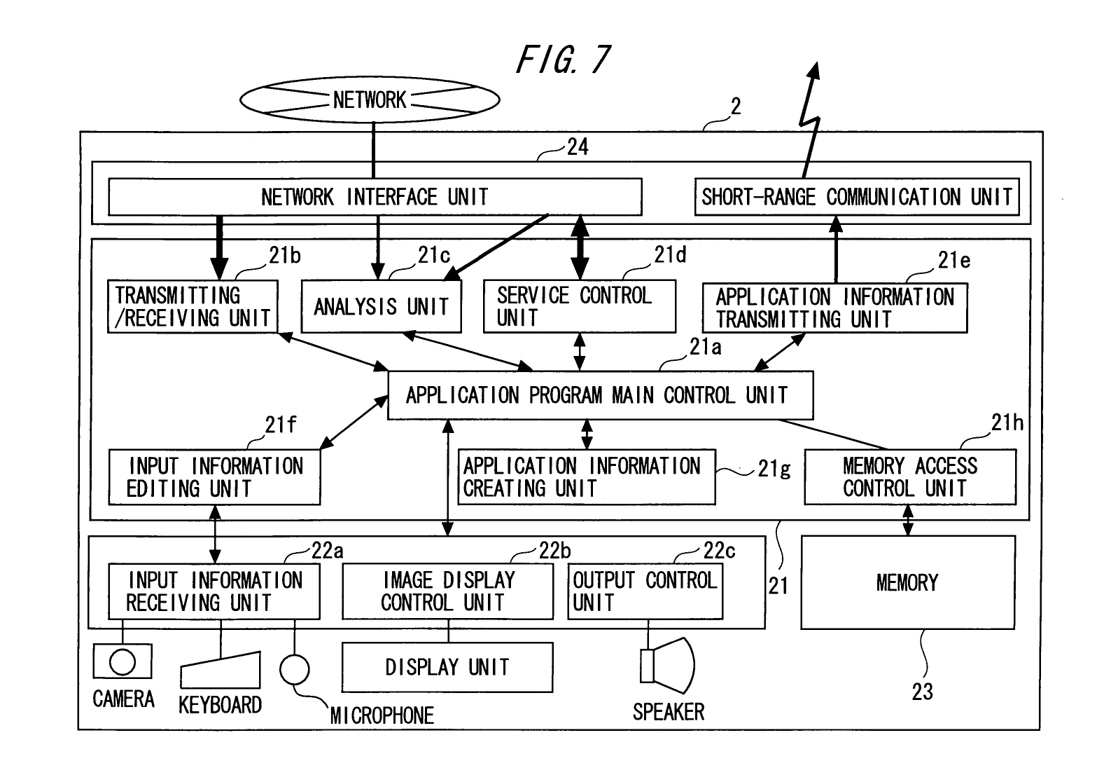

As shown in FIG. 7, the key person terminal 2 includes a processing unit 21 composed of a CPU and a memory, an input/output unit 22, a storage unit 23, and a communication control unit 24. In this embodiment, a mobile telephone is given as an example of the terminal 2, but there is no limitation thereon. Any terminal may be used as the terminal 2 as long as the terminal 2 is an information processor, namely, a computer, which can execute a predetermined process according to an application program for a conference.

The input/output unit 22 includes an input information receiving unit 22a, an image display control unit 22b, and an output control unit 22c. The input information receiving unit 22a receives information inputted through a member's operation of a button (keyboard), a voice inputted through a microphone, and an image of the member photographed with a camera, which are further inputted to the processing unit 21. The image display control unit 22b displays screens including a menu and the image of a current speaker in a display unit based on a display signal sent from the processing unit. The output control unit 22c performs output control based on an output signal sent from the processing unit 21. For example, voices of a TV conference are outputted from the speaker.

The storage unit (memory) 23 stores a program for receiving a service (TV conference), an application program such as a member management program, and an operating system for making a telephone call. By execution of the application program, information on a member is stored in a specific area of the memory 23.

The processing unit 21 reads out to execute the program stored in the memory 23 when necessary, thereby managing the member information required for participation in a TV conference.

Particularly in this embodiment, based on the member management program, the processing unit 21 realizes functions of an application program main control unit 21a, a transmitting/receiving unit 21b, an analysis unit 21c, a service control unit 21d, an application information transmitting unit 21e, an input information editing unit 21f, an application information creating unit 21g, and a memory access control unit 21h.

The application program main control unit 21a performs management regarding which function is to be executed and the like in accordance with operation of a terminal application program.

The transmitting/receiving unit 21b transmits/receives data to/from the server 1 through the communication control unit 24 via a protocol such as HTTP, and functions as: a request transmitting unit that transmits request information for a service to the server 1; and a member information receiving unit that receives member information created based on the request information from the server.

The analysis unit 21c analyzes activation data in the case where an application program is externally activated by email or infrared communication.

The service control unit 21d performs control relating to the implementation of a service, and functions as: a service requesting unit that transmits a request for a service and the member information to the server 1; and a service receiving unit that receives the information on the requested service.

The application information transmitting unit 21e transmits member application information to each group member terminal 3 via a protocol such as OBEX.

The input information editing unit 21f edits information inputted through the input information receiving unit 22a.

The memory access control unit 21h writes or reads information required for an application program (for example, member information) into or out of a predetermined memory area within the memory 23.

2-3. Group Member Terminal 3

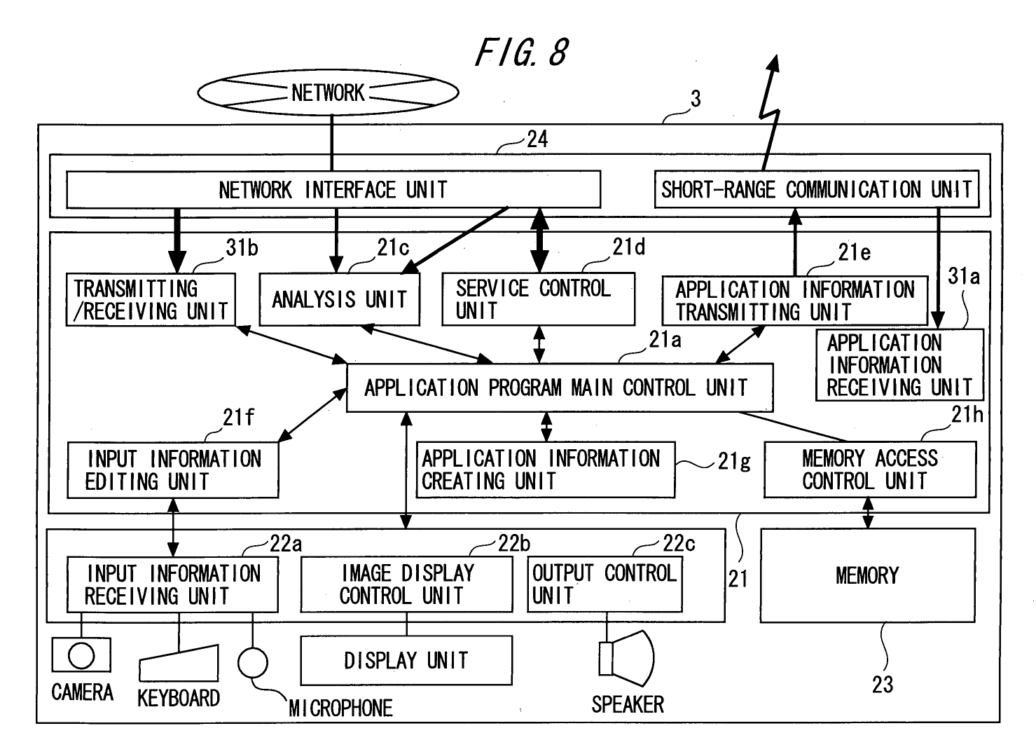

As shown in FIG. 8, the group member terminal 3 includes a processing unit 21 composed of a CPU and a memory, an input/output unit 22, a storage unit 23, a communication control unit 24. In this embodiment, a mobile telephone is given as an example of the group member terminal 3, but there is no limitation thereon. Any terminal may be used as the group member terminal 3 as long as the group member terminal 3 is an information processor, namely, a computer, which can execute a predetermined process according to an application program for a conference. The structure of the group member terminal 3 is the same as that of the key person terminal 2 described above except that the processing unit 21 of the group member terminal 3 realizes functions of an application information receiving unit 31a and a transmitting/receiving unit 31b.

The application information receiving unit 31a receives member application information from the key person terminal 2 or the group member terminal 3 through a short-range communication unit of the communication control unit 24 via a protocol such as OBEX.

The transmitting/receiving unit 31b transmits/receives data to/from the server 1 through the communication control unit 24 via a protocol such as HTTP, and also functions as: an application information transmitting unit that transmits the member application information to the server 1; and a member information receiving unit that receives member information created based on the member application information from the server 1.

Note that in this embodiment, the key person terminal 2 and the group member terminal 3 are separately provided. However, a single terminal may include all the units of the key person terminal 2 and all the units of the group member terminal 3, and may be configured so as to function as the key person terminal 2 upon request for a service and function as the group member terminal 3 upon participation in a service requested by another key person.

§3. Implementation Procedure for a TV Conference

As a service provided in this system, description will be made of an example of implementing a TV conference by use of mobile telephones.

First, when a key person inputs an execution of a conference application program to the terminal 2, the terminal 2 displays a main menu with the following items on a display. When the key person performs an input for selecting (hereinafter, such an input being referred to simply as “selection”) any of the items by operating a button with respect to the terminal 2, a process for the item is started.
Functions to be activated upon menu selection by a user
   Key person registration
   Group member registration by infrared communication
   Group member registration by email communication
   Subconference member registration
   Arbitrarily conference opening
   Group member list display
   Group member authorization registration
   Schedule display
   Schedule registration/modification
   Member deletion
   Conference withdrawal
   Conference dissolution

Also, in the case where the analysis unit 21c or the application information receiving unit 31a discriminates that a conference starting notification or member application information is received, the key person terminal 2 or the group member terminal 3 starts the following processes.
Functions allowed when a conference starting notification or application information notification is performed by infrared communication or by email
   Group member registration
   Conference participation (opening with designated date/cycle)
   Conference participation (opening arbitrarily)

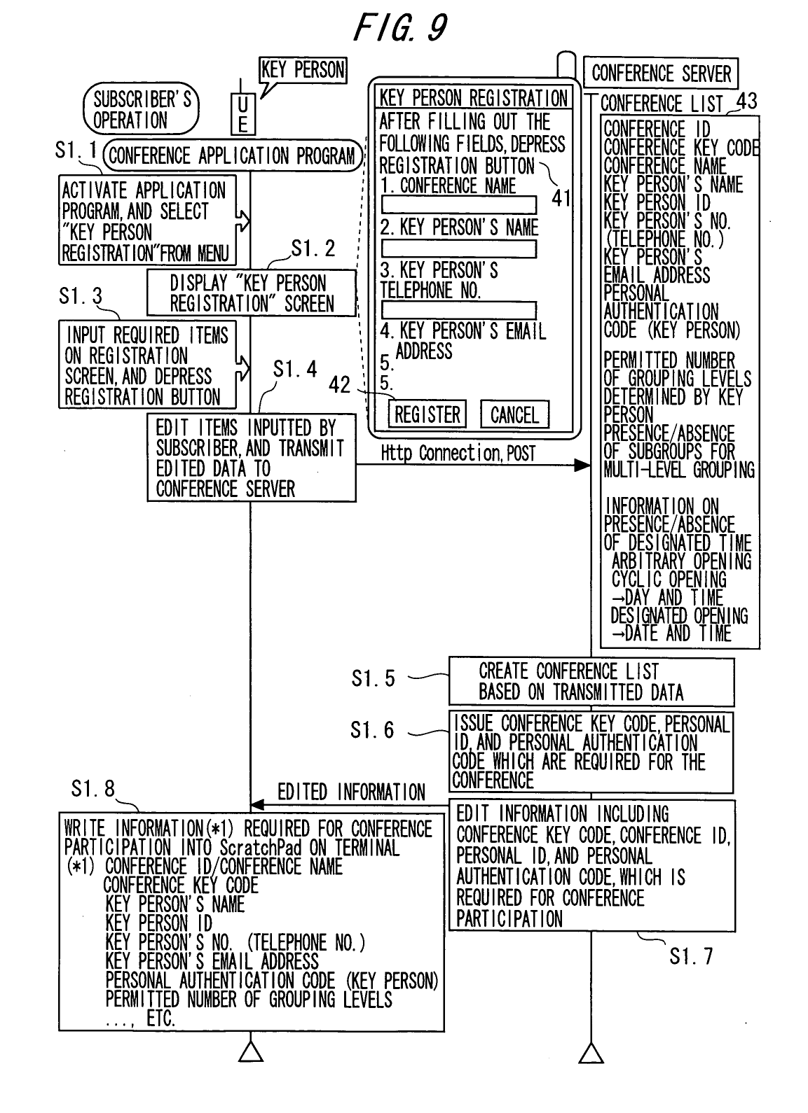

FIG. 9 shows a process flow applied when “Key person registration” is selected by a key person.

3-1. Key Person Registration Process

S1.1: When a user to be a key person activates the application program, the terminal 2 displays a main menu to urge the selection of a function. If the key person registration is selected, the terminal 2 starts this function.

S1.2: The terminal 2 displays a “Key person registration” screen 41 to urge the key person to input the following items.
Conference name
Key person's name
Key person's telephone number (telephone number of the terminal: it is optionally possible to display the telephone number registered in the terminal on the input screen even without the user's direct input)
Key person's email address (it is optionally possible to display the email address registered in the terminal on the input screen even without the user's direct input)
Conference opening mode (arbitrarily opening only, date designation (designation of an opening date), cycle designation (designation of an opening day and time), or the like).
Opening date and time for the date designation/opening day and time for the cycle designation
Permitted number of grouping levels determined by a key person
Presence/absence of subgroups for multi-level grouping

S1.3: After filling respective input fields displayed on the screen with those input items, the key person selects a registration button 42.

S1.4: Upon the selection of the registration button 42, the key person terminal 2 transmits information obtained from the respectively inputted items (request information) to a conference server 1 via POST in the HTTP protocol. Specifically, the input information editing unit 21f edits those inputted items as parameters of the request information for requesting a service from a data management program (program in the form of a servlet) stored on the conference server 1. The transmitting/receiving unit 21b calls the program via POST in the HTTP protocol, and transmits the request information to the program.

S1.5: When the conference server 1 receives the request information through the transmitting/receiving unit 15c, the control unit 15a passes the request information to the database management unit 16, and the database creating unit 16c creates a conference list 43 containing information on the conference, which includes a conference name, a conference key code, a conference ID, and a opening date and time, based on the request information.

S1.6: The database creating unit 16c also creates member information including a personal ID and a personal authentication code (password) required for the key person to participate in the conference, and registers the member information in association with the conference list (in the example of FIG. 9, the member information is contained in the conference list).

S1.7: The management control unit 16a passes the member information stored in the management information database to the application program interaction unit 15, and the transmitting/receiving unit 15c transmits the member information to the key person terminal 2.

S1.8: The key person terminal 2 receives the member information through the transmitting/receiving unit 21b, and the memory access control unit 21h writes the member information into the memory area (ScratchPad) of the memory 23. The following items are written into the ScratchPad as the member information.
Conference ID
Conference name
Conference key code
Key person's name
Key person ID
Key person's telephone number
Key person's email address
Personal authentication code (key person)
Permitted number of grouping levels
Etc.

Note that as another possible process, character data such as the key person's name and the conference name among those items may be stored not in the memory but only on the server 1 in the case where there are limitations on a memory size on a terminal or a data size for data transmission and other such cases, so that each time a name needs to be displayed in the application program, the application program inquires the name from the server 1. In this example, the limitations of a memory size and the limitations of a data size for data transmission are not particularly taken into consideration, and the description is made as that the character data is also stored in the memory on the terminal, and the character data is also transmitted upon the data transmission. Also, if the application program can obtain information on the telephone number or the email address from the terminal, the writing operation into the memory is not essential (the same applies to flows of subsequent embodiments).

In terms of the application program, an outline of the process for transmitting/receiving data is shown as the following procedure.

1. Specify a URL to open a Generic Connection Framework.

2. Set a POST request as an implementation instance of an HttpConnection interface.

3. Obtaining an implementation instance of an OutputStream interface for writing data into a request body, and write data thereinto. Set a data type of the request body in a request header.

4. Call a Connect method to connect to a Web server and execute the POST request.

5. Obtain data returned from the Web server (read out data via an InputStream).

6. Close the Generic Connection Framework (execute a Close method with respect to an implementation instance of the HttpConnection interface).

3-2. Group Member Registration Process (in a Face-to-face Manner by Infrared Communication)

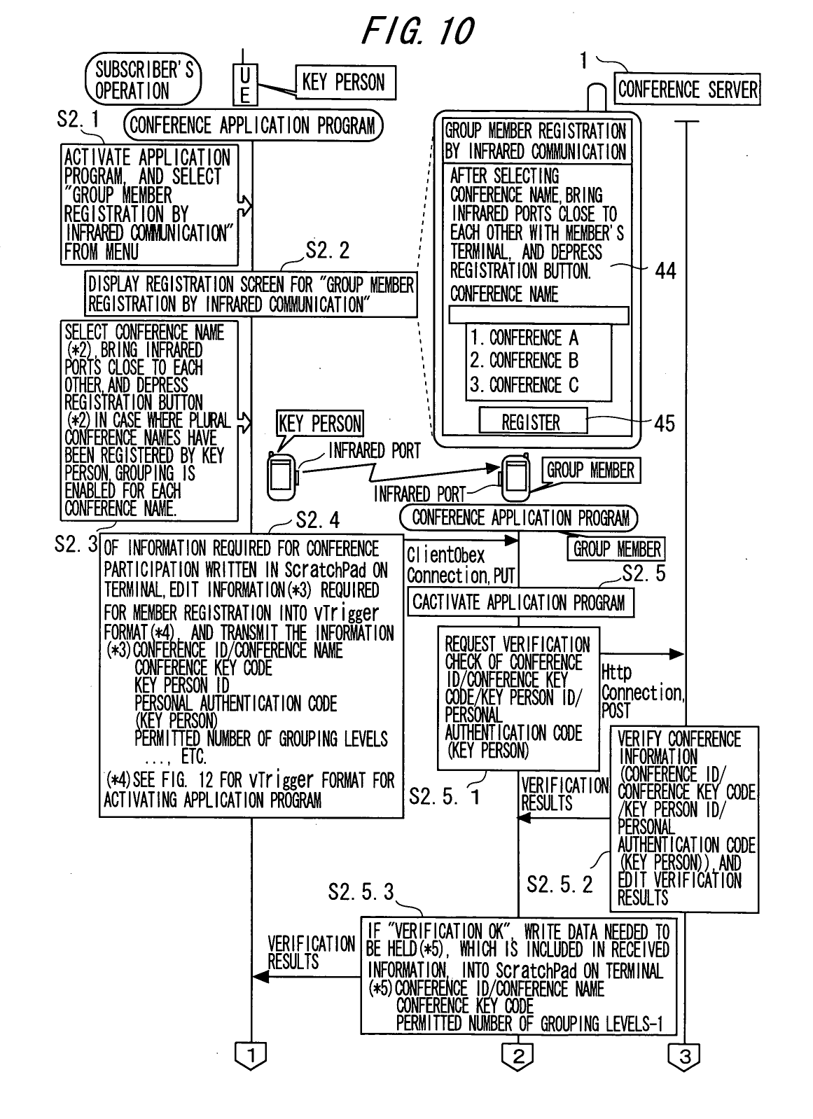

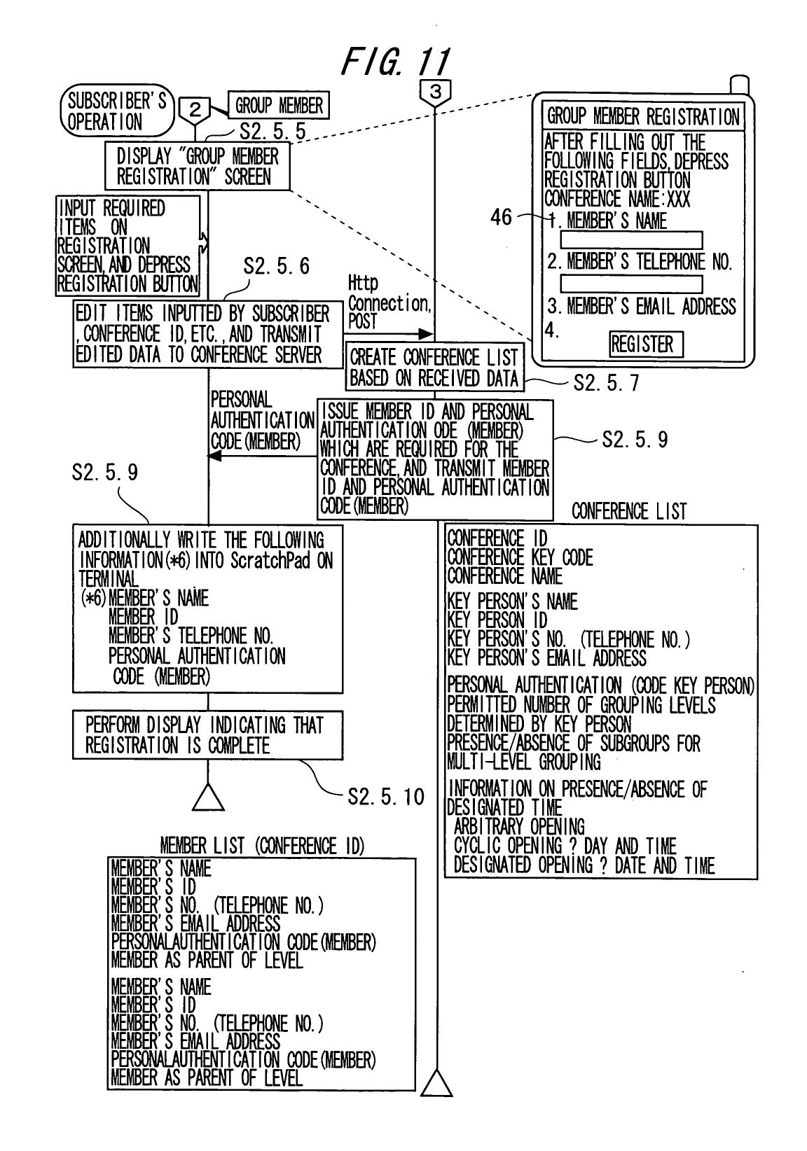

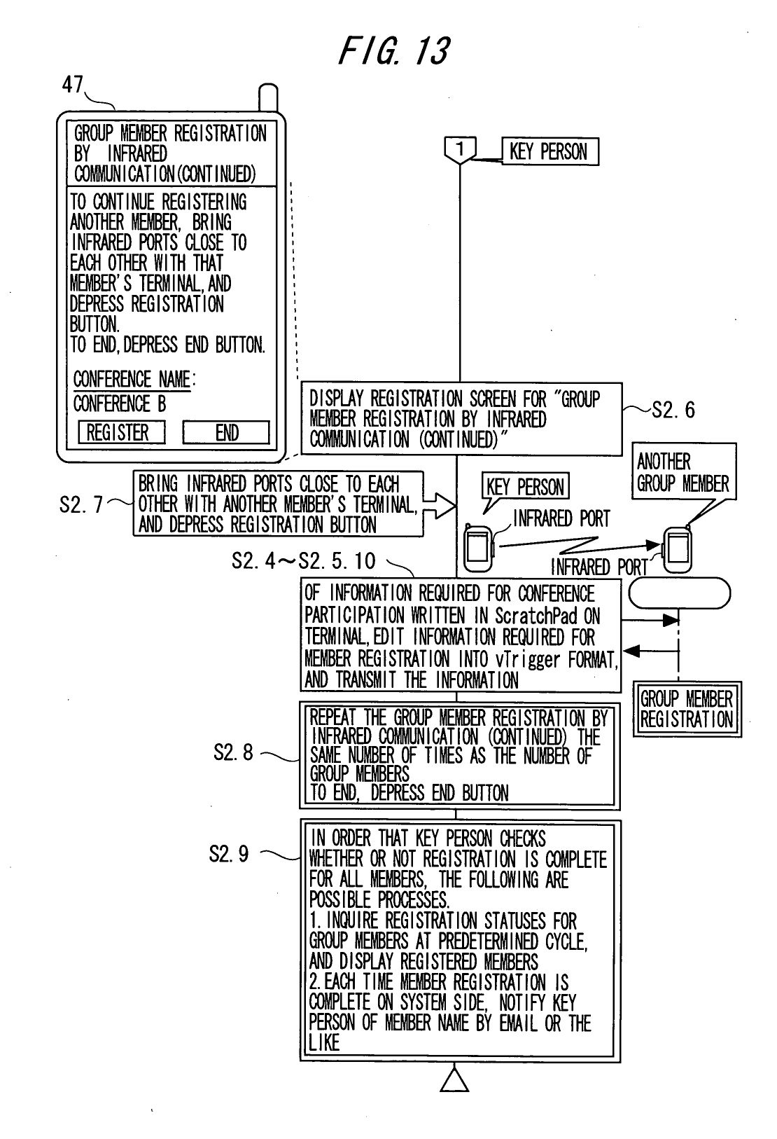

FIGS. 10, 11, and 13 show a flow of the group member registration process (grouping) performed by a key person. In a face-to-face communication, members pass information peer-to-peer upon their direct meeting when they meet face to face. In this face-to-face communication, the members can recognize their opponents when passing information, thereby preventing the information from leaking due to impersonation.

S2.1: The key person activates the application program and selects “Group member registration by infrared communication” from the menu.

S2.2: The terminal 2 displays the registration screen of “Group member registration by infrared communication” on the display to urge the key person to select a desired conference name for grouping from the list of conference names displayed on the screen (in the case where the plural conference names have been registered by the key person, the grouping is enabled for each of the conference names).

S2.3: The key person brings infrared ports close to each other between his/her own terminal 2 and a terminal 3 of a candidate group member for the grouping and selects a registration button 45.

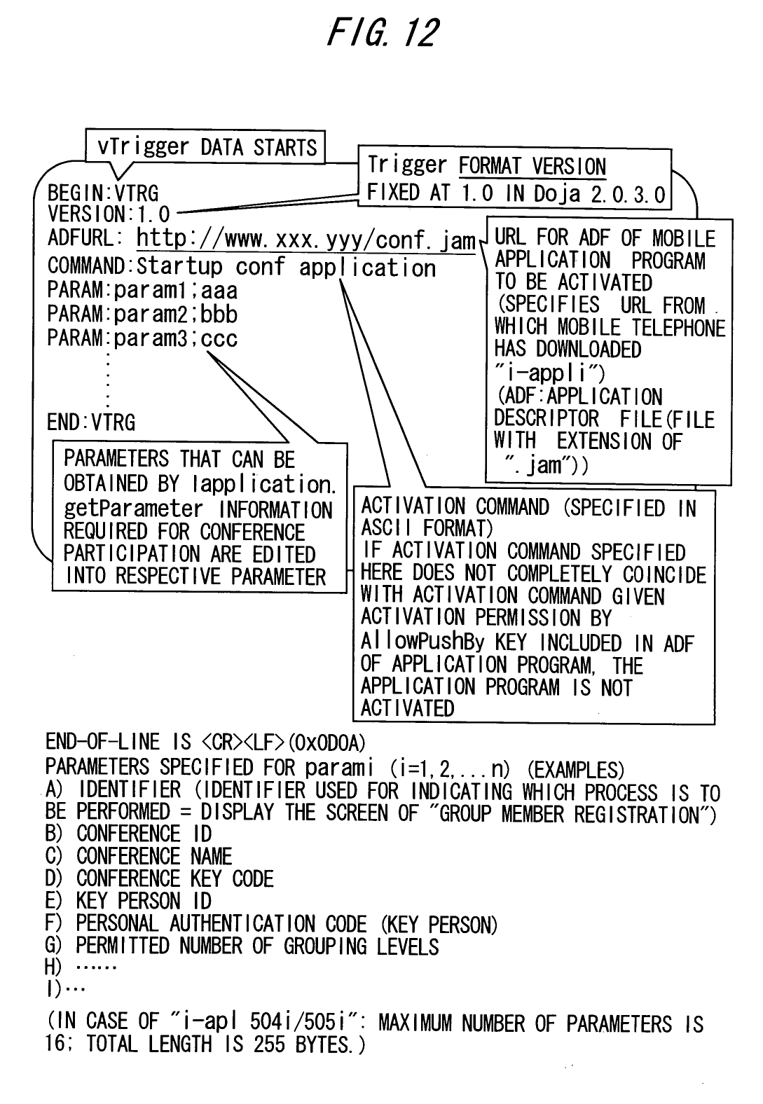

S2.4: Upon the selection of the registration button 45, in the key person terminal 2, the database creating unit 16c reads the member information written in the ScratchPad, and edits the following information required for member registration into parameters in a vTrigger format (see FIG. 12) to create the member application information, which is then transmitted via PUT in the OBEX protocol.
Conference ID
Conference name
Conference key code
Personal ID (key person ID)
Personal authentication code (key person)
Permitted number of grouping levels
Etc.

Note that as another parameter in the vTrigger format, an identifier indicating which process is to be performed on the terminal that receives the information is added to the above-mentioned items. Here, “identifier=display the screen of ‘Group member registration’” is specified.

S2.5: In the group member terminal 3 receiving data, if the application information receiving unit 31a receives the member application information, a dialogue is displayed to ask the group member whether or not the application program is to be activated. If the activation is selected, the procedure advances to the following process.

S2.5.1: In the group member terminal 3, the application information transmitting unit 21e transmits the received member application information to the conference server 1 via POST in the HTTP protocol to request the conference server 1 to verify the member application information.

S2.5.2: In the conference server 1, the database verification unit 16b verifies whether or not the received member application information including a conference ID, a conference key code, a key person ID, and a personal authentication code (key person) coincides with the member information on the key person registered in the management information database. If the coincidence is verified, the database creating unit 16c creates member information including the following items, and the data transmitting/receiving unit 15c transmits the member information to the group member terminal 3 as process results while registering the member information in the management information database. Alternatively, if the coincidence is not verified as a result of the verification, the server 1 transmits an error message to the terminal 3 as verification results.
Conference ID
Conference name
Conference key code
Permitted number of grouping levels-1

S2.5.3: The group member terminal 3 writes the verification results received from the server 1 into the ScratchPad, and transmits the verification results to the key person terminal 2. In that case, the group member terminal 3 may transmit only the results of whether the member application information has been normally received or not (verified or not), instead of all the above items, as the process results.

S2.5.4: The key person terminal 2 receives the process results.

S2.5.5: Then, the group member terminal 3 displays a group member registration screen 46 based on “identifier=display the screen of ‘Group member registration’”.

S2.5.6: When the user inputs the following items on the screen and selects the registration, the terminal 3 transmits the input information to the conference server 1 as the member application information via POST in the HTTP protocol.
Member's name
Member's telephone number (telephone number of the terminal: it is optionally possible that the telephone number registered in the memory 23 is read out onto the input screen and automatically inputted even without the user's direct input)
Member's email address (it is optionally possible that the telephone number registered in the memory 23 is read out and automatically inputted even without the user's direct input)
Etc.

S2.5.7: The conference server 1 creates the conference list based on the transmitted member application.

S2.5.8: The conference server 1 issues a personal ID (member ID) and a personal authentication code (group member) required for the conference, and creates member information that allows the user to participate in the conference, followed by transmission thereof to the terminal 3. The conference server 1 also adds the member information to the member information created in S2.5.1 and registers the resultant member information in the management information database.

S2.5.9: The group member terminal 3 that has received the member information additionally writes the following data into the ScratchPad based on the member information.
Member's name
Member ID
Member's telephone number
Personal authentication code (member)
Etc.

S2.5.10: The group member terminal 3 performs display indicating that the registration is complete.

S2.6: After the member registration performed on the first group member, the key person terminal 2 displays a screen of “Group member registration by infrared communication (continued)”.

S2.7: When the key person brings infrared ports close to each other between his/her own terminal 2 and a terminal 3 of a second candidate group member for the grouping and selects the registration, the steps of S2.4 to S2.5.10 are performed similarly.

S2.8: After the key person repeated “Group member registration by infrared communication (continued)” the same number of times as the number of group members, “end” is selected to end the procedure.

S2.9: In order that the key person checks whether or not the registration is complete for all the members, the following process is performed.

(1) Registration statuses for the group members are inquired of the server 1 at a predetermined cycle, and registered members are displayed.

(2) Each time the member registration is complete on the server 1 side, the key person is notified of the member name by email or the like.

Note that in the above group member registration process, the steps performed by the key person and its terminal 2 may be performed by a group member who has received member information from the key person and the terminal 3 of the group member. Accordingly, in addition to the member who is directly designated by the key person, the designated member can also designate another member. At this time, it is desirable that the designation be permitted within the permitted levels set by the key person. In that case, for example, in the server 1, the database analysis unit 16d judges whether or not the permitted number of levels in the member application information received in step 2.5.2 is equal to or more than a predetermined value. If the number is equal to or more than the predetermined value, the database creating unit 16c creates member information by performing subtraction on the permitted number of levels, and transmits the member information to the group member terminal.

In the case where the group member terminal 3 that has received the member information performs the group member registration process in place of the key person terminal 2, in step 2.4, the member application information is created so as to include the permitted number of levels in the member information, and transmitted to another group member terminal 3.

If this group member terminal 3 is at a level exceeding the permitted number of levels set by the key person, the permitted number of levels of the member application information is judged as below the predetermined value, making it impossible to perform member registration.

Note that the judgment as to whether or not the number of levels is within the permitted range may be performed by the terminal 3. For example, when the conference name is selected in steps 2.2 and 2.3, the terminal 3 references the permitted number of levels of the member information. If the number is equal to or more than a predetermined value (for example, 1 or more), the registration process is continued. If the number is lower than the predetermined value, the terminal 3 displays an indication of exceeding the permitted range of the key person and discontinues the process. Alternatively, upon displaying a registration screen 44, the terminal 3 may reference the permitted number of levels and performs setting such that the conference name of a conference at a level below a predetermined number is not displayed to prohibit the registration process for such a conference.

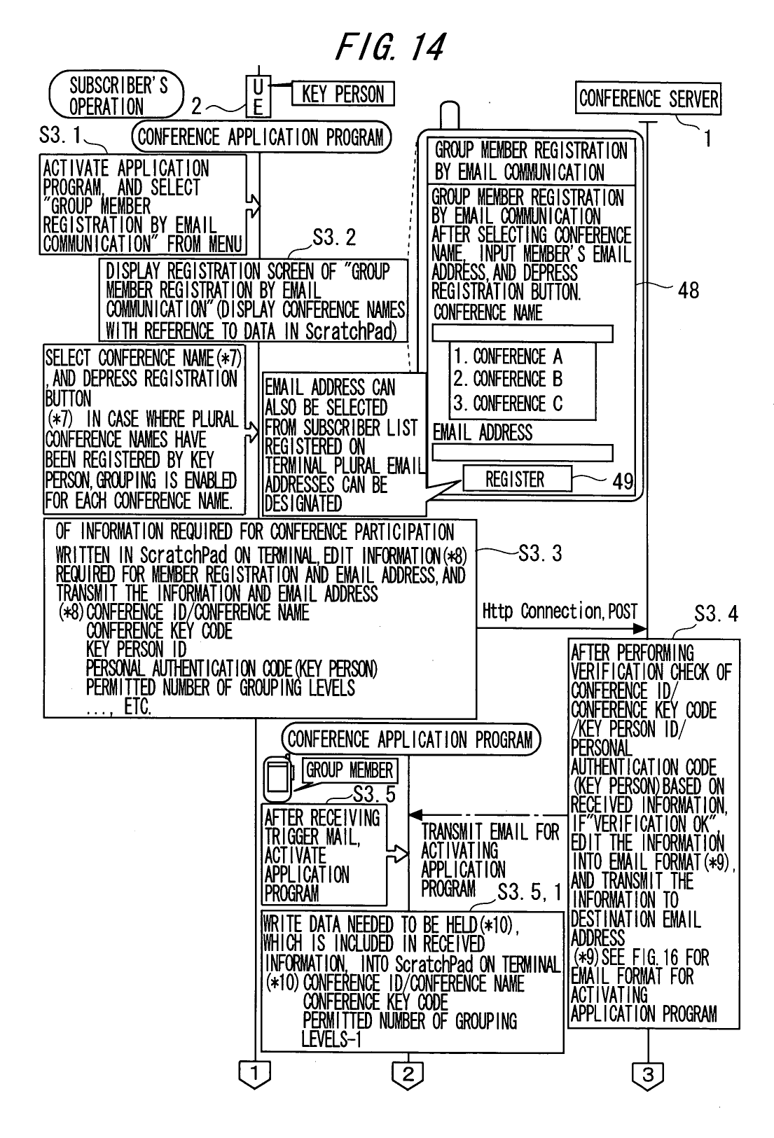

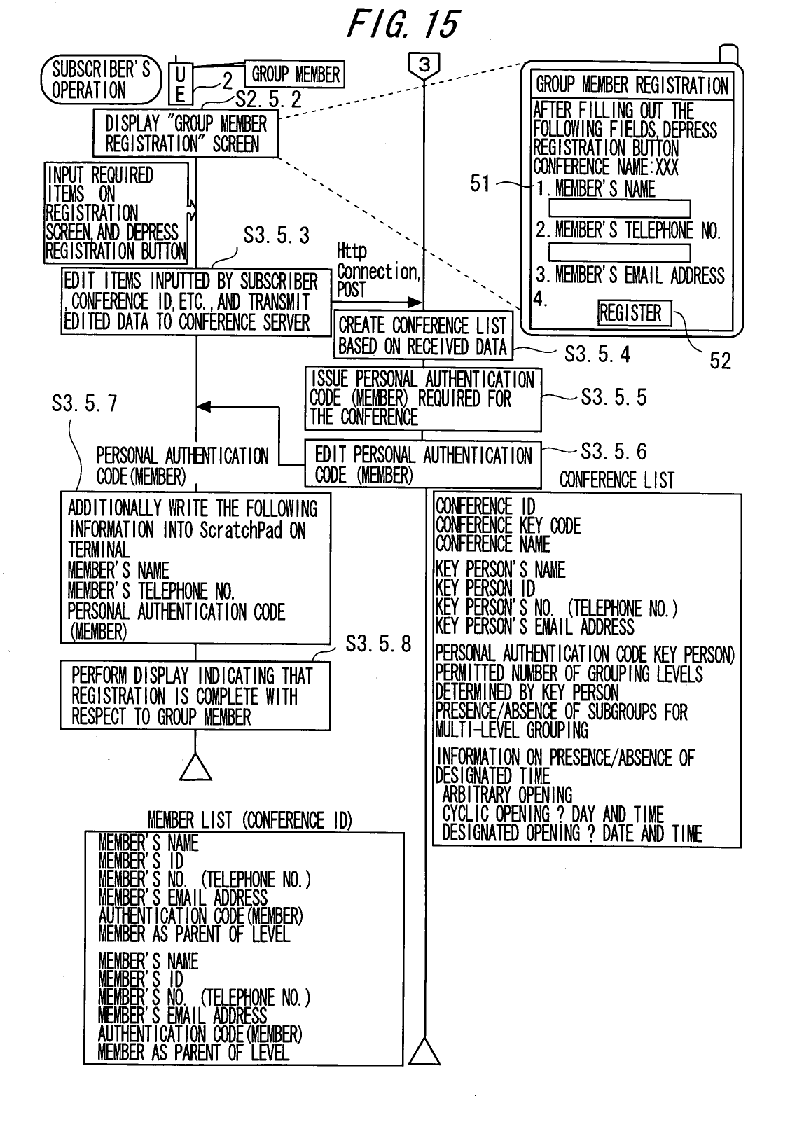

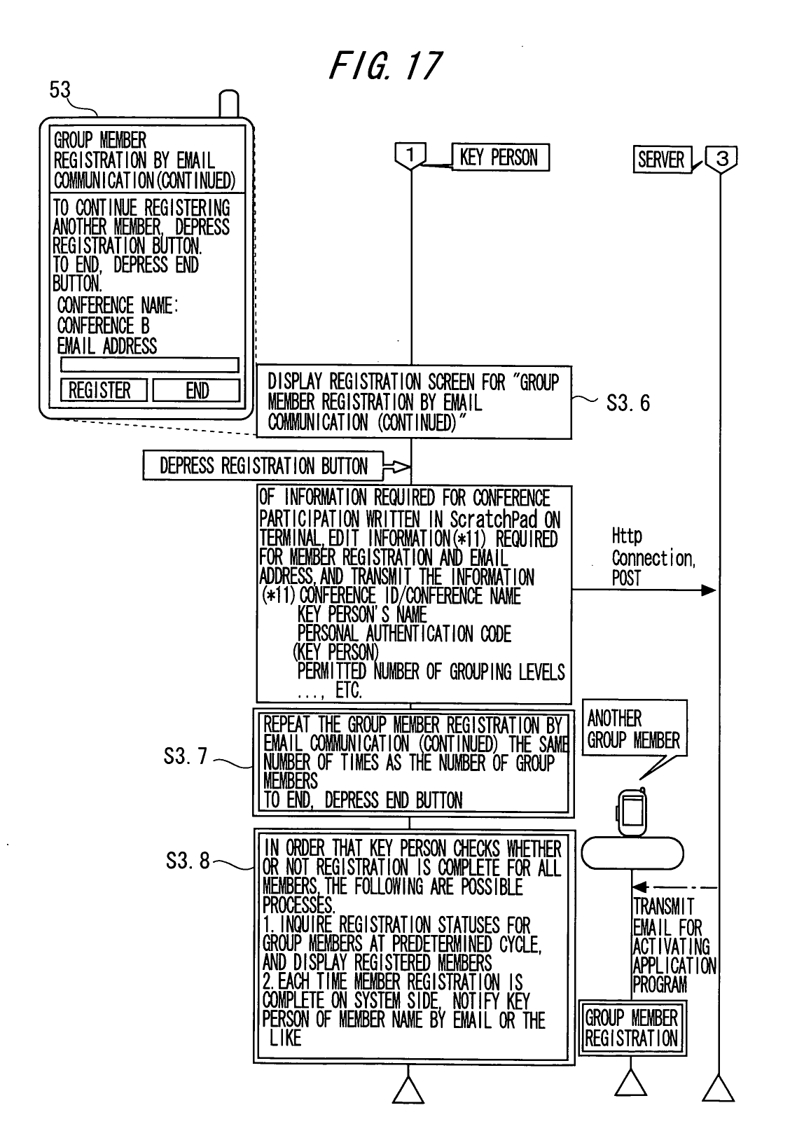

3-3. Group Member Registration Process (in a Non-face-to-face Manner by email Communication) FIGS. 14, 15, and 17 show another flow of the group member registration process performed by a key person (in a non-face-to-face manner by email communication).

S3.1: The key person activates the application program and selects “Group member registration by email communication” from the menu.

S3.2: When this selection is made, the key person terminal 2 displays-a registration screen 48 of “Group member registration by email communication”, and the user selects the name of a desired conference from the conference names displayed on the screen and inputs the email address of a user to be a group member. In the case where the plural conference names have been registered by the key person, the grouping is enabled for each of the conference names. The email address can also be selected from a subscriber list registered on the terminal, and plural addresses can be specified as well.

S3.3: When the key person selects the a registration button 49, the terminal 2 creates the following member application information required for the member registration based on the inputted email address and other information required for participation in the conference which is written in the ScratchPad on the terminal, and transmits the member application information to the conference server 1 via POST in the HTTP protocol.
Conference ID
Conference name
Conference key code
Key person ID
Personal authentication code (key person)
Permitted number of grouping levels
Etc.

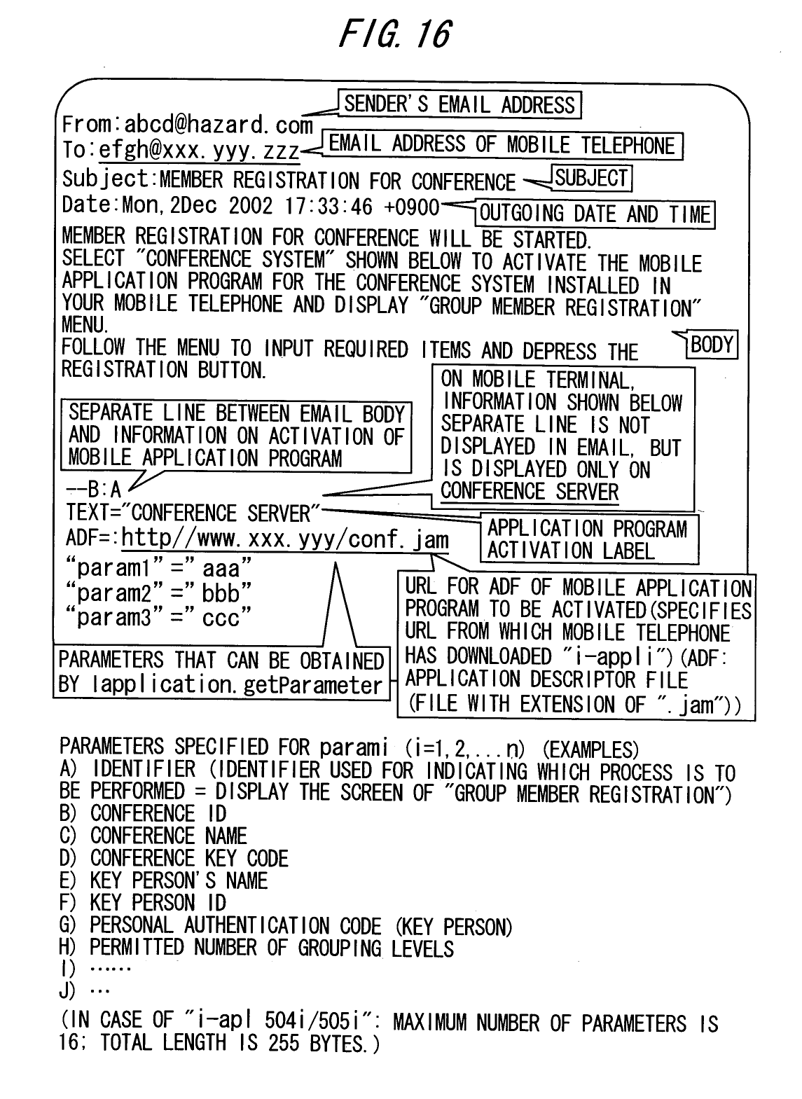

S3.4: The conference server 1 performs a verification check on the conference ID for the member application information, the conference key code, the key person ID, and the personal authentication code (key person) that have been transmitted. After that, in the case of “verification OK”, the above information is edited into an email format (see FIG. 16) for activation of the application program for the group member, and the resultant email is transmitted to a destination email address. The following information is edited as parameters to be contained in the email.
Conference ID
Conference name
Conference key code
Key person's name
Key person ID
Personal authentication code (key person)
Permitted number of grouping levels
Etc.

Note that as another parameter to be contained in the email, an identifier indicating which process is to be performed on the terminal that receives the information is added to the above-mentioned information. Here, “identifier=display the screen of ‘Group member registration’” is specified. Also, in this example, the server 1 relays the email for the member application information from the key person terminal 2 to the group member terminal 3, but there is no limitation on this relaying manner, and another mail server may relay the email therebetween.

S3.5: In the group member terminal 3 receiving data, after receiving the member application information by this email, a dialogue is displayed to ask the group member whether or not the application program is to be activated. If the activation of the application program is selected, the group member terminal 3 activates the application program, and the procedure advances to the following process.

S3.5.1: The group member terminal 3 writes the following data needed to be held, which is included in the received member application information, into the ScratchPad.
Conference ID
Conference name
Conference key code
Permitted number of grouping levels-1

S3.5.2: The group member terminal 3 displays a group member registration screen 51 based on “identifier=display the screen of ‘Group member registration’”.

S3.5.3: When the user inputs the following items on the registration screen and selects a registration button 52, the group member terminal 3 adds the information of the input items to the member application information, and transmits the member application information to a conference server 54 via POST in the HTTP protocol.
Member's name
Member's telephone number (telephone number of the terminal: it is optionally possible to display the telephone number registered in the terminal on the input screen even without the user's direct input)
Member's email address (it is optionally possible to display the email address registered in the terminal on the input screen even without the user's direct input)
Etc.

S3.5.4: The conference server 1 creates the conference list based on the transmitted member application information.

S3.5.5: The conference server 1 also issues a member ID and a personal authentication code (member) required for the conference, creates member information that allows the user to participate in the conference, and registers the member information in the management information database in association with the conference list.

S3.5.6: Then, the data transmitting/receiving unit 15c of the conference server 1 transmits the member information to the email address, that is, to the group member terminal 3.

S3.5.7: Based on the received member information, the group member terminal 3 writes the following data into the ScratchPad as the information required for participation in the conference.
Member's name
Member ID
Member's telephone number
Personal authentication code (member)
Etc.

S3.5.8: The group member terminal 3 performs display indicating that the registration is complete.

S3.6: After the member registration has been performed on the first group member, the key person terminal 2 displays a “Group member registration by email communication (continued)” screen 53.

When the key person specifies the email address of a user terminal of a second candidate group member to continue the registration process, the processes in the above steps of S3.3 to S3.5.8 are performed similarly.

S3.7: After the key person repeated “Group member registration by email communication (continued)” the same number of times as the number of group members, “end” is selected to end the procedure.

S3.8: In order that the key person checks whether or not the registration is complete for all the members, the terminal 2 performs the following process.

(1) Registration statuses for the group members are inquired of the system at a predetermined cycle, and registered members are displayed.

(2) Each time the member registration is complete on the system side, the key person is notified of the member name by email or the like.

Note that in the above group member registration process, the steps performed by the key person and its terminal 2 may be performed by a group member who has received member information from the key person and the terminal 3 of the group member. Accordingly, in addition to the member who is directly designated by the key person, the designated member can also designate another member. At this time, it is desirable that the designation be permitted within the permitted levels set by the key person. In that case, for example, in the server 1, the database analysis unit 16d judges whether or not the permitted number of levels in the member application information received in step 3.4 is equal to or more than a predetermined value. If the number is equal to or more than the predetermined value, the database creating unit 16c creates member information by performing subtraction on the permitted number of levels, and transmits the member information to the group member terminal 3.

In the case where the group member terminal 3 that has received the member information performs the group member registration process in place of the key person terminal 2, in step 3.3, the member application information is created so as to include the permitted number of levels in the member information, and transmitted to another group member terminal 3.

If this group member terminal 3 is at a level exceeding the permitted number of levels set by the key person, the permitted number of levels of the member application information is judged as below the predetermined value, making it impossible to perform member registration.

Note that the judgment as to whether or not the number of levels is within the permitted range may be performed by the terminal 3. For example, when the conference name is selected in step 3.2, the terminal 3 references the permitted number of levels of the member information. If the number is equal to or more than a predetermined value (for example, 1 or more), the registration process is continued. If the number is lower than the predetermined value, the terminal 3 displays an indication of exceeding the permitted range of the key person and discontinues the process. Alternatively, upon displaying the registration screen 48, the terminal 3 may reference the permitted number of levels and performs setting such that the conference name of a conference at a level below a predetermined number is not displayed to prohibit the registration process for such a conference.

3-4. Subconference Member Registration Process

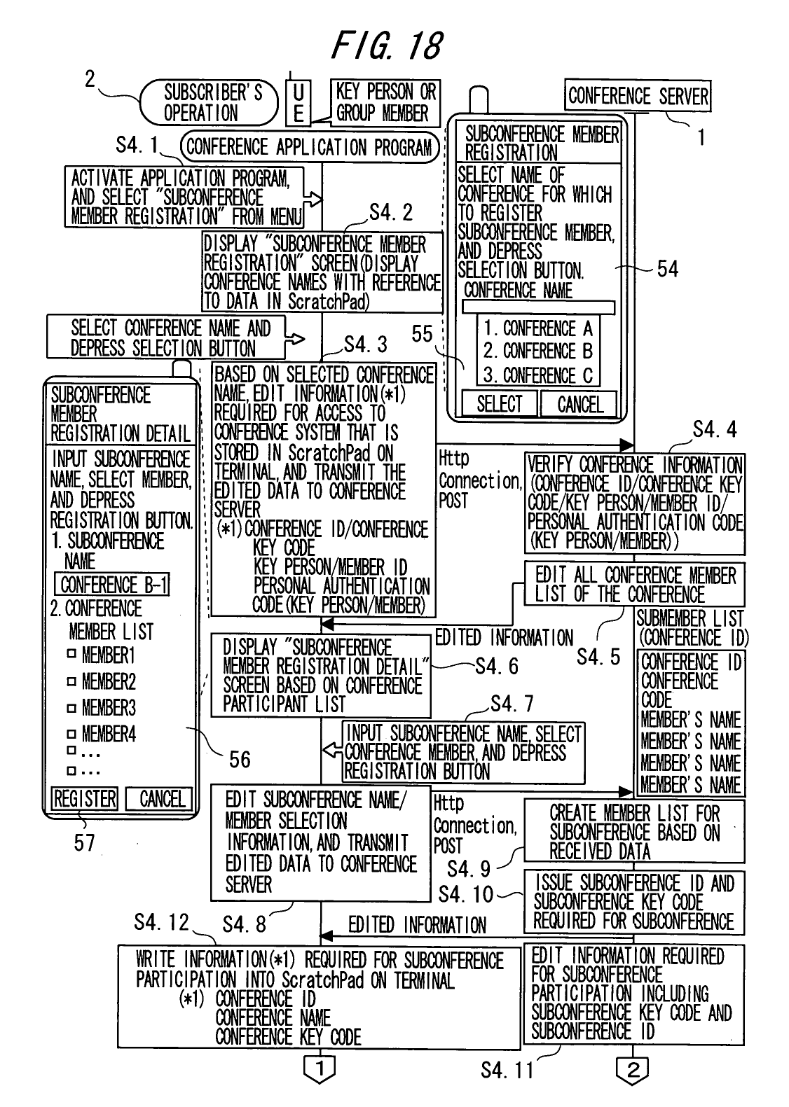

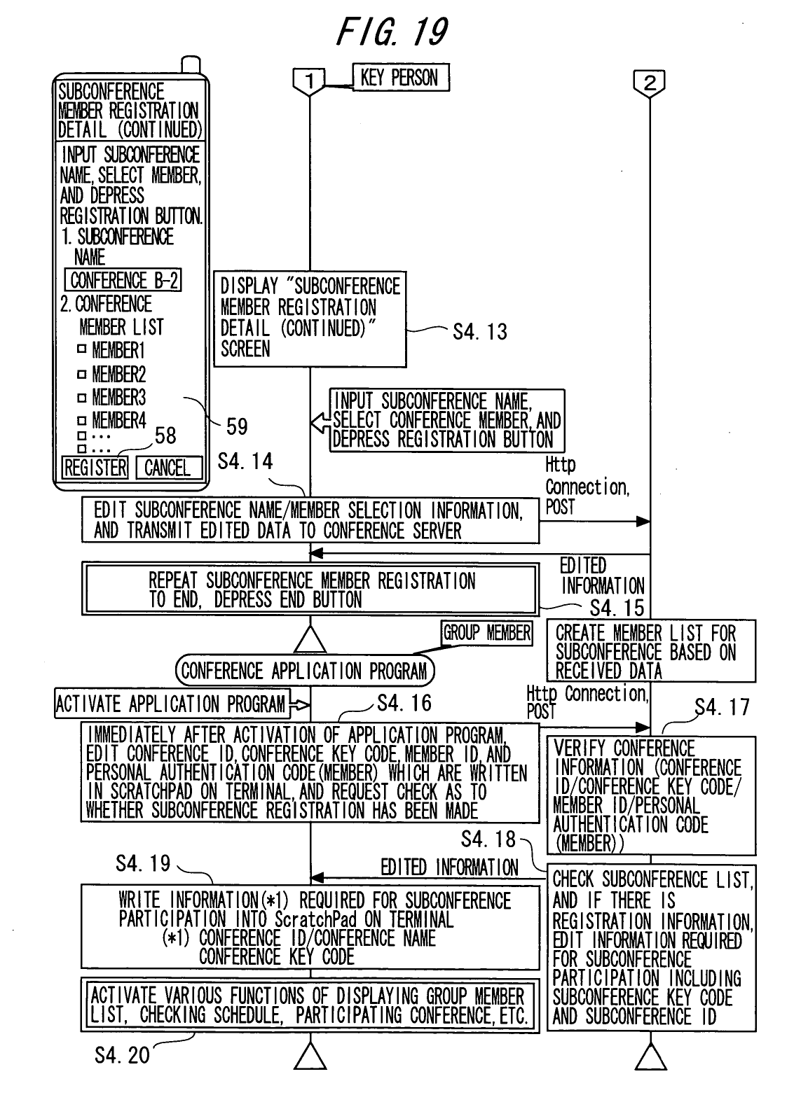

FIGS. 18 and 19 show a flow of the subconference member registration process.

S4.1: A key person (or a group member with a permission of the key person) activates the application program and selects “Subconference member registration” from the menu.

S4.2: The terminal 2 displays a “Subconference member registration” screen 54, and the user selects a desired conference name from the list of conference names displayed on the screen (The conference name is displayed referencing the data in the ScratchPad. In the case where the conference name is not stored in the ScratchPad, the terminal 2 inquires the conference name from the server to obtain and display the registered conference name.).

S4.3: When the key person depressed a selection button 55, the terminal 2 edits the following information written in the ScratchPad which is required for access to a conference system, and then transmits the edited information to the conference server via-POST in the HTTP-protocol.
Conference ID
Conference key code
Key person/member ID
Personal authentication code (key person/member)
Etc.

S4.4-S4.5: With a management data referencing program for the conference server 1, based on the transmitted data, the verification is performed on conference information (conference ID/conference key code/key person/member ID/personal authentication code (key person/member)), a conference member list for the conference including all the members is edited and transmitted to the terminal 2.

S4.6: The terminal 2 that has received the member list displays a “Subconference member registration detail” screen 56 based on the member list.

S4.7: The key person inputs a subconference name, selects a conference member (for example, puts a checkmark to a necessary member), and then selects a registration button 57.

S4.8: The key person terminal 2 edits the inputted subconference name or information on the selected member to create request information for the subconference, and transmits the request information to the conference server 1.

S4.9˜S4.11: The conference server creates a member list for the subconference based on the received data, and issues a conference ID and a conference key code for the subconference. After that the conference server creates member information required for participation in the subconference, and transmits the member information to the key person terminal 2.

S4.12: The terminal 2 that has received the member information writes the member information into the ScratchPad on the terminal as the information required for participation in the subconference. The data to be written into the ScratchPad includes the following.
Conference ID
Conference name
Conference key code
Etc.

S4.13˜S4.14: The key person terminal 2 displays a “Subconference member registration detail (continued)” screen 58, and the key person repeats the selection of the above-mentioned subconference member registration when necessary.

S4.15: The key person selects an end button 59 to end the procedure.

S4.16: The terminal 3 of the group member registered as a member in the subconference member registration process inquires from the server 1 whether or not a subconference that is not stored in the ScratchPad is registered when the application program is activated for group member list display, schedule display, or conference participation. For example, the conference information (conference ID/conference key code/member ID/personal authentication code (member)) is extracted from the ScratchPad and transmits the conference information to the server 1.

S4.17: The conference server 1 verifies the conference information against the information stored in the management information database.

S4.18: If the coincidence of the information is verified, the conference server 1 checks the subconference list, and if there is any registration information left untransmitted to the terminal 3, transmits the member information including the subconference key code and the subconference ID required for participation in the subconference to the terminal 3.

S4.19: The terminal 3 that has received the member information writes the member information into the ScratchPad as the information required for participation in the subconference. The data to be written into the ScratchPad includes the following.
Conference ID
Conference name
Conference key code
Etc.

S4.20: The terminal 3 activates the application program for the originally desired processes including group member list display, schedule display, and conference participation.

Note that in the subconference member registration process, the steps performed by the key person and its terminal 2 may be performed by a group member who has received a permission from the key person and the terminal 3 of the group member.

3-5. Conference Participation Process (Opening With Designated Date/cycle)

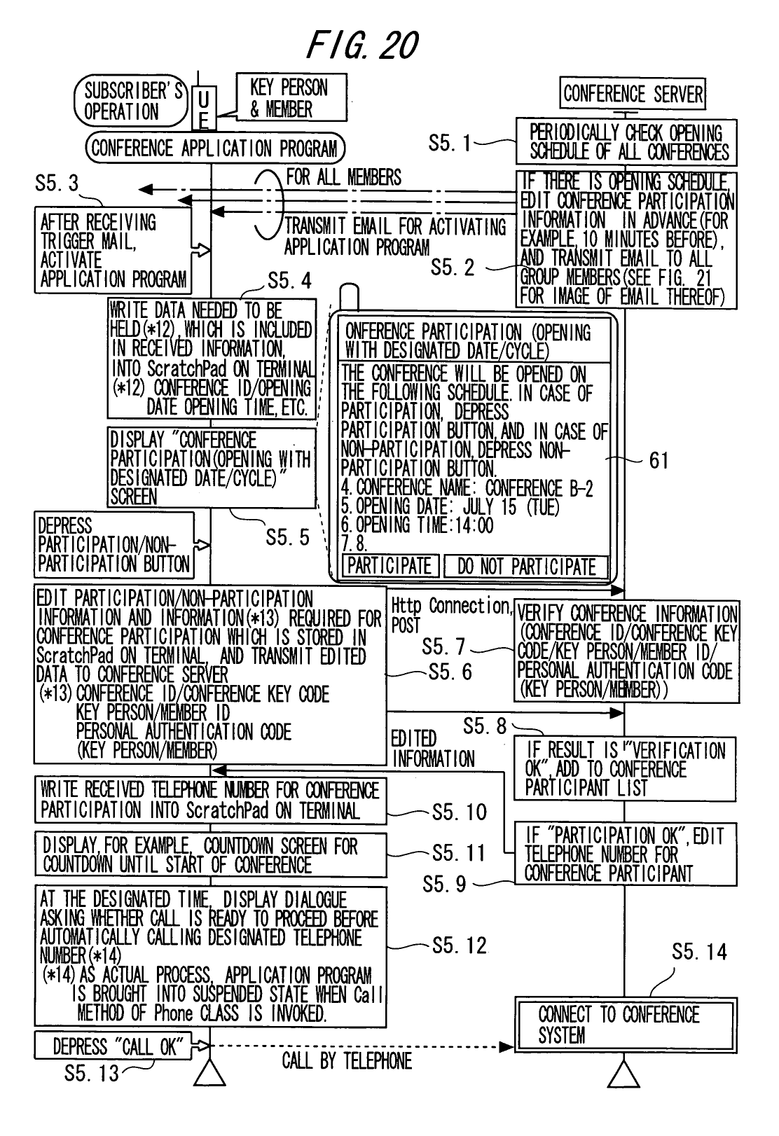

FIG. 20 shows a flow of the conference participation process (opening with designated date/cycle).

S5.1: The conference server 1 references the conference list periodically and checks whether or not there is a conference to be opened.

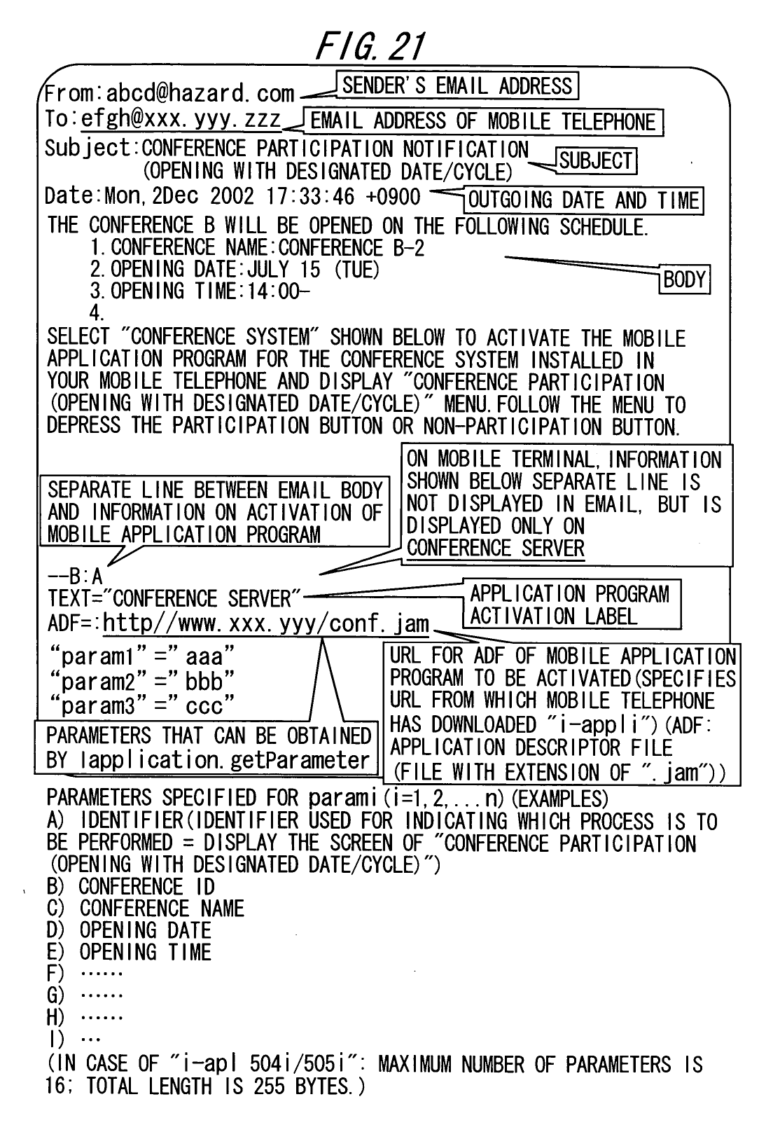

S5.2: If there is a conference to be opened, the conference server 1 extracts the information (including a conference ID, a conference name, an opening date, and an opening time) relating to this conference from the management information database to create conference participation information, and transmits the conference participation information to all the terminals 2 and 3 that participate in the conference (see FIG. 21 for the image of an email therefor).

S5.3: Upon receiving an email regarding the conference participation information to be a trigger, the group member terminal 3 displays a dialogue to urge the selection of whether or not to activate the application program. If the group member selects the activation, the terminal 3 activates the application program to start the conference participation process. Note that hereinafter, description will be made of the steps for allowing a group member to use the terminal 3 to participate in the conference, but the steps for allowing a key person to use the terminal 2 to participate in the conference are the same. Thus, description of the latter steps will be omitted.

S5.4: The group member terminal 3 writes the following data needed to be held, which is included in the received conference participation information, into the ScratchPad.
Conference ID
Conference name
Opening date
Opening time
Etc.

S5.5: The group member terminal 3 displays a “Terminal's conference participation (opening with designated date/cycle)” screen.

S5.6: If the group member depresses a button for participation or non-participation, the terminal 3 edits participation/non-participation information and the following information required for the conference participation which is stored in the ScratchPad on the terminal, and transmits the member information to the conference server 1.
Conference ID
Conference key code
Key person/member ID
Personal authentication code (key person/member)
Etc.

S5.7˜S5.9: In the conference server 1, the verification is performed on the received member information (conference ID/conference key code/key person/member ID/personal authentication code (key person/member)). If the result is “verification OK”, the member is added to a participation member list, and the terminal 3 of the group member permitted to participate in the conference is notified of a telephone number for the conference participation.

S5.10: The group member terminal 3 writes the received telephone number for the conference participation into the ScratchPad.

S5.11: The group member terminal 3 displays on the display, for example, a countdown screen for countdown until the start of the conference, and waits until the opening time (This step may simply be a standby state instead of displaying the countdown screen or the like in particular.).

S5.12: At the designated time (opening time), the group member terminal 3 displays a dialogue asking whether a call is ready to proceed (“call OK”) or not in order to automatically call the designated telephone number for the conference participation (As an actual process, the application program is brought into a suspended state when a Call method of a Phone class is invoked.).

S5.13: The user selects “call OK”.

S5.14: The group member terminal 3 calls the telephone number for the conference participation to establish a connection with the conference server 1 through a wireless telephone line. Then, the server 1 implements the TV conference service by causing the service control unit 21d to distribute service information including images and voices received from those terminals 2 and 3 to different terminals of the terminals 2 and 3.

3-6. Conference Participation Process (Arbitrarily Opening)

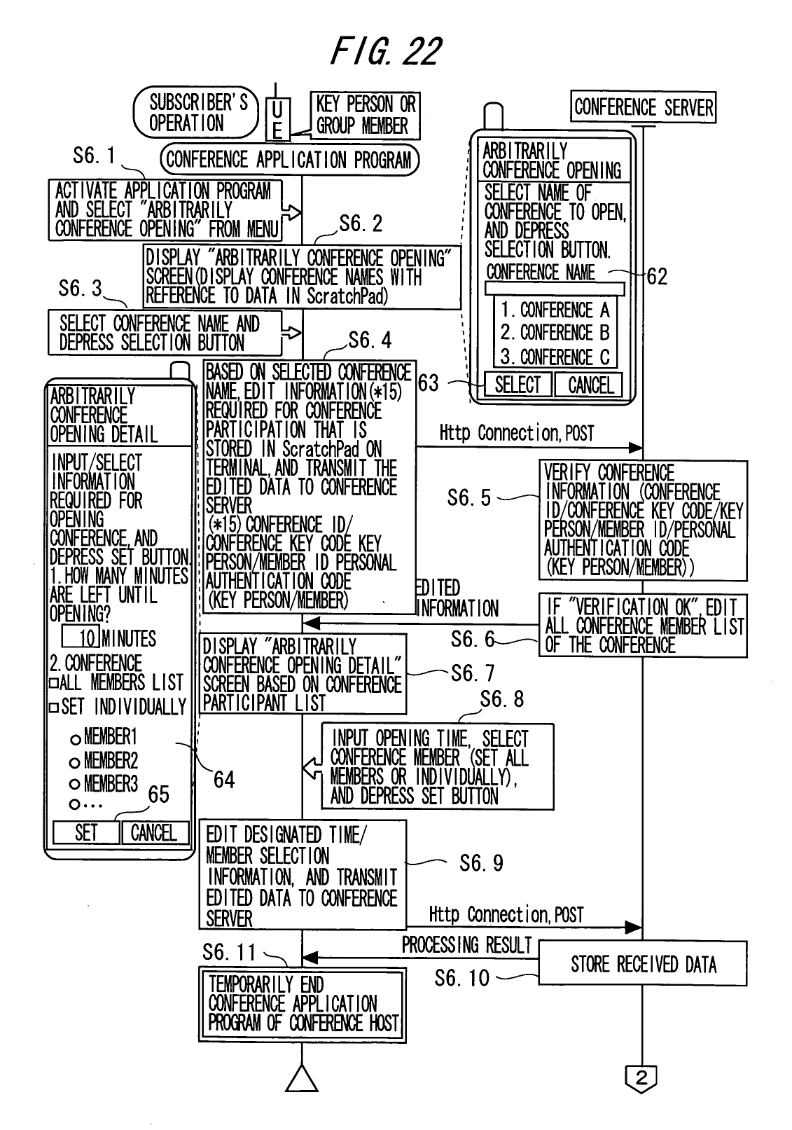

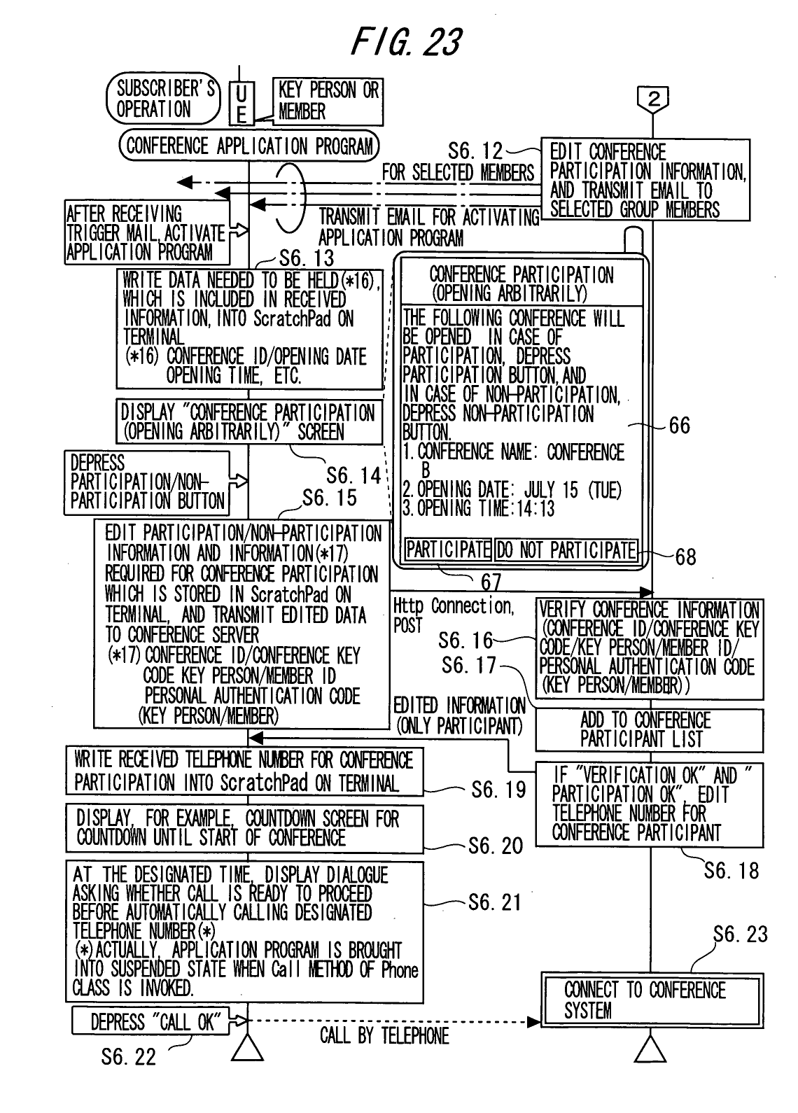

FIGS. 22 and 23 show a flow of a conference participation process (arbitrarily opening).

S6.1: A user to be a conference host (key person or group member with a permission of the key person) activates the application program and selects “Arbitrarily conference opening” from the menu. Note that hereinafter, description will be made of the steps for allowing a key person to use the terminal 2 to participate in the conference, but the steps for allowing a group member to use the terminal 3 to participate in the conference are the same. Thus, description of the latter steps will be omitted.

S6.2: If the “Arbitrarily conference opening” is selected from the menu, the key person terminal 2 displays an “Arbitrarily conference opening” screen 62 (where conference names are displayed with reference to the data on the ScratchPad).

S6.3: The key person selects a conference name and depresses (selects) a selection button 63.

S6.4: The key person terminal 2 reads information including the following items required for participation in a conference with the selected conference name out of the ScratchPad to edit the information, and transmits the resultant information to the conference server 1 as the member information.
Conference ID
Conference key code
Key person/member ID
Personal authentication code (key person/member)
Etc.

S6.5: In the conference server 1, the verification is performed on the member information (conference ID/conference key code/key person/member ID/personal authentication code (key person/member)).

S6.6: In the case of “verification OK”, the terminal 2 extracts the member information on members registered for the conference from the management information database to create a member list, and transmits the member list to the terminal 2.

S6.7: The key person terminal 2 displays an “Arbitrarily conference opening detail” screen 64 based on the received member list.

S6.8: The key person inputs the opening time and selects the conference members (all member designation or individual designation), followed by the selection of a set button 65.

S6.9: The key person terminal 2 edits the opening time and member selection information, and transmits the resultant information as opening request information to the conference server 1.

S6.10: The conference server 1 stores the received opening request information into the storage device 13.

S6.11: The conference application program on the terminal 2 of the conference host is temporarily ended.

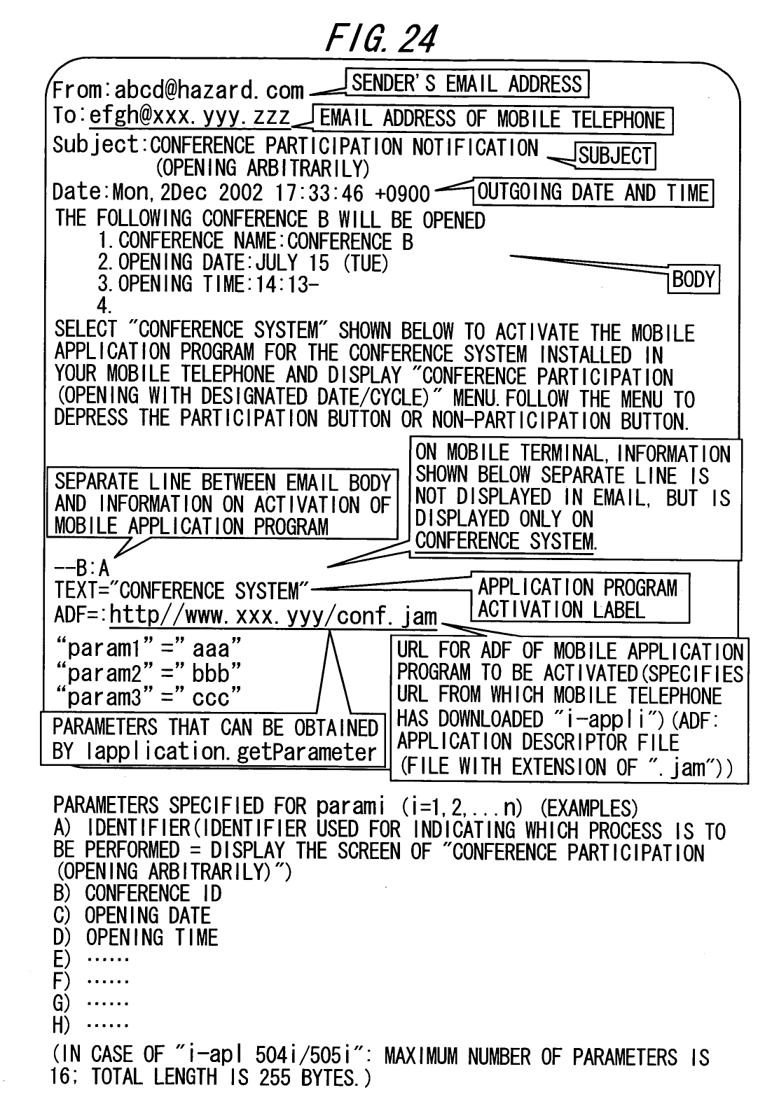

S6.12: The conference server 1 edits the conference participation information, and an email therefor is transmitted to the selected group member (see FIG. 24 for image for the image of the email).

S6.13: Upon receiving the email including the conference participation information to be a trigger, the group member terminal 3 displays a dialogue to urge the selection of whether or not to activate the application program. If the activation is selected, the application program is activated to start the conference participation process.

The group member terminal 3 also writes the following data needed to be held, which is included in the received conference participation information, into the ScratchPad.
Conference ID
Conference name
Opening date
Opening time
Etc.

S6.14: The group member terminal 3 displays a “Conference participation (arbitrarily opening)” screen 66.

S6.15: If the user selects a participation button 67 or a non-participation button 68, member information including information indicating the participation/non-participation and the following items, which is stored on the ScratchPad, required for the conference participation are edited, and the edited data is transmitted to the conference server 1.
ConferenceID
Conference key code
Key person/member ID
Personal authentication code (key person/member)
Etc.

S6.16˜S6.17: In the conference server 1, the verification is performed on the member information (conference ID/conference key code/key person/member ID/personal authentication code (key person/member)). If the result is “verification OK”, the member is added to the participation member list.

S6.18: The conference server 1 then checks the information indicating the participation/non-participation of the member information judged as “verification OK”, and transmits a telephone number for the conference participation to a member intending to participate.

S6.19: The group member terminal 3 that has received the telephone number for the conference participation writes the telephone number into the ScratchPad.

S6.20: The group member terminal 3 displays on the display, for example, the countdown screen for countdown until the start of the conference, and waits until the opening time (This step may simply be a standby state instead of displaying the countdown screen or the like in particular.).

S6.21: At the designated time (opening time), the group member terminal 3 displays the dialogue asking whether a call is ready to proceed (“call OK”) or not in order to automatically call the designated telephone number for the conference participation (As an actual process, the application program is brought into a suspended state when a Call method of a Phone class is invoked.).

S6.22: The user selects “call OK”.

S6.23: The group member terminal 3 calls the telephone number for the conference participation to establish a connection with the conference server 1 through a wireless telephone line. Then, the server 1 implements the TV conference service by causing the service control unit 21d to distribute service information including images and voices received from those terminals 2 and 3 to different terminals of the terminals 2 and 3.

3-7. Group Member List Display/Group Member Authorization Registration/Schedule Display/Schedule Registration/Modification/Member Deletion/Conference Withdrawal/Conference Dissolution

Similarly to the above-mentioned functions, the terminals 2 and 3 interact with the conference server 1 based on the data stored in the ScratchPad to perform each of the processes for group member list display, group member authorization registration, schedule display, schedule registration/modification, member deletion, conference withdrawal, and conference dissolution.

§4. Database Structure

Shown below is an outline of the database structure registered in the storage device of the conference server 1.

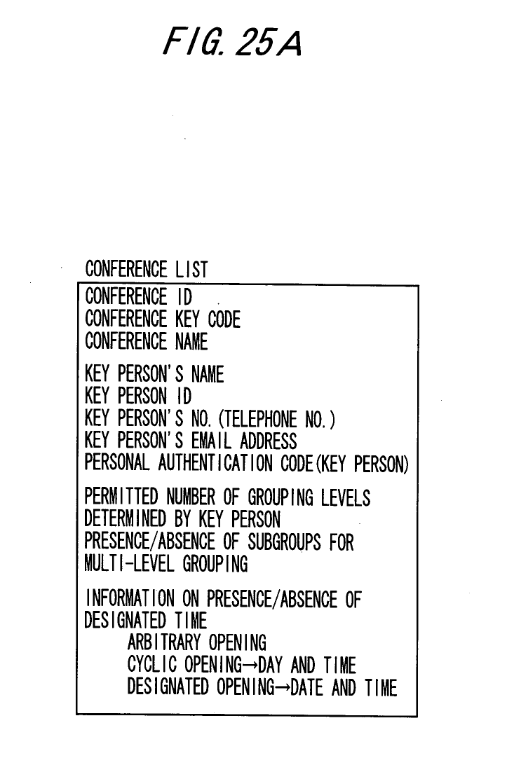

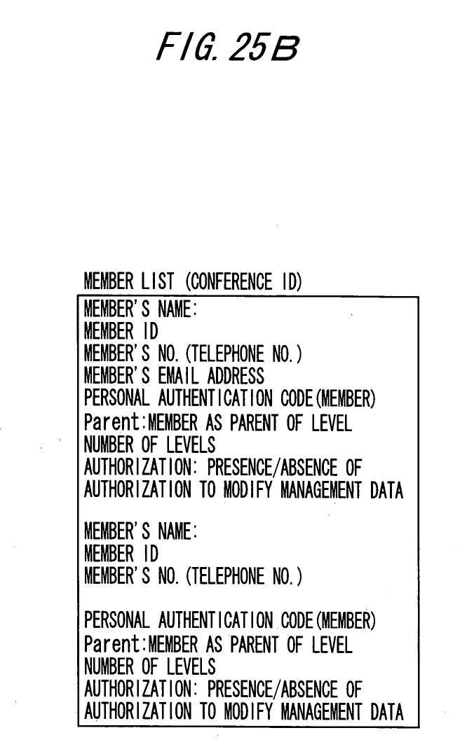

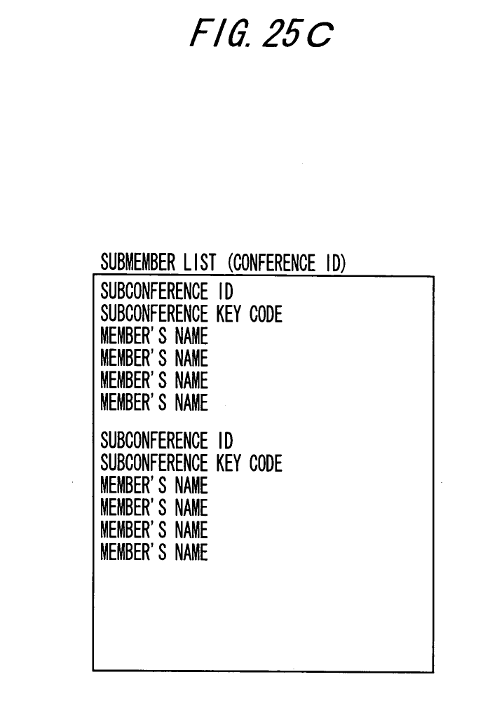

FIG. 25A is an example of the conference list. Stored in the conference list (service list) are basic information on a conference (basic information on a service) including a conference ID for identifying the conference (service ID for identifying the service), a conference key code, a conference name (service name), and the member information on a key person.

FIG. 25B is an example of the member list. In the member list, the member information on all group members is stored in association with the conference (service) with the conference ID being used as a key.

FIG. 25C is an example of a submember list. The submember list is a list for a member registered as the member of a subconference, and the member information is stored in the submember list in association with the conference with the conference ID being used as a key.

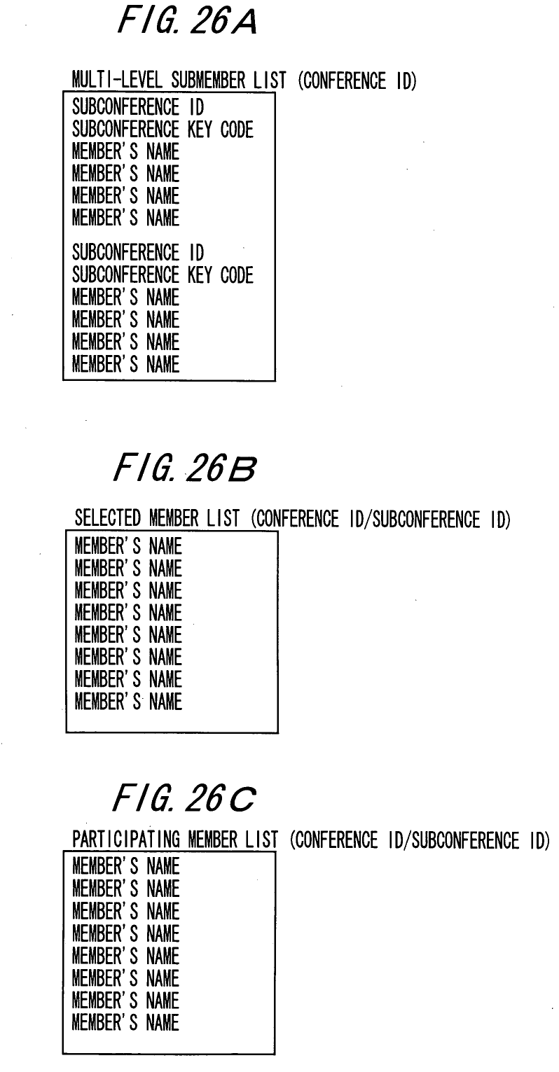

FIG. 26A is an example of a multi-level submember list. In the multi-level submember list, groups in a predetermined number of levels are set based on the number of levels, and the member information on members belonging to those groups among the members of a conference is stored. The member information is stored in association with the conference with the conference ID being used as a key.

FIG. 26B is an example of a selected member list. In the selected member list, the member information on a member selected in the conference participation process (arbitrarily opening) is stored in association with the conference or the subconference with the conference ID or the subconference ID being used as a key.

FIG. 26C is an example of a participating member list. In the participating member list, the member information on a member participating in a conference when the conference opens is stored in association with the conference or the subconference with the conference ID or the subconference ID being used as a key.

§5. Effects of this Embodiment

According to this embodiment, the following effects are produced.

The group members can be organized easily and flexibly as circumstances demand, so that the widespread use can be realized from general use for a conference in which a large number of people participate to personal use for a meeting in which a small number of people participate.

The information including a personal ID, a personal authentication code, and a conference ID is not left in a document of paper or an email text, thereby preventing such a situation of loss or fraudulent use thereof.

Each group member does not need to bother to memorize the information including a personal ID, a personal authentication code, and a conference ID.

Each time a user registers/updates a conference opening date and time (scheduling data), selects a group member, participates in a TV conference, or the like, it is not necessary to bother to perform manual input of the information including a personal ID, a personal authentication code, and a conference ID.

For each conference, it is not necessary for the host of the conference to perform operations such as notifying all the group members of the information including a key code required for the conference participation.

An access right to the conference server 1 is fixed to each terminal, thereby realizing robust security.

It is not necessary to manage various information performed by a system administrator.

It is possible to organize a complicated group member structure such as organizing a group member structure considered in a hierarchical manner or restructuring the already-structured group members into subgroups.

### Embodiment 2

Next, Embodiment 2 of the present invention will be described. This embodiment has the same configuration as that of Embodiment 1 except that the procedure of implementing a TV conference service (member management) is different. Thus, redundant description will be omitted by adding the same symbols to the same structural components or by like means.

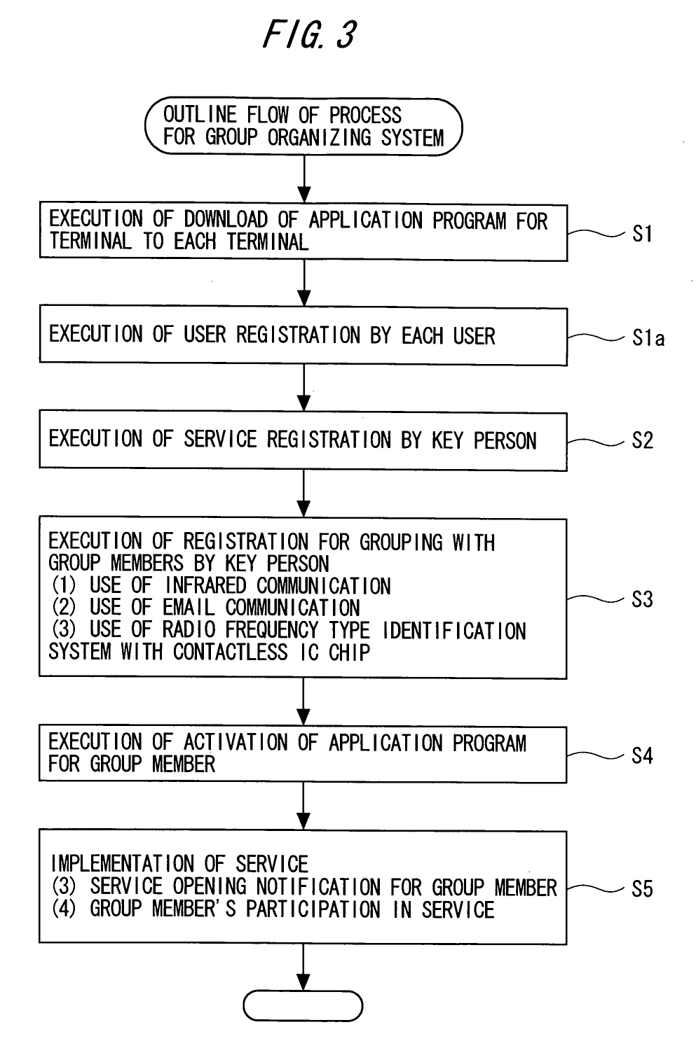

FIG. 3 shows an outline flow of a process for the system according to this embodiment.

S1 (abbreviated as “S1” in the figure): An application program for a terminal is downloaded to each of the terminals 2 and 3.

S1a: Each of the terminals 2 and 3 performs user registration.

S2:A key person terminal 2 executes the downloaded application program and makes a request for a service such as a TV conference to the server 1. Personal information of a corresponding key person and service implementation information for a conference or the like are inputted as registration information when the request is made.

S3: The key person terminal 2 transmits the member application information to a group member terminal to designate a group member by using an infrared communication function, a wireless communication system (for example, a specific low-power wireless communication system, specifically, through the Bluetooth (registered trademark) or a wireless LAN), or an email communication function.

S4: Each group member terminal 3 that has received the member application information executes the application program to register for the conference.

S5: Upon receiving a service opening notification (conference starting notification), the group members including the key person each transmit member information from the terminal 2 or 3 to the server 1 and participate in the service such as a TV conference.

First, similarly to Embodiment 1, when the key person inputs the execution of a conference application program to the terminal 2, the terminal 2 displays a main menu with the following items on the display.
Functions to be activated when a user first activates the application program
   User registration
Functions to be activated upon menu selection by the user
   Conference registration
   Group member registration by infrared communication
   Group member registration by email communication
   Subconference member registration
   Arbitrarily conference opening
   Group member list display
   Group member authorization registration
   Schedule display
   Schedule registration/modification
   Member deletion
   Conference withdrawal
   Conference dissolution

Also, in the case where the analysis unit 21c or the application information receiving unit 31a discriminates that a conference starting notification or member application information is received, the key person terminal 2 or the group member terminal 3 starts the following processes.
Functions to be activated by infrared communication or by email
   Conference participation (opening with designated date/cycle)
   Conference participation (opening arbitrarily)

Hereinbelow, description will be made of process flows of four functions of the main menu, that is, “User registration”, “Conference registration”, “Group member registration by infrared communication”, and “Group member registration by email communication”. The functions other than those four items are the same as those of Embodiment 1.

1-1. User Registration

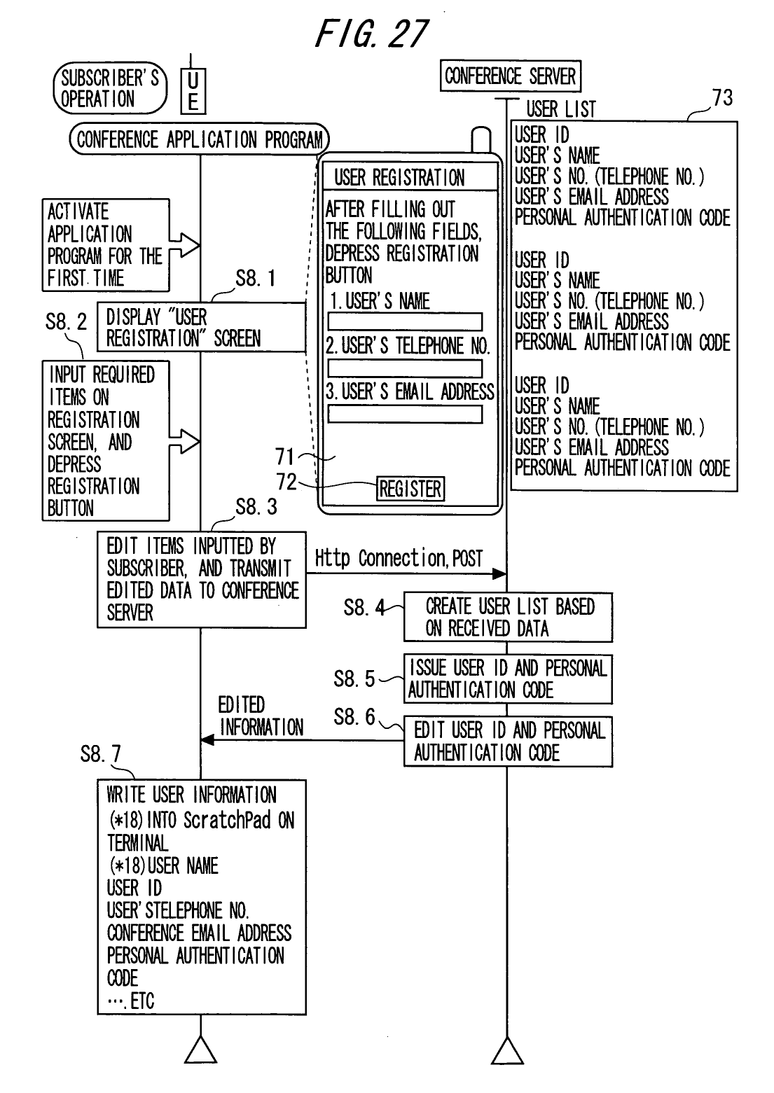

FIG. 27 shows a flow of the user registration process.

S8.1: When the application program is first activated after the download thereof, the terminals 2 and 3 each display a “User registration” screen 71.

S8.2: The user fills respective input fields displayed on the screen 71 with information on the following items.
User name
User's telephone number
User's email address

S8.3: When the user selects the registration button 72 after inputting information, the terminals 2 and 3 each transmit the inputted information to the conference server 1 via POST in the HTTP protocol. For example, the terminals 2 and 3 each edit those inputted information as parameters for the data management program (program in the form of a servlet) stored on the conference server 1, then call the program via POST in the HTTP protocol, and transmit the information (parameters) to the program.

S8.4˜S8.6: The conference server 1 creates a record for the user in a user list 73 based on the received information, and registers the information of the input items therein. Also, the conference server 1 issues a user ID and a personal authentication code, which are added to the record of the user, and edits the information including the member ID and the personal authentication code as a part of the member information required for a member's access to the conference system to transmit the member information to each of the terminal 2 and 3.

S8.7: The terminals 2 and 3 that have received the information each writes the information into the ScratchPad. The data to be written into the ScratchPad includes the following.
Member's name
Member ID
Member's telephone number
Member's email address
Personal authentication code

Note that as another possible process, character data such as the member's name among those items may be stored not in the memory on a terminal but only on the server 1 in the case where there are limitations on a memory size on a terminal or a data size for data transmission, so that each time a name needs to be displayed in the application program, the name is inquired by the server 1. In this embodiment, the limitations of a memory size on a terminal and the limitations of a data size for data transmission are not particularly taken into consideration, and the description is made as that the character data is also stored in the memory on the terminal, and the character data is also transmitted upon the data transmission. Also, since information on the telephone number or the email address has already been registered in the terminal, the writing operation into the memory is not essential (the same applies to flows of subsequent embodiments).

1-2. Conference Registration

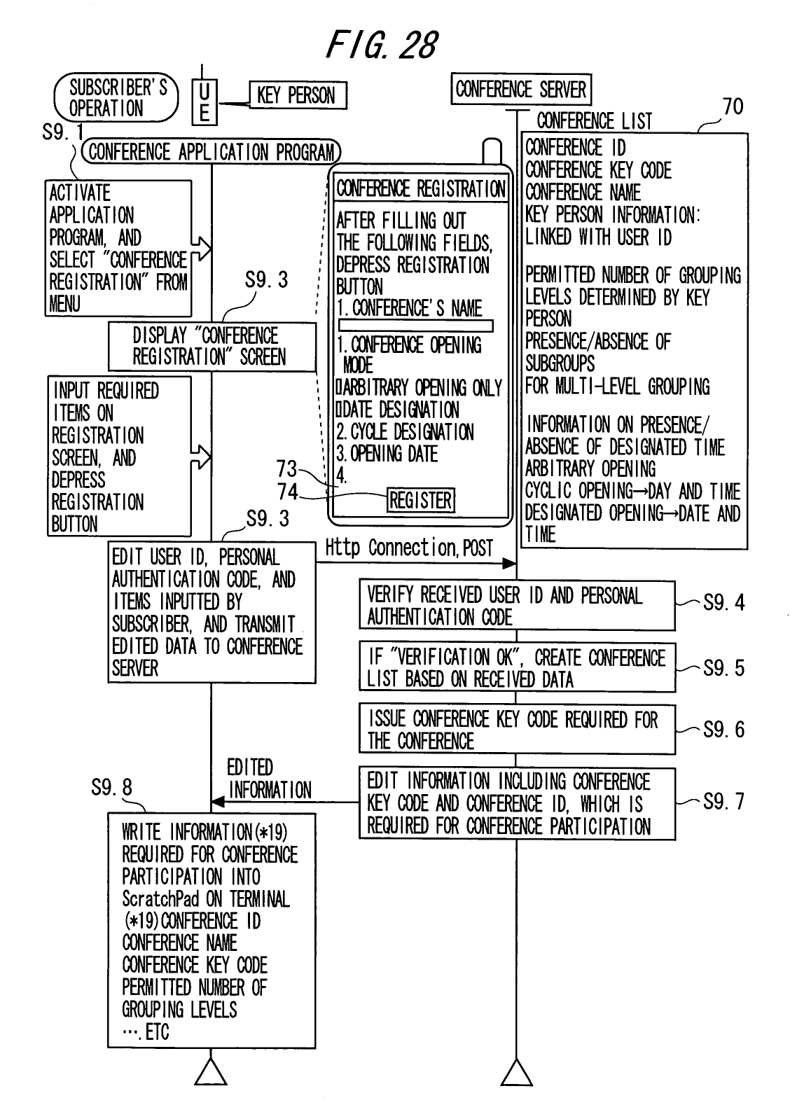

FIG. 28 shows a flow of the conference registration process.

S9.1: The user to be a key person activates the application program and selects “Conference registration” from the menu.

S9.2: Upon the selection of “Conference registration” from the menu, the key person terminal 2 displays a “Conference registration” screen 73 to urge the key person to input the following information.
Conference name
Conference opening mode (arbitrarily opening only, date designation (designation of an opening date), cycle designation (designation of an opening day and time), or the like).
Opening date and time for the date designation/opening day and time for the cycle designation
Permitted number of grouping levels determined by a key person
Presence/absence of subgroups for multi-level grouping

S9.3: After filling respective input fields displayed on the screen 73 with the above information, the key person selects a registration button 74. Then, the key person terminal 2 transmits the inputted information to the conference server 1 via POST in the HTTP protocol (edits the inputted information as parameters for the data management program (program in the form of a servlet) stored on the conference server, then calls the program via POST in the HTTP protocol, and passes the information to the program).

S9.4: The conference server 1 verifies the received user ID and personal authentication code. In the case of “verification OK”, the conference server 1 creates the conference list based on the received information, issues a conference key code for the conference, and edits member information including the conference key code and the conference ID as the information required for the user to participate in the conference to transmit the member information to the terminal 2.

S9.5: The application program that has received the member information writes the member information into the ScratchPad on a terminal as the information required for the conference participation. The data to be written into the ScratchPad includes the following.
Conference ID
Conference name
Conference key code
Permitted number of grouping levels
Etc.

1-3. Group member registration process (in a face-to-face manner by infrared communication)

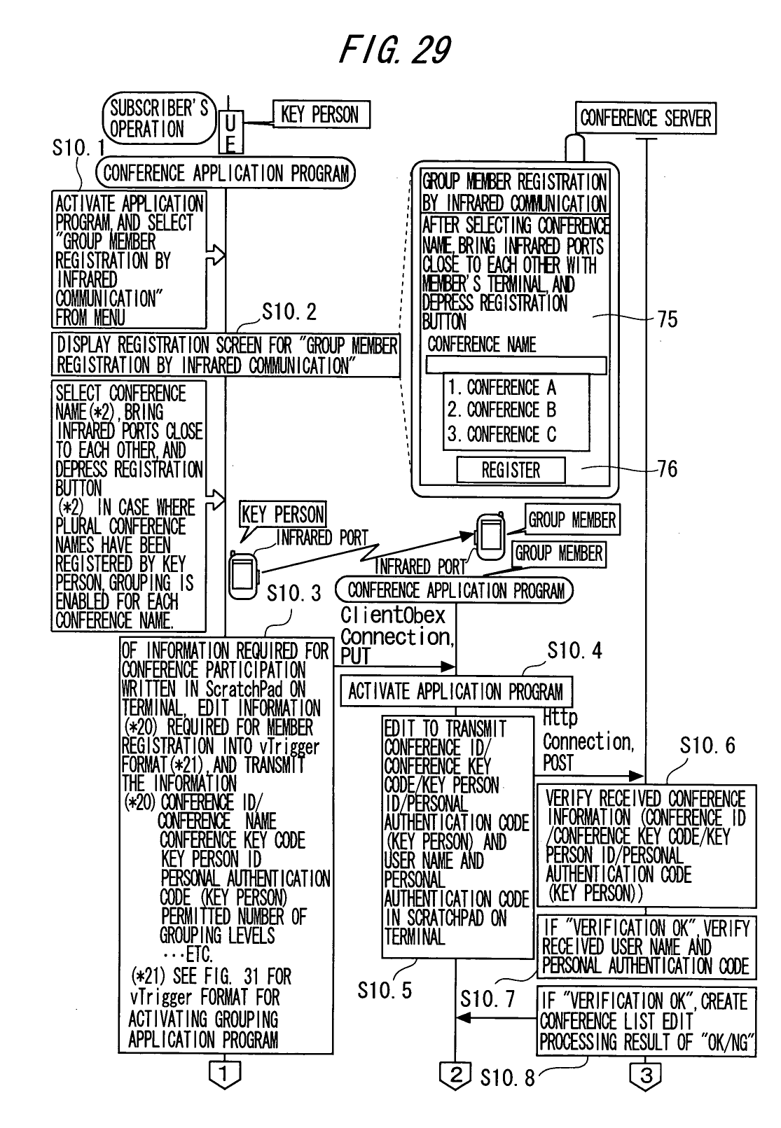

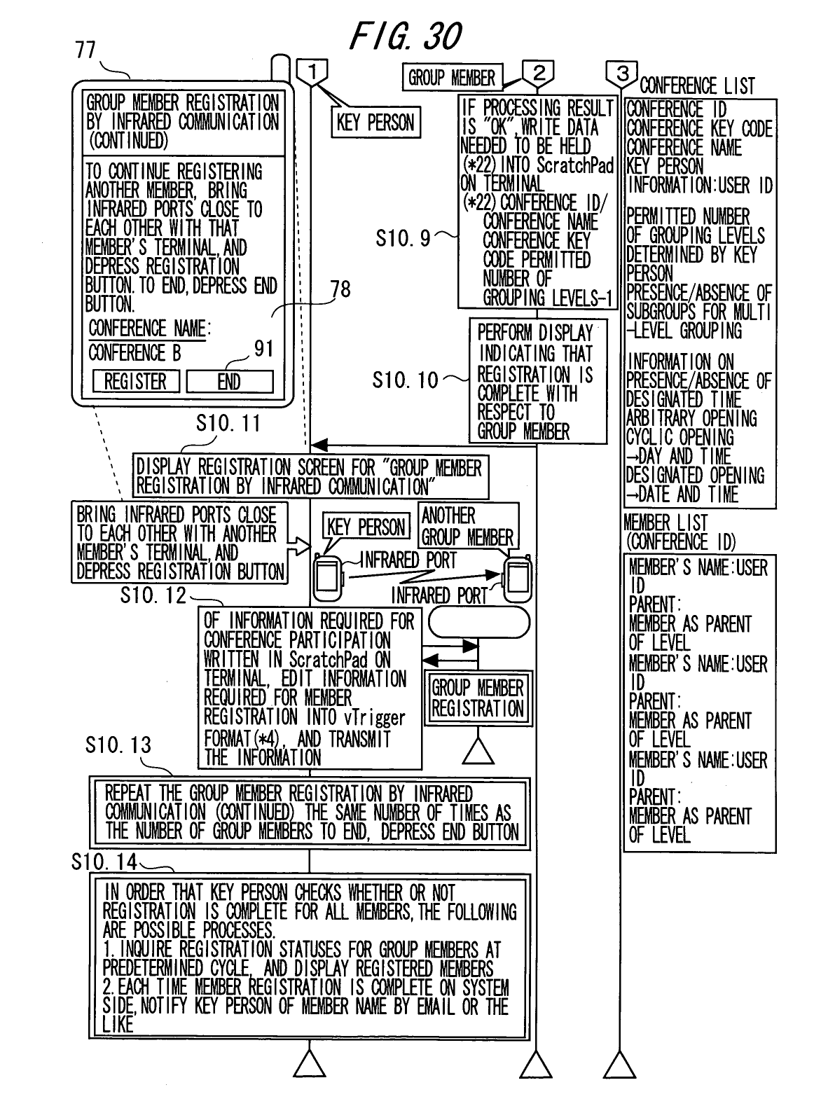

FIGS. 29 and 30 show a flow of the group member registration process (in a face-to-face manner by infrared communication) performed by a key person.

S10.1: The key person activates the application program and selects “Group member registration by infrared communication” from the menu.

S10.2: The terminal 2 displays the registration screen of “Group member registration by infrared communication” including the list of conference names to urge the key person to select a desired conference name for the registration process (in the case where the plural conference names have been registered by the key person, the grouping is enabled for each of the conference names).

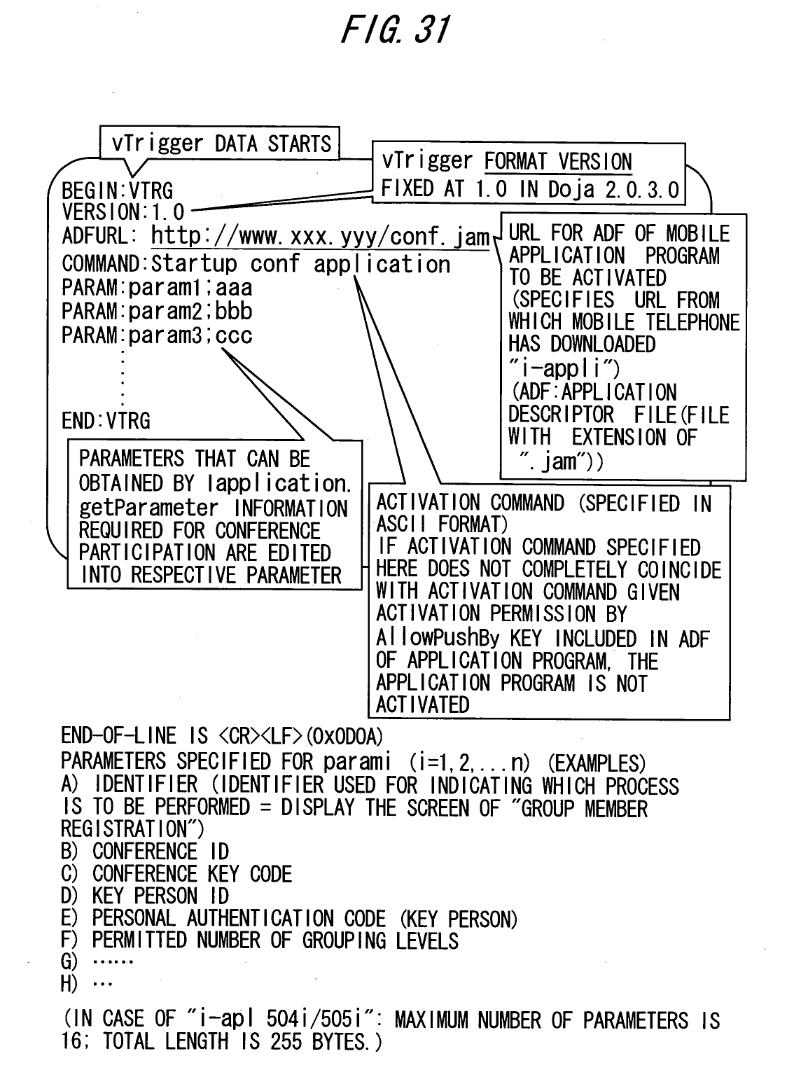

S10.3: After selecting the conference name, the key person brings infrared ports close to each other between his/her own terminal 2 and a terminal 3 of a candidate group member for the grouping and selects a registration button 76. Then, the terminal 2 edits the following member application information required for member registration, which is included in the member information required for the conference participation written in the ScratchPad, into parameters in a vTrigger format (see FIG. 31), and then transmits the member application information to the terminal 3 via PUT in the OBEX protocol.
Conference ID
Conference name
Conference key code
Key person's name
Key person ID
Personal authentication code (key person)
Permitted number of grouping levels
Etc.

Note that as another parameter in the vTrigger format, an identifier indicating which process is to be performed on the terminal that receives the information is added to the above-mentioned items. Here, “identifier=execute the ‘Group member registration’ process” is specified.

S10.4 On the other hand, the group member terminal 3 that has received the data receives a signal to be a trigger to display a dialogue to urge the selection of whether or not to activate the application program. If the activation is selected, the group member terminal 3 activates the application program.

The group member terminal 3 that has received the member application information (conference information) starts the process of the following group member registration based on the identifier.

S10.5: In order to perform the group member registration, the terminal 3 transmits a request for verification of the received conference ID/conference key code/key person ID/personal authentication code (key person) and the user name and personal authentication code in the ScratchPad on the terminal, to the conference server 1 via POST in the HTTP protocol.

S10.6: The conference server 1 verifies the conference information (conference ID/conference key code/key person ID/personal authentication code (key person)) included in the received member application information against the information stored in the management information database.

S10.7: If the result from the verification of the conference information is “verification OK”, the conference server 1 further verifies personal information (user name and authentication code) included in the received member application information against the information stored in the management information database. If the personal information is not stored in the management information database, registration (for addition to the member list) is performed as the member of the conference.

S10.8: After the verification, a conference list 70 is created based on the member application information, and the member information that allows the member to participate in the conference is transmitted to the terminal 3 as the process results.

S10.9: Upon receiving the process results, the group member terminal 3 writes member information including the following items into the ScratchPad on the terminal.
Conference ID
Conference name
Conference key code
Permitted number of grouping levels-1

S10.10: The group member terminal 3 performs display indicating that the registration is complete.

S10.11: After the member registration has been performed on the first group member, the application program on the key person terminal 2 causes the display of a “Group member registration by infrared communication (continued)” screen.

S10.12: When the key person brings infrared ports close to each other with a user terminal of a second candidate group member for the grouping and selects a registration button 78, the above-mentioned steps are repeated similarly on the terminal 2.

S10.13: After the key person repeated the process of “Group member registration by infrared communication (continued)” the same number of times as the number of group members, an end button 91 is selected to end the procedure.

S10.14: In order that the key person checks whether or not the registration is complete for all the members, the following process is performed on the terminal 2.

(1) Registration statuses for the group members are inquired of the server 1 at a predetermined cycle, and registered members are displayed.

(2) Each time the member registration is complete on the system side, the key person is notified of the member name by email or the like.

Note that in the above group member registration process, the steps performed by the key person and its terminal 2 may be performed by a group member who has received member information from the key person and the terminal 3 of the group member. Accordingly, in addition to the member who is directly designated by the key person, the designated member can also designate another member. At this time, it is desirable that the designation be permitted within the permitted levels set by the key person. In that case, for example, in the server 1, the database analysis unit 16d judges whether or not the permitted number of levels in the member application information received in step 10.6 is equal to or more than a predetermined value. If the number is equal to or more than the predetermined value, the database creating unit 16c creates member information by performing subtraction on the permitted number of levels, and transmits the member information to the group member terminal 3 in step 10.8.

In the case where the group member terminal 3 that has received the member information performs the group member registration process in place of the key person terminal 2, in step 10.3, the member application information is created so as to include the permitted number of levels in the member information, and transmitted to another group member terminal.

If this group member terminal 3 is at a level exceeding the permitted number of levels set by the key person, the permitted number of levels of the member application information is judged as below the predetermined value, making it impossible to perform member registration.

Note that the judgment as to whether or not the number of levels is within the permitted range may be performed by the terminal 3. For example, when the conference name is selected in steps 10.2 and 10.3, the terminal 3 references the permitted number of levels of the member information. If the number is equal to or more than a predetermined value (for example, 1 or more), the registration process is continued. If the number is lower than the predetermined value, the terminal 3 displays an indication of exceeding the permitted range of the key person and discontinues the process. Alternatively, upon displaying a registration screen 76, the terminal 3 may reference the permitted number of levels and performs setting such that the conference name of a conference at a level below a predetermined number is not displayed to prohibit the registration process for such a conference.

1-4. Group Member Registration Process (in a Non-face-to-face Manner by email Communication)

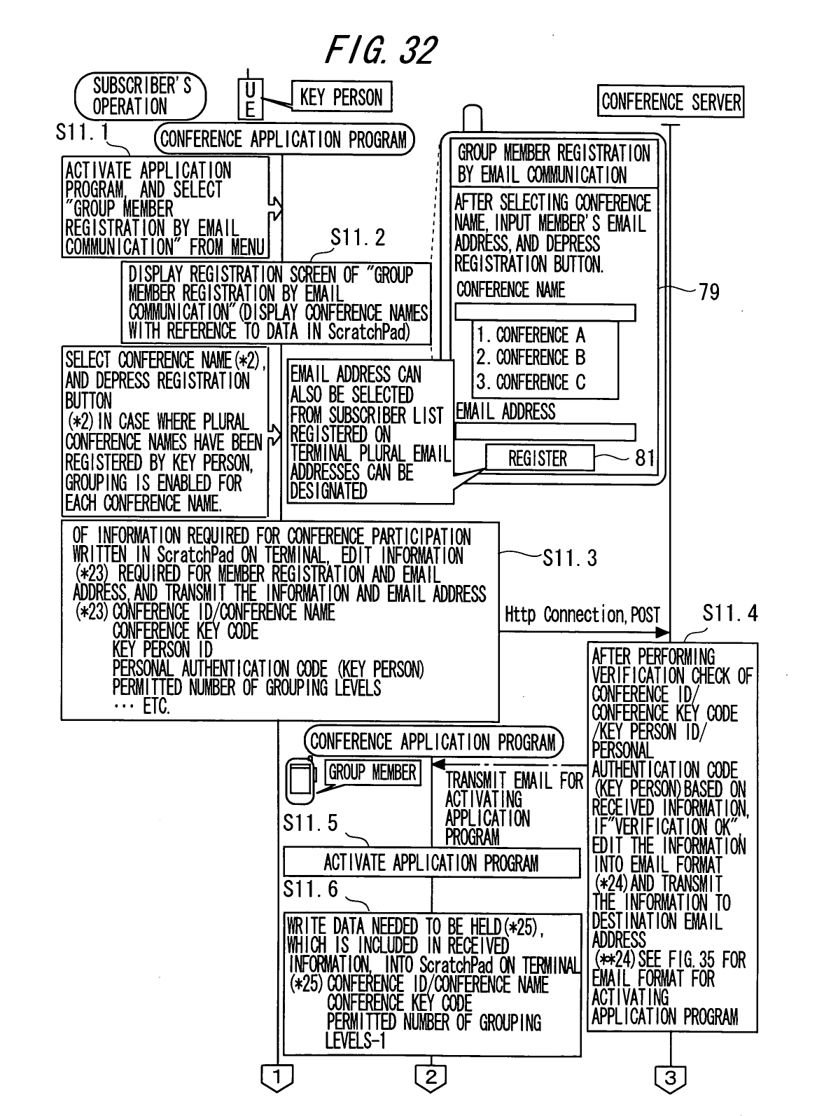

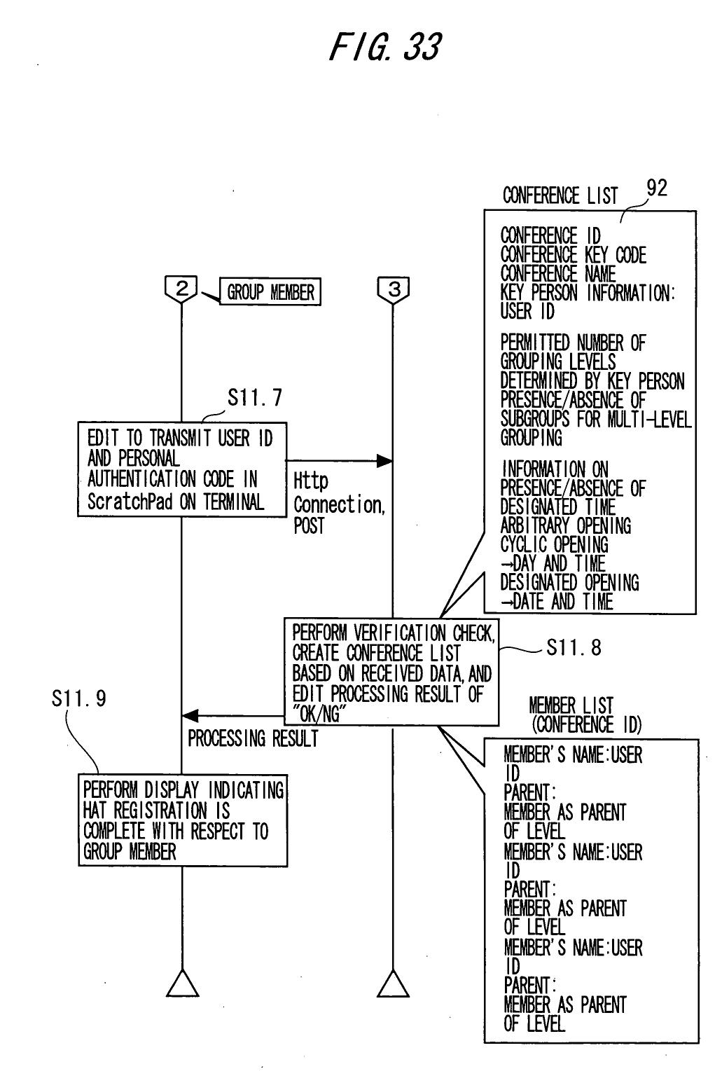

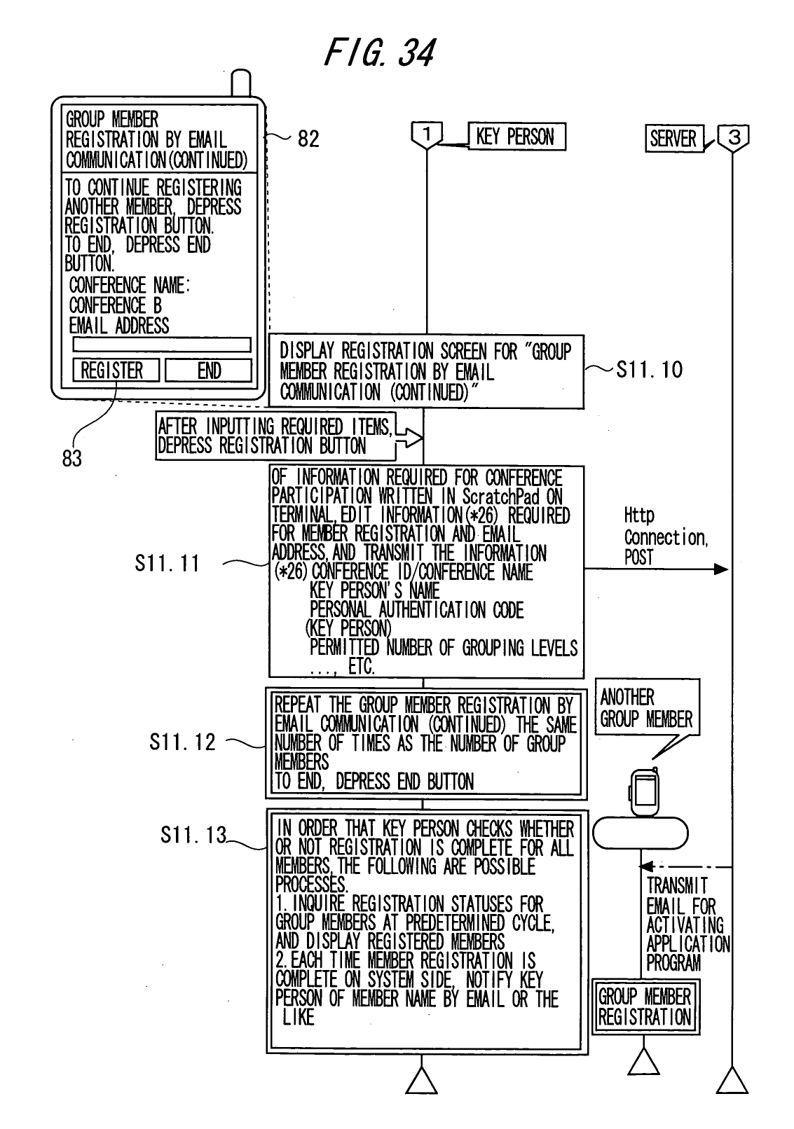

FIGS. 32 to 34 show a flow of the group member registration process performed by a key person (in a non-face-to-face manner by email communication).

S11.1: The key person activates the application program and selects “Group member registration by email communication” from the menu.

S11.2: The terminal 2 displays a registration screen 79 of “Group member registration by email communication”. The user selects the name of a desired conference from the list of the conference names displayed on the screen and inputs the email address of a user to be a group member. In the case where the plural conference names have been registered by the key person, the grouping is enabled for each of the conference names.

The email address can also be selected from a subscriber list registered on the terminal, and plural addresses can be specified as well.

S11.3: When the key person selects the a registration button 81 after the input of the information, the terminal 2 transmits the inputted email address and the following information required for the member registration, which is included in the information required for conference participation written in the ScratchPad on the terminal, as the member application information (conference information) to the conference server 1 via POST in the HTTP protocol.
Conference ID
Conference name
Conference key code
Key person ID
Personal authentication code (key person)
Permitted number of grouping levels
Etc.

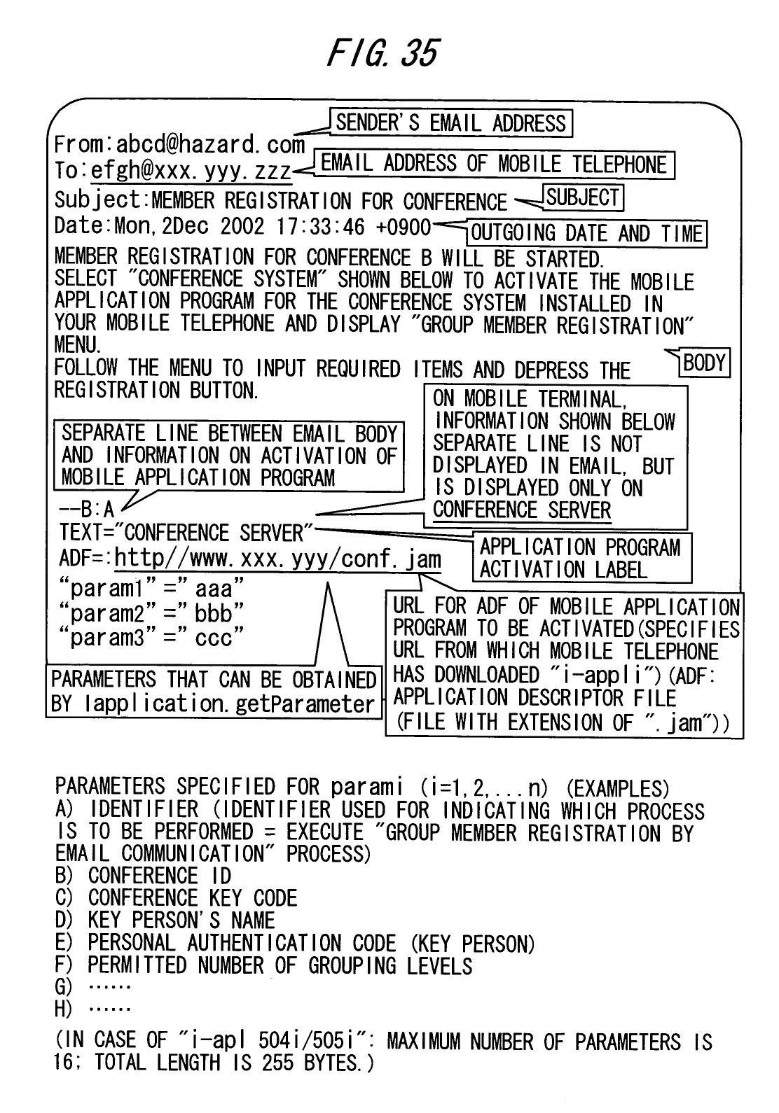

S11.4: The conference server 1 verifies the received conference ID/conference key code/key person ID/personal authentication code (key person) on the member application information against the information stored in the management information database. In the case of “verification OK”, the conference server 1 creates an email (see FIG. 35) for activation of the application program for the group member registration, and transmits the email to a destination email address. The email contains the following information (member application information) as parameters.
Conference ID
Conference name
Conference key code
Key person ID
Personal authentication code (key person)
Permitted number of grouping levels
Etc.

Note that as another parameter to be contained in the email, an identifier indicating which process is to be performed on the terminal that receives the information is added to the above-mentioned information. Here, “identifier=execute the ‘Group member registration’ process” is specified.

S11.5: The group member terminal 3 that has received the data receives a trigger and then displays a dialogue to urge the selection of whether or not to activate the application program. If the user activates the application program, the terminal 3 starts the process of the group member registration based on the identifier.

S11.6: The terminal 3 writes the following data included in the received member application information into the ScratchPad.
Conference ID
Conference name
Conference key code
Permitted number of grouping levels-i

S11.7: The terminal 3 edits the personal information including the user ID and personal authentication code written in the ScratchPad into the member application information, and transmits the member application information to the conference server 1 via POST in the HTTP protocol.
User ID
Personal authentication code
Etc.

S11.8: In the conference server 1, verification is performed on the member application information (personal information) transmitted from the terminal 3 against the user information registered in the management information database. If the coincidence of the information is verified, a conference list 92 is created based on the personal information and the conference information received in step 11.4, and “registration OK” is transmitted to the terminal 3 as the process result.

S11.9: The group member terminal 3 performs display indicating that the registration is complete.

S11.10: After the member registration has been performed on the first group member, the key person terminal 2 displays a “Group member registration by email communication (continued)” screen.

S11.11: When the key person specifies the email address of a user terminal of a second candidate group member to continue the registration process, the processes in the above steps of S3.3 to S3.5.8 are performed similarly.

S11.12: After the terminal 2 repeated “Group member registration by email communication (continued)” the same number of times as the number of group members, the key person selects “end”.

S11.13: In order that the key person checks whether or not the registration is complete for all the members, the terminal 2 performs the following process.

(1) Registration statuses for the group members are inquired of the system at a predetermined cycle, and registered members are displayed.

(2) Each time the member registration is complete on the system side, the key person is notified of the member name by email or the like.

Note that in the above group member registration process, the steps performed by the key person and its terminal 2 may be performed by a group member who has received member information from the key person and the terminal 3 of the group member. Accordingly, in addition to the member who is directly designated by the key person, the designated member can also designate another member. At this time, it is desirable that the designation be permitted within the permitted levels set by the key person. In that case, for example, in the server 1, the database analysis unit 16d judges whether or not the permitted number of levels in the member application information received in step 11.4 is equal to or more than a predetermined value. If the number is equal to or more than the predetermined value, the database creating unit 16c creates member information by performing subtraction on the permitted number of levels, and transmits the member information to the group member terminal 3.

In the case where the group member terminal 3 that has received the member information performs the group member registration process in place of the key person terminal 2, in step 11.3, the member application information is created so as to include the permitted number of levels in the member information, and transmitted to another group member terminal 3.

If this group member terminal 3 is at a level exceeding the permitted number of levels set by the key person, the permitted number of levels of the member application information is judged as below the predetermined value, making it impossible to perform member registration.

Note that the judgment as to whether or not the number of levels is within the permitted range may be performed by the terminal 3. For example, when the conference name is selected in step 11.2, the terminal 3 references the permitted number of levels of the member information. If the number is equal to or more than a predetermined value (for example, 1 or more), the registration process is continued. If the number is lower than the predetermined value, the terminal 3 displays an indication of exceeding the permitted range of the key person and discontinues the process. Alternatively, upon displaying the registration screen 79, the terminal 3 may reference the permitted number of levels and performs setting such that the conference name of a conference at a level below a predetermined number is not displayed to prohibit the registration process for such a conference.

1-5. Database Structure

Shown below is an outline of the database structure registered on the conference server.

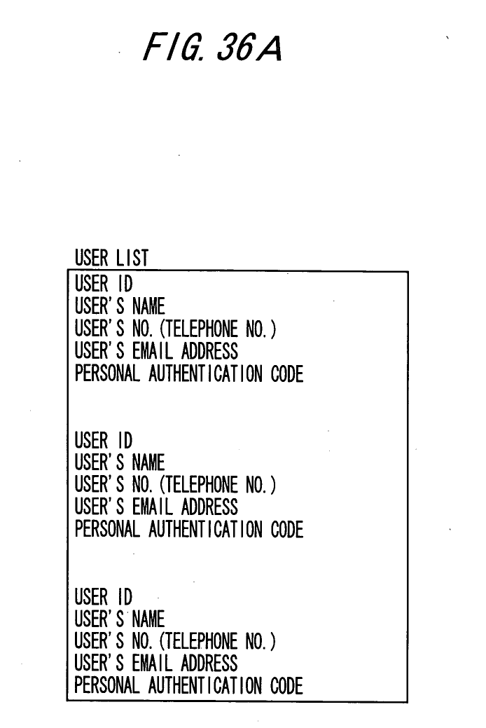

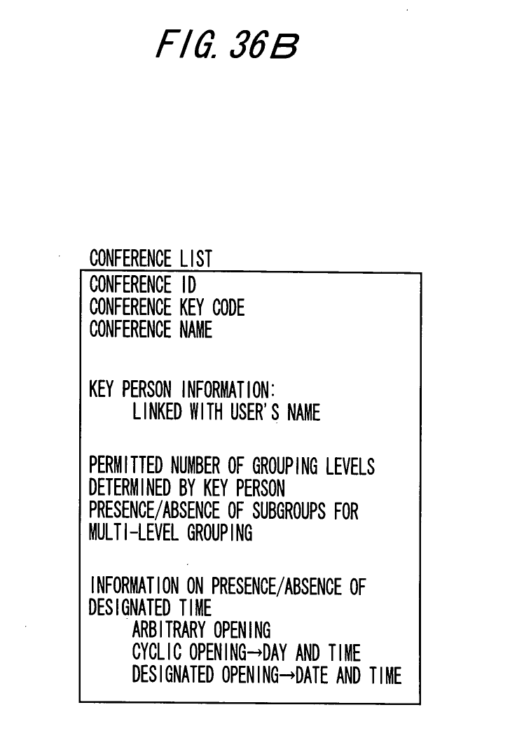

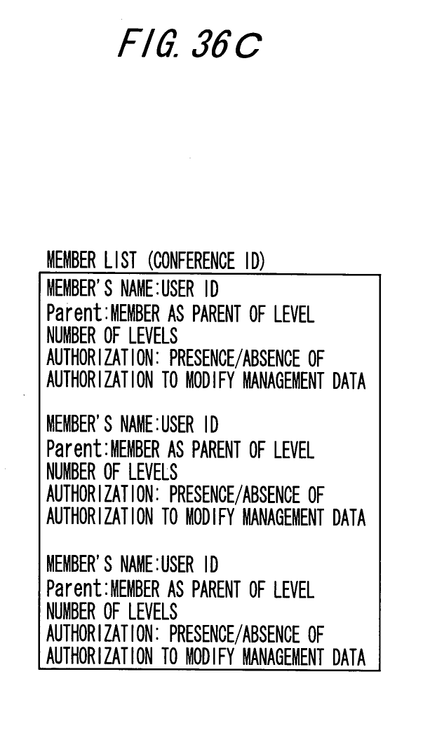

FIG. 36A shows a user list, in which information on all the users who have completed the user registration is registered in a list form.

FIG. 36B shows a conference list, in which basic information on a conference and key person information are registered.

FIG. 36C is an example of the member list. In the member list, the member information on all group members is stored in association with the conference (service) with the conference ID being used as a key.

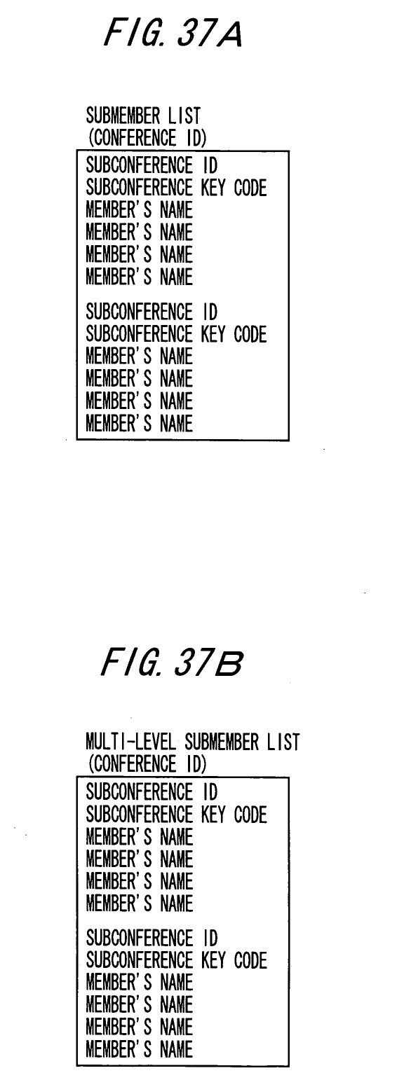

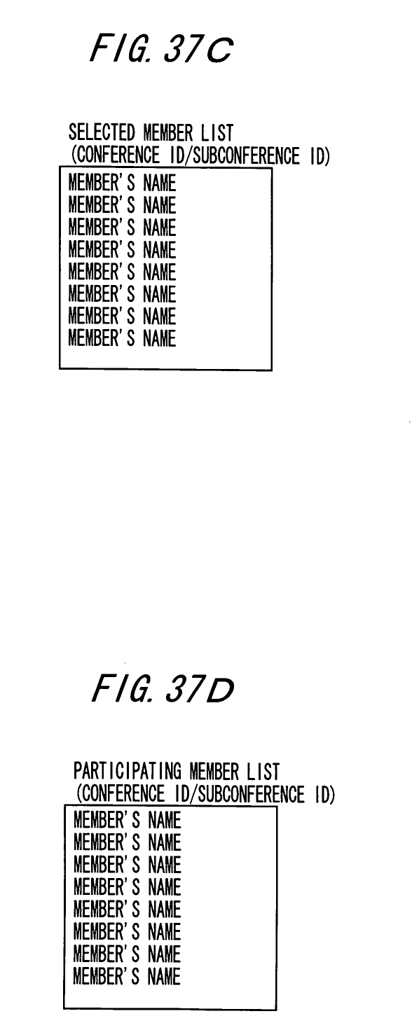

FIG. 37A is an example of a submember list. The submember list is a list for a member registered as the member of a subconference, and the member information is stored in the submember list in association with the conference with the conference ID being used as a key.

FIG. 37B is an example of a multi-level submember list. In the multi-level submember list, groups in a predetermined number of levels are set based on the number of levels, and the member information on members belonging to those groups among the members of a conference is stored. The member information is stored in association with the conference with the conference ID being used as a key.

FIG. 37C is an example of a selected member list. In the selected member list, the member information on a member selected in the conference participation process (arbitrarily opening) is stored in association with the conference or the subconference with the conference ID or the subconference ID being used as a key.

FIG. 37D is an example of a participating member list. In the participating member list, the member information on a member participating in a conference when the conference opens is stored in association with the conference or the subconference with the conference ID or the subconference ID being used as a key.

### Embodiment 3

Next, Embodiment 3 of the present invention will be described. This embodiment has the same configuration as that of Embodiment 1 except that the procedure of implementing a TV conference service (member management) is different in that a simple grouping method is used in the case of temporarily opening a conference. Thus, redundant description will be omitted by adding the same symbols to the same structural components.

Note that the points different from the Embodiment 1

are as follows:

1. The user registration is unnecessary except for the key person.

2. The user IDs/personal authentication codes for the number of desired group members are collectively issued to the key person.

3. The key person distributes information required for conference participation to each group member by infrared communication or by email communication (Distributed to each group member are a user ID/personal authentication code different from another and information required for conference participation including a conference ID/conference key code/telephone number for conference participation.).

4. The group member who has received the data starts the conference participation process, and after receiving “authentication OK” from the conference server, establishes a connection to the conference system.

Also in this embodiment, similarly to Embodiments 1 and 2, the application program for a conference is first downloaded to the user's mobile terminal. By execution of such a conference application program, the terminals 2 and 3 realizes the following functions.
Functions to be activated upon menu selection by the user
User registration (performed only once)
Instant conference registration (performed by a key person (conference host) who has completed the user registration)
Instant conference notification(*1)
Function to be activated by email
Instant conference participation

Note that a conference notification function by infrared communication may possibly be used as the instant conference notification function, but in instant conference, the notification function by email is more practical than the conference notification function by infrared communication (a TV conference is hardly practical over distances in the infrared range). Therefore, this embodiment is described by use of a conference notification function by email. However, in the case where the conference is held with members at remote locations as well as members within distances that can be reached by infrared rays (short range), the members at remote locations may be notified by email and the members within short ranges may be notified by infrared communication.

1-1. User Registration

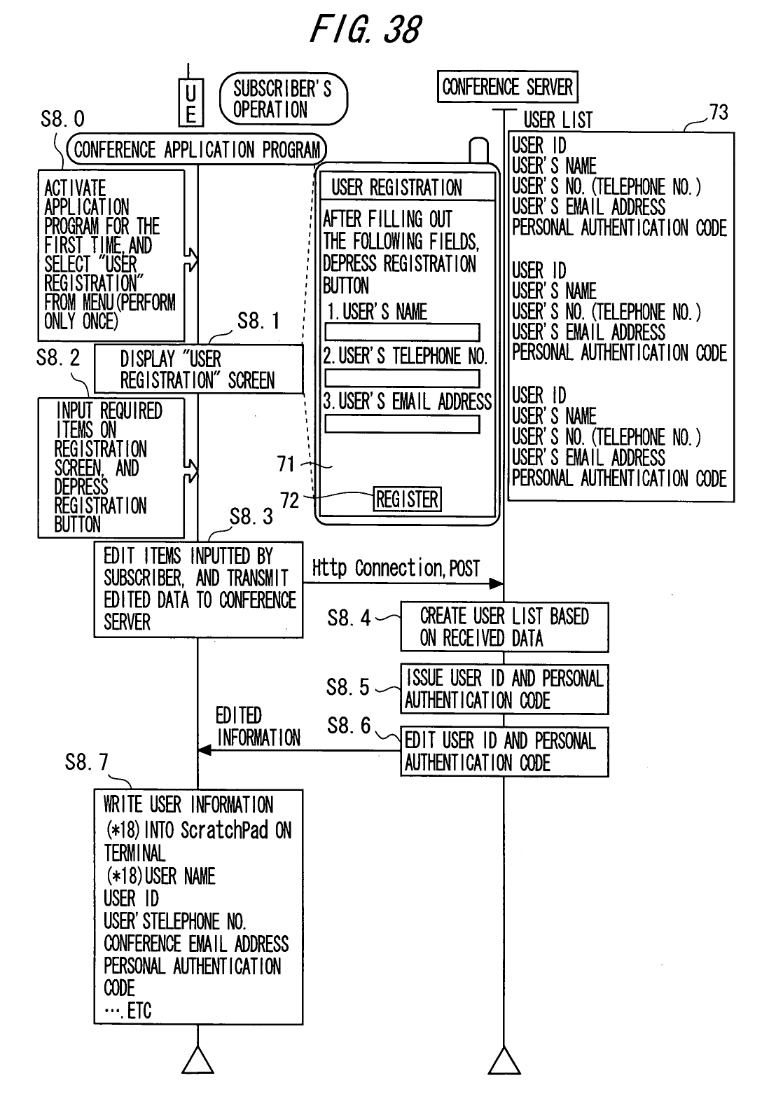

FIG. 38 shows a flow of the user registration process. This process is substantially the same as the user registration process of Embodiment 2 (FIG. 27) except that the selection of whether or not to perform the user registration is possible at the first activation of the application program.

In the flow of Embodiment 2 shown in FIG. 27, the user registration is always performed at the first activation of the application program. Meanwhile, in the flow of Embodiment 3 shown in FIG. 38, the user registration is arbitrarily performed by displaying a menu to urge the selection from the menu at the activation of the application program. In this embodiment, only the key person registers information to a server, so that a group member does not always need to perform the user registration, but once the user registration is performed, the group member can open a conference as a key person later on.

1-2. Instant Conference Registration

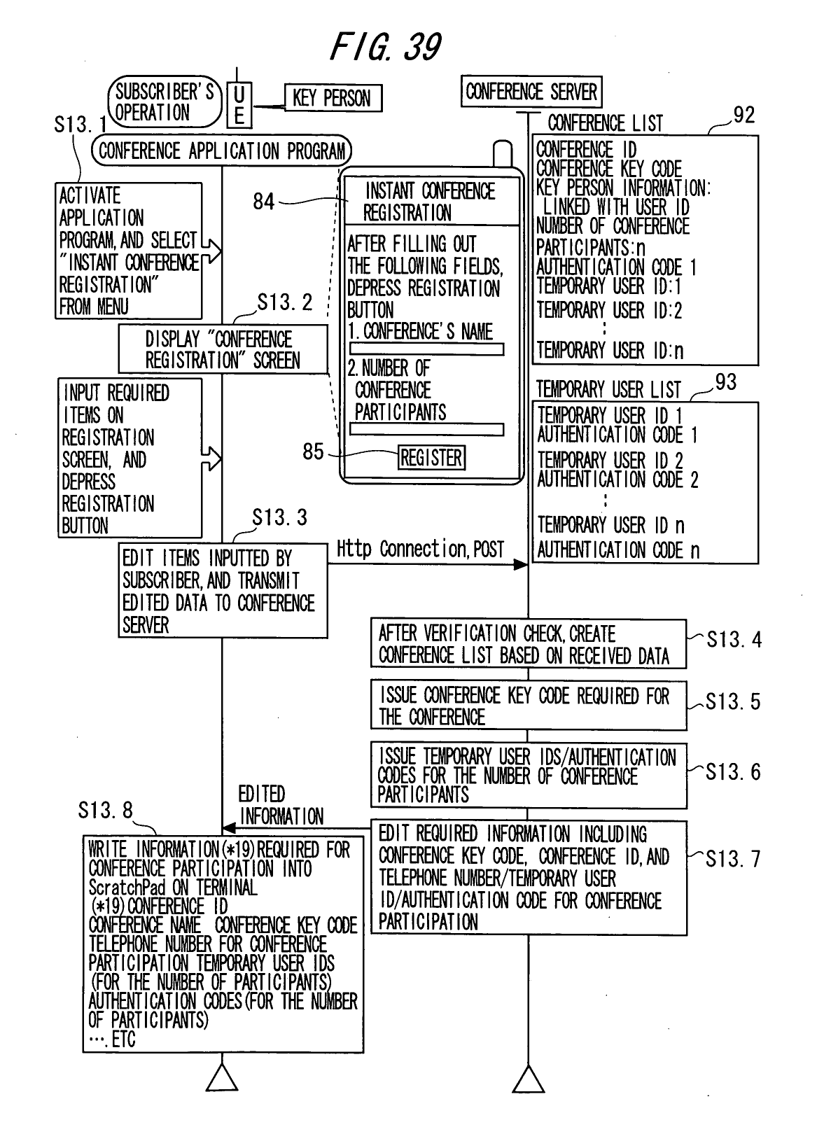

FIG. 39 shows a flow of the conference registration process.

S13.1: The user to be a key person activates the application program and selects “Instant conference registration” from the menu.

S13.2: Upon the selection of “Instant conference registration” from the menu, the terminal 2 displays an “Instant conference registration” screen to urge the key person to input information (conference information) including the following items.
Conference name
Number of conference participants

S13.3: When the user selects a registration button 85 after inputting information, the terminal 2 adds the personal information (including a user name and a user ID) in the ScratchPad to the inputted information to obtain request information for the service, and transmits the request information to the conference server 1 via POST in the HTTP protocol. Then, the terminal 2 edits the request information as parameters for the data management program (program in the form of a servlet) stored on the conference server, then calls the program via POST in the HTTP protocol, and passes the information to the program.

S13.4˜S13.5: The conference server 1 performs verification on the personal information (user ID/personal authentication code) of the key person included in the received request information. In the case of “verification OK”, a conference list 92 is created based on the received request information, and registered in the management information database. Also, the conference server 1 issues a conference key code for the conference to register the conference key code in the conference list 92.

S13.6˜S13.7: The conference server 1 issues temporary user IDs and corresponding authentication codes for the number of the conference participants, creates a user list (temporary user list), and registers each temporary user ID in the conference list 92.

The conference server 1 further edits information including a conference key code/conference ID/telephone number for conference participation as the information required for conference participation that allows the group member to participate in the conference, and transmits the edited information back to the key person terminal 2.

S13.8: The terminal 2 that has received the edited information writes the edited information as the information required for the conference participation into the ScratchPad. The data to be written into the ScratchPad includes the following.
Conference ID
Conference name
Conference key code
Telephone number for conference participation
Temporary user IDs (for the number of conference participants)
Authentication codes (for the number of conference participants)
Etc.

1-3. Instant Conference Notification by Key Person (in a Non-Face-to-Face Manner by email Communication)

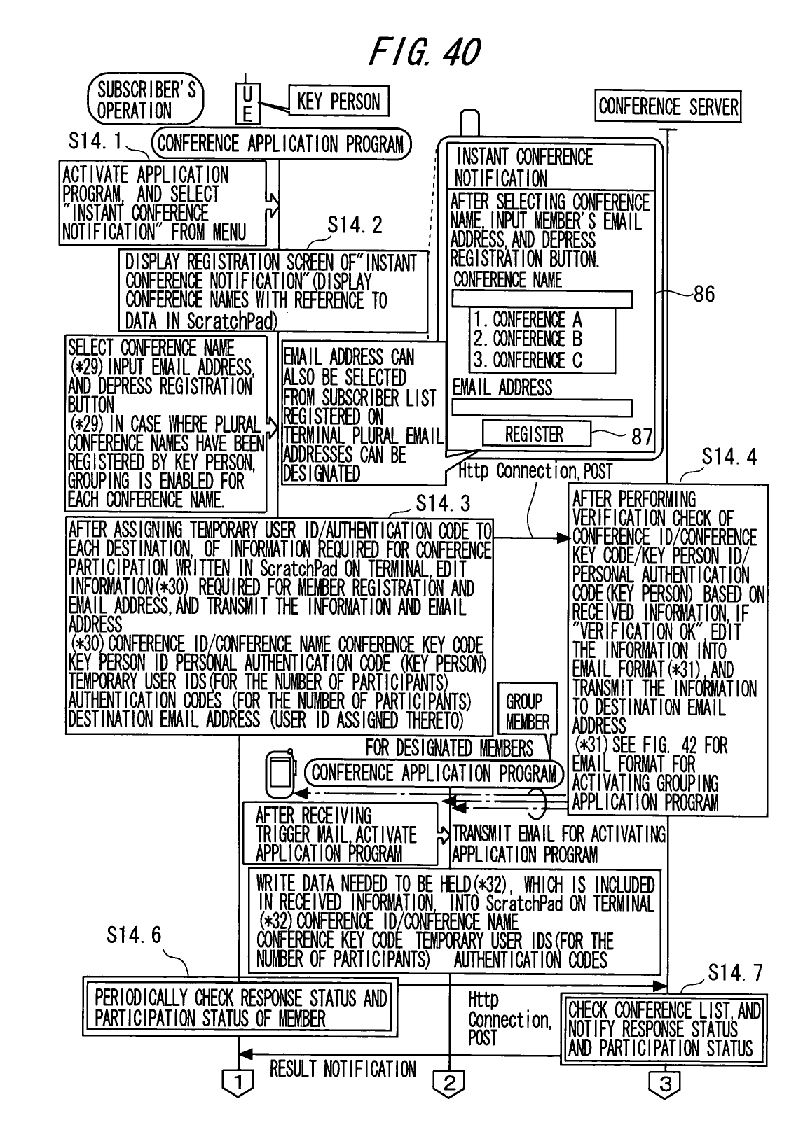

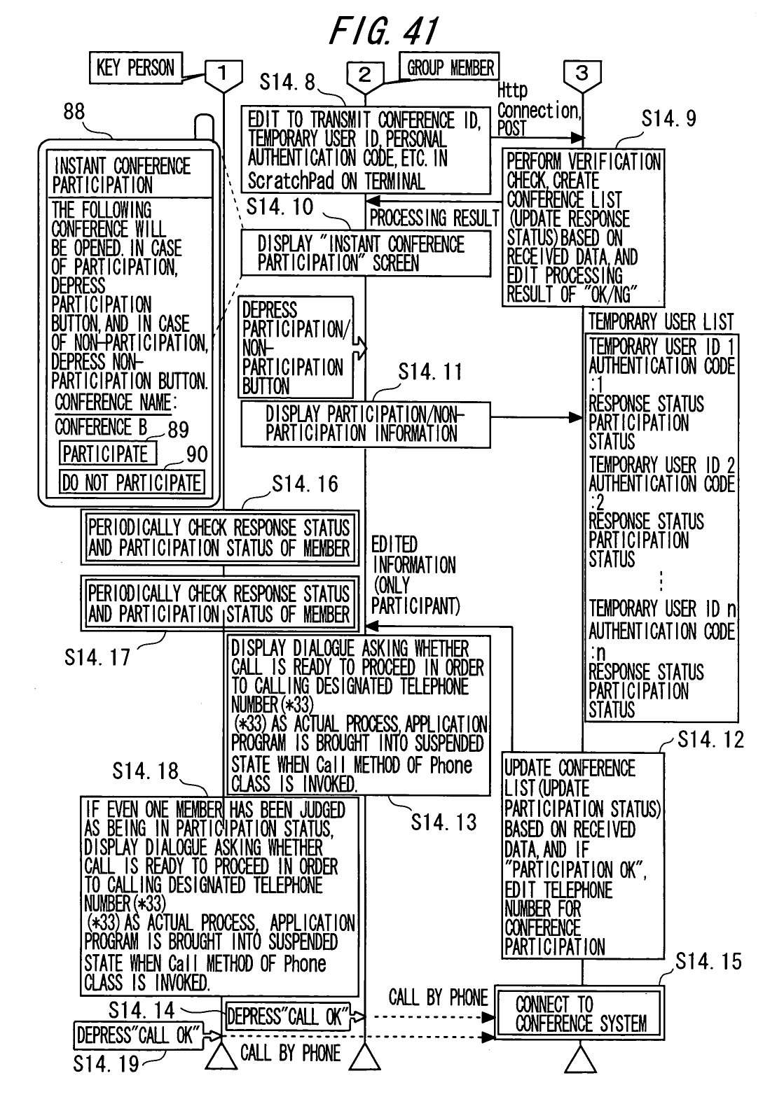

FIGS. 40 and 41 show a flow of the instant conference notification process by key person (in a non-face-to-face manner by email communication).

S14.1: The key person activates the application program and selects “Instant conference notification” from the menu.

S14.2: Upon the selection thereof from the menu, the terminal 2 displays an “Instant conference notification registration” screen 86 to urge the selection from the list of conference names displayed on the screen and the input of the email address of the user to be a group member (In the case where the plural conference names have been registered by the key person, the grouping is enabled for each of the conference names. The email address can also be selected from a subscriber list registered on the terminal, and plural addresses can be specified as well.).

S14.3: If the key person selects the registration, the terminal 2 assigns a temporary ID to each of the inputted email addresses, edits the following information required for the conference participation which is written in the ScratchPad on the terminal to obtain member application information, and transmits the member application information to the conference server 1 via POST in the HTTP protocol.
Conference ID
Conference name
Conference key code
Key person ID
Personal authentication code (key person)
Destination email addresses (for the number of participants)
temporary user IDs (for the number of participants) correspondingly assigned to the addresses
Authentication code (for the number of participants)
Etc.

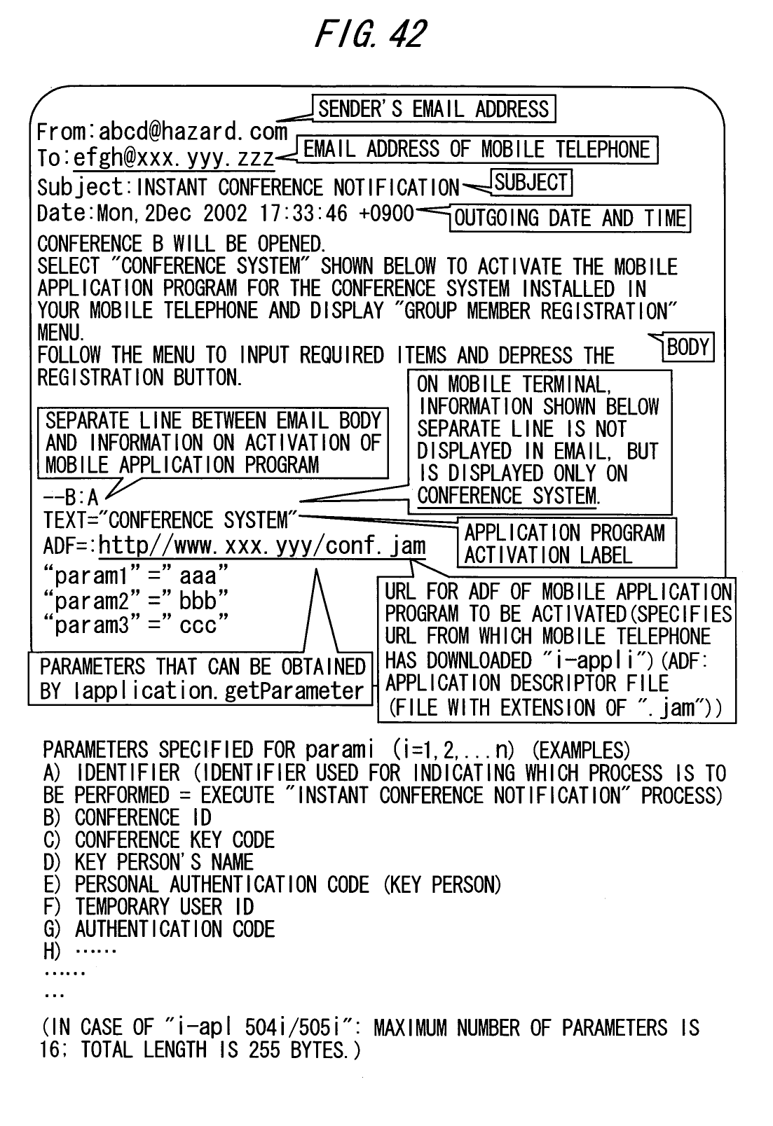

S14.4: The conference server 1 verifies the conference ID, conference key code, key person ID, and personal authentication code (key person) that are included in the received member application information against the information stored in the management information database. If the coincidence of the information is verified, “verification OK” is obtained. Then, the conference server 1 creates an email (see FIG. 42) for activation of the application program for the group member, and transmits the email to each of destination email addresses for the number of designated members.

The following member information is contained as parameters in the email.
Conference ID
Conference name
Conference key code
Key person ID
Personal authentication code (key person)
Temporary user ID
Authentication code
Etc.

Note that as another parameter to be contained in the email, an identifier indicating which process is to be performed on the terminal that receives the information is added to the above-mentioned information. Here, “identifier=execute the ‘Instant conference notification’ process” is specified.

S14.5: The group member terminal 3 that has received the information receives a trigger and then displays a dialogue to urge the selection of whether or not to activate the application program. If the user selects the activation, the terminal 3 activates the application program and writes the data of the following items included in the received member information into the ScratchPad.
Conference ID
Conference name
Conference key code
Key person ID
Personal authentication code (key person)
Temporary user ID
Authentication code

S14.8: Then, the terminal 3 transmits the member application information (including a conference ID, a temporary user ID, and a Personal authentication code) registered in the ScratchPad to the conference server 1 via POST in the HTTP protocol.
Conference ID
Temporary user ID
Authentication code
Etc.

S14.9: The conference server 1 verifies the received member information against the information stored in the management information database. If the coincidence of the information is verified, “verification OK” is obtained. Then, the conference server 1 creates a conference list (with a renewed response status), and transmits the process result (OK/NG) to the terminal 3.

S14.10: If the process result is “OK”, the terminal 3 displays an “instant conference participation” screen 88.

S14.11: If the user selects a participation button 89 or a non-participation button 90, the terminal 3 transmits participation information or non-participation information to the conference server 1 according to the selection.

S14.12: The conference server 1 renews the conference list (renews a participation status) based on the received participation information or non-participation information, and in the case of “participation OK”, transmits the telephone number for the conference participation to the terminal 3.

S14.13: The terminal 3 writes the received telephone number for the conference participation into the ScratchPad, and displays a dialogue for asking whether or not to call the telephone number (As an actual process, the application program is brought into a suspended state when a Call method of a Phone class is invoked.).

S14.14: The user selects “call OK”.

S14.15: The group member terminal 3 calls the telephone number for the-conference participation to establish a connection with the conference server 1 through a wireless telephone line. Then, the server 1 implements the TV conference service by causing the service control unit 21d to distribute service information including images and voices received from those terminals 2 and 3 to different terminals of the terminals 2 and 3.

S14.6,S14.16,S14.17: Meanwhile, after performing the instant conference notification, the key person terminal 2 periodically checks (inquires) the response status and participation status of each member (HTTP connection, GET).

S14.7: The conference server 1 checks the conference list in response to the inquiry, and transmits the response status and participation status of each temporary user to the terminal 2.

S14.18: If even one member has been judged as being in a participation status, the terminal 2 displays a dialogue asking whether a call is ready to proceed (“call OK”) or not in order to call the designated telephone number (As an actual process, the application program is brought into a suspended state when a Call method of a Phone class is invoked.).

S14.19: If the user selects “call OK”, the terminal 2 calls the telephone number for the conference participation to establish a connection with the conference server 1 through a wireless telephone line, starting to receive the service.

When the service ends, the conference server 1 registers billing information in the conference list. The billing information may include the amount of money corresponding to the service provision time or may include the amount of money corresponding to the traffic of service information. The billing information is registered in association with the key person on a user basis or by accumulating the billed amount for all group members. The conference server 1 reads out the billing information on a predetermined billing date to perform a billing process. Note that in the case where only the key person performs the member registration as in this embodiment, it is desirable to bill the amount for all users to the key person.

1-4. Database Structure

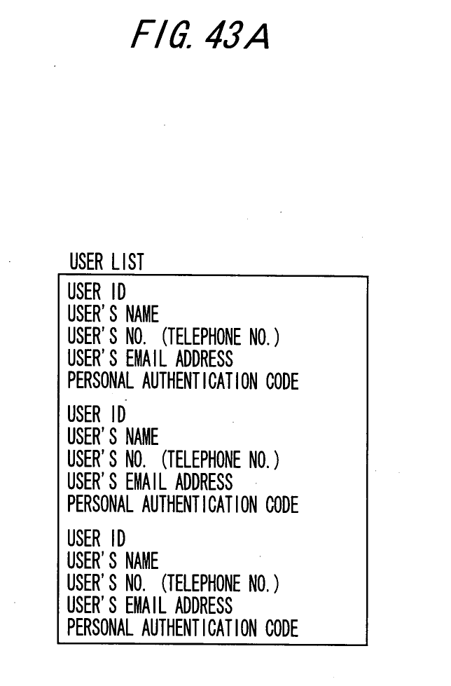

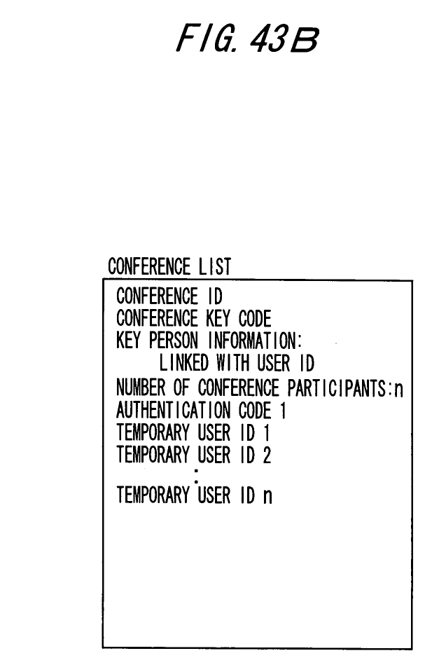

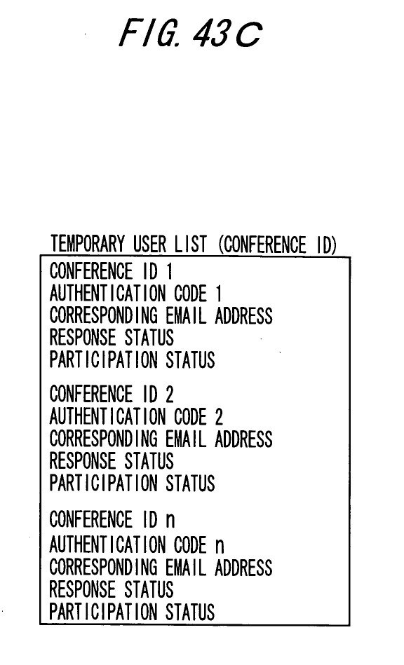

FIGS. 43A to 43C are explanatory diagrams showing a database structure registered on a conference server according to this embodiment.

FIG. 43A shows a user list, in which information on all the users who have completed the user registration is registered in a list form.

FIG. 43B shows a conference list, in which basic information on a conference and key person information are registered.

FIG. 43C is an example of the temporary member list. In the member list, the member information on temporary members is stored in association with the conference (service) with the conference ID being used as a key.

<Modified Embodiment>

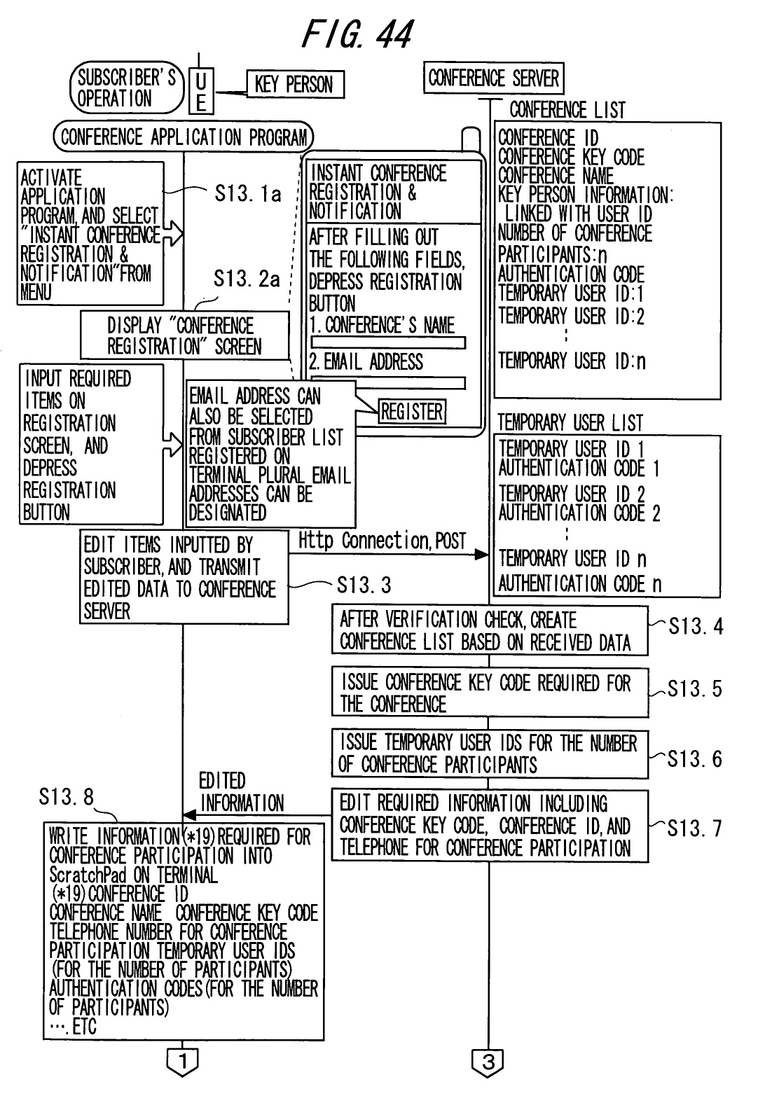

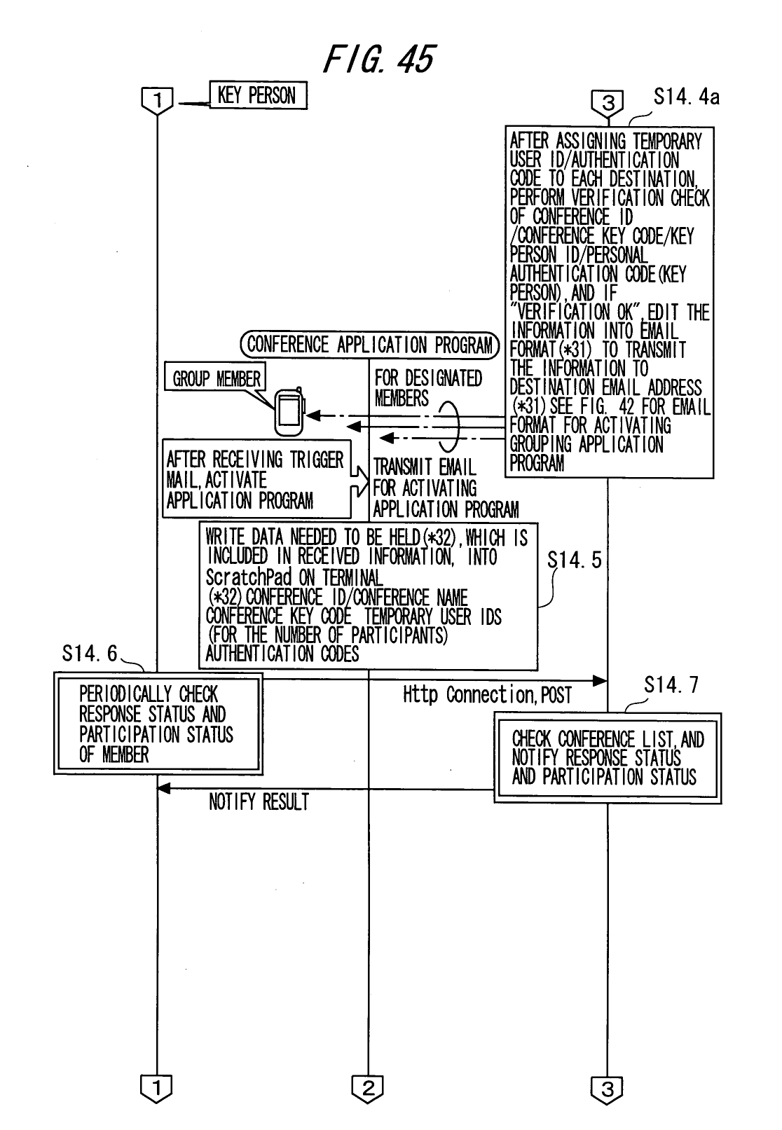

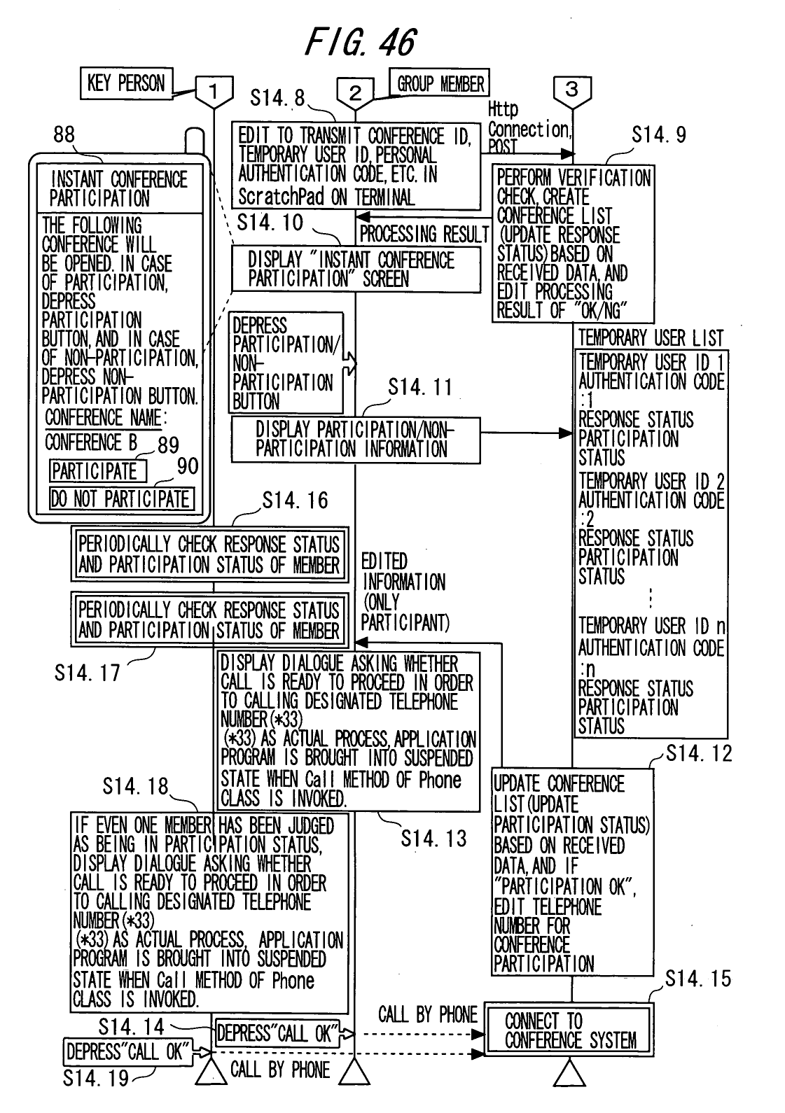

In Embodiment 3, the instant conference notification is performed after the instant conference registration. However, as shown in FIGS. 44 to 46, the instant conference registration and the instant conference notification may be performed as a series of processes.

First, if the key person selects “Instant conference registration & notification” from the menu in step 13.1a, the terminal 2 displays an “Instant conference registration” screen (FIG. 44) to urge the key person to input information (conference information) including a conference name and an email address of each group member. In this embodiment, the email address of each group member is thus inputted in advance and the conference information is registered in steps 13.3 to 13.8. The server 1 then assigns a temporary ID to each email address, creates member information to be transmitted to each email address, and transmits the member information to each corresponding terminal 3 (S14.4a). After that, the notification process is performed similarly to the above (S14.5 to S14.9).

As described above, according to this embodiment, the instant conference registration and the instant conference notification may be performed as a series of processes. Accordingly, the same effects as those of the above embodiments can be produced with a simpler procedure.

### Other Embodiments

The present invention is not limited solely to the above-illustrated embodiments, but it may be natural that various modifications can be added thereto without departing from the gist and the scope of the present invention.

### INDUSTRIAL APPLICABILITY

According to the above-mentioned embodiments, the description is made of an example of utilizing an application program on a mobile terminal. However, the present invention is also applicable to the member management regarding not only the mobile terminal but also PC/PDA-to-PC/PDA communication, PC/PDA-to-mobile-terminal communication, or the like.

Further, according to the embodiments, the description is made of an example of utilizing the infrared communication and the email communication. However, the present invention is also applicable to the case where the application program is activated by communication means through the Bluetooth or by a radio frequency type identification system (RFID=Radio Frequency Identification) with a contactless IC chip.

Further, for example, in terms of incoming/outgoing calls or emails to/from a terminal, the present invention is also applicable to the case where the member management is performed so as to restrict the incoming or outgoing other than that occurring between persons who have authorized each other by infrared communication or email communication.

According to the present invention, the incomings from persons other than grouped members can be restricted by a user. Consequently, for such a person as not to respond to an incoming call with “Caller ID blocking” turned on, such a service is effective in that more incomings can be restricted. Alternatively, the present invention is also effective for such a usage method as that the incomings/outgoings are made possible between grouped members through mobile terminals assigned thereto by the employer while other incomings/outgoings (for private purposes) are made impossible.

According to the above measures, the present invention can provide a technique for managing members easily and flexibly as circumstances demand.

1. A member management system, including:
a server that provides a service through a network;
a key person terminal that requests the server to provide the service; and
a group member terminal that receives the service requested by the key person terminal from the server,
the server including:
a request receiving unit that receives request information for the service from the key person terminal;
a list creating unit that creates a service list for the requested service based on the request information, and registers the service list in a list storing unit;
a member information creating unit that creates member information based on the request information, and registers the member information in a member information storing unit in association with the service of the service list;
a member information transmitting unit that transmits the member information to the key person terminal;
an application receiving unit that receives member application information created based on the member information from the group member terminal;
an application information verifying unit that verifies whether or not the member application information is authorized member application information based on the member information registered in the member information storing unit;
a group member information creating unit that creates member information on the group member terminal in the case where the member application information is judged as being authorized as a result of verification thereof, and registers the member information in the member information storing unit;
a group member information transmitting unit that transmits the member information created by the group member information creating unit to the group member terminal;
a member information verifying unit that, upon receiving a request for the service and member information from the key person terminal or the group member terminal, verifies the received member information against the member information registered in the member information storing unit in association with the requested service; and
a service providing unit that, in the case where the member information is judged as being authorized as a result of verification thereof, distributes information on the requested service to a terminal that has transmitted the member information,
the key person terminal including:
a request transmitting unit that transmits the request information for the service to the server;
a member information receiving unit that receives the member information created based on the request information from the server;
an application information creating unit that creates the member application information based on the member information;
an application information transmitting unit that transmits the member application information to the group member terminal;
a service requesting unit that transmits the request for the service and the member information to the server; and
a service receiving unit that receives the information on the requested service,
the group member terminal including:
an application information receiving unit that receives the member application information;
an application information transmitting unit that transmits the member application information to the server;
a member information receiving unit that receives the member information created based on the member application information from the server;
a service requesting unit that transmits the request for the service and the member information to the server; and
a service receiving unit that receives the information on the requested service.

2. A member management system, including:
a server that provides a service through a network;
a key person terminal that requests the server to provide the service; and
a group member terminal that receives the service requested by the key person terminal from the server,
the server including:
a request receiving unit that receives request information including information on a service to be requested and the number of members to receive the service from the key person terminal;
a list creating unit that creates a service list for the requested service based on the request information, and registers the service list in a list storing unit;
a member information creating unit that creates member information based on the request information and member IDs for the number of the members, and registers the member information and the member IDs in a member information storing unit in association with the service of the service list;
a member information transmitting unit that transmits the member information and the member IDs to the key person terminal;
a member information verifying unit that, upon receiving a request for the service and member information from the key person terminal or the group member terminal, verifies the received member information against the member information registered in the member information storing unit in association with the requested service; and
a service providing unit that, in the case where the member information is judged as being authorized as a result of verification thereof, distributes information on the requested service to a terminal that has transmitted the member information,
the key person terminal including:
a request transmitting unit that transmits the request information including the information on the service to be requested and the number of the members to receive the service to the server;
a member information receiving unit that receives member information for the key person terminal created based on the request information and the member IDs for the number of the members from the server;
a member information creating unit that creates member information for the group member terminal based on the member information for the key person terminal and the member IDs;
a member information transmitting unit that transmits the member information for the group member terminal to the group member terminal;
a service requesting unit that that transmits the request for the service and the member information for the key person terminal to the server; and
a service receiving unit that receives the information on the requested service,
the group member terminal including:
a member information receiving unit that receives the member information;
a service requesting unit that transmits the request for the service and the member information to the server; and
a service receiving unit that receives the information on the requested service.

3. A member management system, including:
a server that provides a service through a network;
a key person terminal that requests the server to provide the service; and
a group member terminal that receives the service requested by the key person terminal from the server,
the server including:
a request receiving unit that receives request information including information on a service to be requested and addresses for the number of members to receive the service from the key person terminal;
a list creating unit that creates a service list for the requested service based on the request information, and registers the service list in a list storing unit;
a member information creating unit that creates member information of each member based on the request information, and registers the member information in a member information storing unit in association with the service of the service list;
a member information transmitting unit that transmits the member information to the key person terminal and the group member terminal;
a member information verifying unit that, upon receiving a request for the service and member information from the key person terminal or the group member terminal, verifies the received member information against the member information registered in the member information storing unit in association with the requested service; and
a service providing unit that, in the case where the member information is judged as being authorized as a result of verification thereof, distributes information on the requested service to a terminal that has transmitted the member information,
the key person terminal including:
a request transmitting unit that transmits the request information including the information on the service to be requested and the number of the members to receive the service to the server;
a member information receiving unit that receives member information for the key person terminal created based on the request information from the server;
a service requesting unit that transmits the request for the service and the member information for the key person terminal to the server; and
a service receiving unit that receives the information on the requested service,
the group member terminal including:
a member information receiving unit that receives the member information;
a service requesting unit that transmits the request for the service and the member information to the server; and
a service receiving unit that receives the information on the requested service.

4. A member management system according to claim 1, wherein the member application information is communicated between the application information transmitting unit of the key person terminal and the application information receiving unit of the group member terminal by infrared communication, specific low-power wireless communication, or email.

5. A member management system according to claim 1, wherein the member information includes a service ID for identifying a service, a member ID for identifying a terminal, and a password.

6. A member management system according to claim 1, wherein the group member terminal includes:
the application information creating unit that creates the member application information based on the member information; and
the application information transmitting unit that transmits the member application information to the group member terminal.

7. A member management system according to claim 6,
wherein the key person terminal transmits the member application information including a permitted number of levels to the group member terminal,
wherein the server that has received the member application information from the group member terminal:
judges whether or not the permitted number of levels in the member application information is equal to or more than a predetermined value; and
if the permitted number of levels is equal to or more than the predetermined value, creates the member information by performing subtraction on the permitted number of levels and transmits the member information to the group member terminal,
wherein the group member terminal that has received the member information creates the member application information including the permitted number of levels in the member information, and transmits the member application information to another group member terminal.

8. A member management system according to claim 7,
wherein the key person terminal further includes a grouping unit that, if the group member terminal receives the member information from the server and the key person terminal is notified of the permitted number of levels in the member information and a member ID, sets a group for each permitted number of levels, and registers each group and the member ID in association with each other in a group information storing unit,
wherein, if the key person terminal receives input of a group to receive the service, the application information transmitting unit transmits the member application information to the group member terminal identified by the member ID registered in association with the group in the group information storing unit.

9. A member management system according to claim 7,
wherein the group member terminal further includes a grouping unit that, upon receiving input of a member ID for grouping, registers the group and the member ID in association with each other in a group information storing unit,
wherein, if the key person terminal receives input of a group to receive the service, the application information transmitting unit transmits the member application information to the group member terminal identified by the member ID registered in association with the group in the group information storing unit.

10. A server which provides a service to a key person terminal and a group member terminal through a network, including:
a request receiving unit that receives request information for the service from the key person terminal;
a list creating unit that creates a service list for the requested service based on the request information, and registers the service list in a list storing unit;
a member information creating unit that creates member information based on the request information, and registers the member information in a member information storing unit in association with the service of the service list;
a member information transmitting unit that transmits the member information to the key person terminal;
an application receiving unit that receives member application information created based on the member information from the group member terminal;
an application information verifying unit that verifies whether or not the member application information is authorized member application information based on the member information registered in the member information storing unit;
a group member information creating unit that creates member information on the group member terminal in the case where the member application information is judged as being authorized as a result of verification thereof, and registers the member information in the member information storing unit;
a group member information transmitting unit that transmits the member information created by the group member information creating unit to the group member terminal;
a member information verifying unit that, upon receiving a request for the service and member information from the key person terminal or the group member terminal, verifies the received member information against the member information registered in the member information storing unit in association with the requested service; and
a service providing unit that, in the case where the member information is judged as being authorized as a result of verification thereof, distributes information on the requested service to a terminal that has transmitted the member information.

11. A key person terminal which composes a member management system together with a server that provides a service through a network and a group member terminal that receives the service from the server, the key person terminal including:
a request transmitting unit that transmits request information for the service to the server;
a member information receiving unit that receives member information created based on the request information from the server;
an application information creating unit that creates member application information based on the member information;
an application information transmitting unit that transmits the member application information to the group member terminal;
a service requesting unit that transmits a request for the service and the member information to the server; and
a service receiving unit that receives information on the requested service.

12. A group member terminal which composes a member management system together with a server that provides a service through a network and a key person terminal that requests the server to provide the service, the group member terminal including:
an application information receiving unit that receives member application information;
an application information transmitting unit that transmits the member application information to the server;
member information receiving unit that receives member information created based on the member application information from the server;
an application information creating unit that creates the member application information based on the member information;
an application information transmitting unit that transmits the member application information to the group member terminal;
a service requesting unit that transmits a request for the service and the member information to the server; and
a service receiving unit that receives information on the requested service.

13. A recording medium recorded with a program, which is operated on a server which provides a service to a key person terminal and a group member terminal through a network, the program causing the server to execute:
receiving request information for the service from the key person terminal;
creating a service list for the requested service based on the request information, and registering the service list in a list storing unit;
creating member information based on the request information, and registering the member information in a member information storing unit in association with the service of the service list;
transmitting the member information to the key person terminal;
receiving member application information created based on the member information from the group member terminal;
verifying whether or not the member application information is authorized member application information based on the member information registered in the member information storing unit;
creating member information on the group member terminal in the case where the member application information is judged as being authorized as a result of verification thereof, and registering the member information in the member information storing unit;
transmitting the member information created in the preceding step to the group member terminal;
upon receiving a request for the service and member information from the key person terminal or the group member terminal, verifying the received member information against the member information registered in the member information storing unit in association with the requested service; and
in the case where the member information is judged as being authorized as a result of the verification thereof, distributing information on the requested service to a terminal that has transmitted the member information.

14. A recording medium recorded with a program, which is operated on a key person terminal composing a member management system together with a server that provides a service through a network and a group member terminal that receives the service from the server, the program causing the key person terminal to execute:
transmitting request information for the service to the server;
receiving member information created based on the request information from the server;
creating member application information based on the member information;
transmitting the member application information to the group member terminal;
transmitting a request for the service and the member information to the server; and
receiving information on the requested service.

15. A recording medium recorded with a program, which is operated on a group member terminal composing a member management system together with a server that provides a service through a network and a key person terminal that requests the server to provide the service, the program causing the group member terminal to execute:
receiving member application information;
transmitting the member application information to the server;
receiving member information created based on the member application information from the server;
creating the member application information based on the member information;
transmitting the member application information to the group member terminal;
transmitting a request for the service and the member information to the server; and
receiving information on the requested service.

16. A member management method which is executed by a member management system including:
a server that provides a service through a network;
a key person terminal that requests the server to provide the service; and
a group member terminal that receives the service requested by the key person terminal from the server,
the server executing:
receiving request information for the service from the key person terminal;
creating a service list for the requested service based on the request information, and registering the service list in a list storing unit;
creating member information based on the request information, and registering the member information in a member information storing unit in association with the service of the service list;
transmitting the member information to the key person terminal;
receiving member application information created based on the member information from the group member terminal;
verifying whether or not the member application information is authorized member application information based on the member information registered in the member information storing unit;
creating member information on the group member terminal in the case where the member application information is judged as being authorized as a result of verification thereof, and registering the member information in the member information storing unit;
transmitting the member information created in the preceding step to the group member terminal;
upon receiving a request for the service and member information from the key person terminal or the group member terminal, verifying the received member information against the member information registered in the member information storing unit in association with the requested service; and
in the case where the member information is judged as being authorized as a result of the verification thereof, distributing information on the requested service to a terminal that has transmitted the member information,
the key person terminal executing:
transmitting the request information for the service to the server;
receiving the member information created based on the request information from the server;
creating the member application information based on the member information;
transmitting the member application information to the group member terminal;
transmitting the request for the service and the member information to the server; and
receiving the information on the requested service,
the group member terminal executing:
receiving the member application information;
transmitting the member application information to the server;
receiving the member information created based on the member application information from the server;
creating the member application information based on the member information;
transmitting the member application information to the group member terminal;
transmitting the request for the service and the member information to the server; and
receiving the information on the requested service.

17. A member management method according to claim 16, wherein the group member terminal executes:
creating the member application information based on the member information; and
transmitting the member application information to the group member terminal.

18. A member management method according to claim 17,
wherein the key person terminal executes transmitting the member application information including a permitted number of levels to the group member terminal,
wherein the server that has received the member application information from the group member terminal executes:
judging whether or not the permitted number of levels in the member application information is equal to or more than a predetermined value;
if the permitted number of levels is equal to or more than the predetermined value, creating the member information by performing subtraction on the permitted number of levels; and
transmitting the member information to the group member terminal,
wherein the group member terminal that has received the member information executes:
creating the member application information including the permitted number of levels in the member information; and
transmitting the member application information to another group member terminal.

19. A member management method which is executed by a member management system including:
a server that provides a service through a network;
a key person terminal that requests the server to provide the service; and
a group member terminal that receives the service requested by the key person terminal from the server,
the server executing:
receiving request information including information on a service to be requested and the number of members to receive the service from the key person terminal;
creating a service list for the requested service based on the request information, and registering the service list in a list storing unit;
creating member information based on the request information and member IDs for the number of the members, and registering the member information and the member IDs in a member information storing unit in association with the service of the service list;
transmitting the member information and the member IDs to the key person terminal;
upon receiving a request for the service and member information from the key person terminal or the group member terminal, verifying the received member information against the member information registered in the member information storing unit in association with the requested service; and
in the case where the member information is judged as being authorized as a result of the verification thereof, distributing information on the requested service to a terminal that has transmitted the member information,
the key person terminal executing:
transmitting the request information including the information on the service to be requested and the number of the members to receive the service to the server;
receiving member information for the key person terminal created based on the request information and the member IDs for the number of the members from the server;
creating member information for the group member terminal based on the member information for the key person terminal and the member IDs;
transmitting the member information for the group member terminal to the group member terminal;
transmitting the request for the service and the member information for the key person terminal to the server; and
receiving the information on the requested service,
the group member terminal executing:
receiving the member information;
transmitting the request for the service and the member information to the server; and
receiving the information on the requested service.
